(19) United States
(12) Patent Application Publication
(10) Pub. No.: US 2011/0225262 A1
(43) Pub. Date: Sep. 15, 2011

(54) SERVER DEVICE, CLIENT DEVICE, DELIVERY METHOD, AND PROGRAM

(75) Inventor: Yoshimasa Utsumi, Tokyo (JP)

(73) Assignee: Sony Corporation, Tokyo (JP)

(21) Appl. No.: 13/039,071

(22) Filed: Mar. 2, 2011

(30) Foreign Application Priority Data
Mar. 9, 2010 (JP) P2010-051738

(51) Int. Cl. G06F 15/16

(52) U.S. Cl. 709/217

(57) ABSTRACT

A server device includes: a communication unit that communicates with a plurality of client devices capable of performing network communication; a reproduction unit that reproduces content data; and a control unit that delivers common content data reproduced by the reproduction unit from the communication unit to each of the client devices and, in a case where a change request requesting to change delivery content is received from one client device through the communication unit during the common content delivery operation, checks a status of a reception of an additional change request from other client within a first period counting of which is started based on the reception from the one client and determines a process after an elapse of the first period based on the status of the reception of the change request within the first period.

### BACKGROUND OF THE INVENTION

1. Field of the Invention

The present invention, relates to a server device and a client device, for example, configuring a home network, a delivery method of a server device, and a program, and more particularly, to a process responding to a change request for delivery content.

2. Description of the Related Art

As a so-called home network system, a system that is configured by a contents server device and client devices is proposed.

In this home network system, for example, client devices that are output devices of videos or audios are arranged in each room of a house. For example, the client device is a device that includes a television monitor, a speaker, or the like.

Then, a contents server device arranged in a predetermined room and a plurality of the client devices are connected to be communicable with each other through a predetermined communication network (wired or wireless).

Accordingly, the video or audio contents delivered from the contents server device can be viewed or listened to in each room inside the house.

In such a home network system, two types including an on-demand mode and a party mode can be considered in a delivery operation.

The on-demand mode is a mode in which different contents are delivered to client device in each room from the contents server device.

The party mode is a mode in which the same contents are commonly delivered to the client devices arranged in each room from the contents server device and are synchronously (simultaneously) reproduced.

In the case of the on-demand mode, a user performs an operation of selecting contents for the client device arranged in each room. This operation information is transmitted to the contents server device through network communication. The contents server device delivers designated contents to the client device as a transmission source of the operation information based on the operation information. In other words, the contents server device delivers different contents to each client device.

Accordingly, in the case of the on-demand mode, users present in each room can receive delivery of music contents desired to listen to or video contents desired to view and enjoy different contents in each room by performing operation inputs for the client devices.

On the contents server device side, for example, in a case where, for example, a multi-head HDD (Hard Disk Drive) is used as a storage unit of content data or the like, plural pieces of content data can be simultaneously reproduced and can be respectively delivered to predetermined devices.

On the other hand, in the case of the party mode, in a case where, for example, guests for a party and others are scattered over rooms such as a living room, a kitchen, a reception room, or the like, the same contents can be simultaneously enjoyed by delivering a common content to all the rooms. In this case, even when a person moves from one room to another, he or she can continuously enjoy the same contents. Thus, the purpose of the party mode is, for example, to allow a conversation on a subject of the reproduced content to liven up conversations.

### SUMMARY OF THE INVENTION

However, even in the case of the party mode, a request made through an operation of the client device may be considered to be accepted.

A case where, for example, music contents is delivered in the party mode will be described as an example. A user not only listens to the delivered music as BGM (back ground music) but may actively desire to listen to a different piece based on the flow of conversations, association of the music currently listened to, or the like. In such a case, it is preferable that a different piece can be requested (request to change delivery content) through an operation input for the client device arranged in the room in which the person is present.

However, when a content change is requested around the same time by using each client device, and the music delivered to all the rooms is frequently changed each time the content change is requested, persons present in other rooms may get distracted or feel displeased. In addition, a person performing an operation of returning the content to the original piece, a person requesting for a further different piece, or others may appear. Accordingly, there is a concern for a case where a change request is consecutively made as in a so-called channel conflict.

In other words, when, for example, music that is listened to as BGM is repeatedly changed over in the middle of the pieces, persons other than the person performing the operation (persons present in other rooms) may be distracted as a result so as not to be able to enjoy the party or concentrate on a conversation. In addition, while a conversion over a music artist that is currently being played is enjoyed, if the music is changed to a different piece that is irrelevant to the player, the good conversion may be spoiled and unamused.

As a method of solving such a state, in JP-A-2000-224673, contents is disclosed in which a priority is given to a specific sub-unit among a plurality of sub-units (corresponding to the client devices), and, as a result, even when a channel conflict occurs, requests from other sub-units to which the priority is not given are exclusively processed.

In addition, in JP-A-2004-228647, technology is disclosed in which, when commands are simultaneously transmitted from a plurality of remote controls to a device connected to a network, an exclusive process is performed.

However, although by giving priority to a specific client device so as to exclude control from the other client devices, a channel conflict can be avoided, there is a problem in that the delivered contents is not allowed to be changed from the other client devices. In this case, when a user present in another room desires to change the contents, there is inconvenience that the user necessarily goes to the room in which the client device, to which the priority is given, is arranged and performs an operation.

In addition, in the case where the priority is to be given, it is difficult to determine the rules of the priority and the client device to which the priority is given in a home network performing a party mode operation.

Thus, it is desirable to provide a home network system in which a content change request can be made from each client device in a case where a delivery operation is performed in the party mode. In addition, it is desirable to appropriately respond to a tangle between change requests (occurrence of a plurality of change requests within a short period) or to prevent adverse effects of the tangle.

According to an embodiment of the present invention, there is provided a server device including: a communication unit that communicates with a plurality of client devices capable of performing network communication; a reproduction unit that reproduces content data; and a control unit that delivers common content data reproduced by the reproduction unit from the communication unit to each of the client devices and, in a case where a change request requesting to change delivery content is received from one client device through the communication unit during the common content delivery operation, checks a status of a reception of an additional change request from other client within a first period counting of which is started based on the reception from the one client and determines a process after an elapse of the first period based on the status of the reception of the change request within the first period.

In the above-described server device, the control unit may perform a process of invalidating the received change request during a second period counting of which is started after the elapse of the first period when the number of the change requests detected within the first period is equal to or greater than a predetermined number.

Alternatively, the control unit may transmit a prohibit signal for prohibiting transmission of new change request to all or some of the client devices through the communication unit when the number of the change requests detected within the first period is equal to or greater than a predetermined number.

Alternatively, when the number of the detected change requests within the first period is equal to or greater than a predetermined number, the control unit may transmit a prohibit signal for prohibiting transmission of new change request to all or some of the client devices through the communication unit and transmits a release signal for releasing the prohibition of transmission of the change request to all or some of the client devices through the communication unit after a second period counting of which is started after the elapse of the first period counting.

In addition, the control unit may a valid change request which is a change request received at a time when the first period elapses, and controls the reproduction unit so as to reproduce the content data according to the valid change request and transmit the reproduced content data from the communication unit to each of the client devices.

In such a case, the control unit may control the reproduction unit so as to maintain the content data delivered before the start of counting of the first period in a case where the number of the change requests detected within the first period is equal to or greater than a predetermined number and control the communication unit so as to transmit the reproduced data from the communication unit to each of the client devices.

In addition, the control unit may be configured not to control to change the delivery content in accordance with the change request received until the first period elapses.

In addition, the control unit may be configured not to control to change the delivery content in accordance with the change request detected within the first period also after the elapse of the first period in a case where the number of the change requests detected within the first period is equal to or greater than a predetermined number.

On the other hand, the control unit may control the reproduction unit so as to reproduce the content data according to the latest change request detected within the first period after the elapse of the first period and controls the communication unit so as to transmit the reproduced content data from the communication unit to each of the client devices in a case where the number of the change requests detected within the first period is less than a predetermined number.

In addition, the control unit, in accordance with a reception of the change request until a time point when the first period elapses, may transmit an announcement signal used for notifying of the received change request from the communication unit to all or some of the client devices.

In addition, the control unit may perform an adding-up process of approval/disapproval information in accordance with a reception of an approval/disapproval information signal that is received by the communication unit from the client device after the transmission of the announcement signal within the first period and determine the delivery content after the elapse of the first period based on a result of the adding-up process.

According to another embodiment of the present invention, there is provided a server device including: a communication unit that communicates with a plurality of client devices capable of performing network communication; a reproduction unit that reproduces content data; and a control unit that delivers a common content data reproduced by the reproduction unit from the communication unit to each of the client devices and, in a case where a change request requesting to change delivery content is received from one client device through the communication unit during the common content delivery operation, the control unit controlling the reproduction unit so as to reproduce both of the common content data and a content data corresponding to the change request from the one client and controlling the reproduction unit so as to transmit the content data corresponding to the change request only to the one client device and the common content data to other client devices except for the one client device.

In the above-described server device, when the transmission of the content data to the one client device is completed, the control unit may control the reproduction unit so as to recover delivery of the common content data to all client devices including the one client device.

According to still another embodiment of the present invention, there is provided a client device including: a communication unit that communicates with a server device capable of performing network communication; a reproduction processing unit that performs a reproduction process of content data that is delivered from the server device and is received by the communication unit; and a control unit that transmits a change request used for requesting to change delivery content from the communication unit to the server device in accordance with a user operation and, in a case where a transmission prohibiting signal is received from the server device, does not transmit the change request according to the user operation in a predetermined period counting of which is started after the reception.

According to yet another embodiment of the present invention, there is provided a client device including: a communication unit that communicates with a server device capable of performing network communication; a reproduction processing unit that performs a reproduction process of content data that is delivered from the server device and is received by the communication unit; and a control unit that performs a process of transmitting a change request used for requesting to change delivery content from the communication unit to the server device in accordance with a user operation, a process of presenting a contents of an announcement signal when the announcement signal used for notifying of the change request from another client device is received from the server device, and a process of transmitting an approval/disapproval information signal representing approval/disapproval information on a contents of the announcement signal in accordance with a user operation from the communication unit to the server device.

According to still yet another embodiment of the present invention, there is provided a delivery method of a server device in a delivery system in which the server device and a plurality of client devices can communicate with each other through network communication. The delivery method includes the steps of: commonly delivering reproduced content data to each of the client devices; checking a status of a reception of an additional change request in accordance with a reception of a change request used for requesting to change delivery content from one client device during the common content delivery operation within a predetermined period counting of which is started based on the reception from the one client; and determining a process after an elapse of the predetermined period based on the status of the reception of the change request within the predetermined period.

According to further another embodiment of the present invention, there is provided a program that allows a calculation processing apparatus to perform the above-described steps.

According to still further another embodiment of the present invention, there is provided a delivery method of a server device in a delivery system in which the server device and a plurality of client devices can communicate with each other through network communication. The delivery method includes the steps of: commonly delivering reproduced content data to each of the client devices; and, when a change request used for requesting to change a delivered content data is received from one of the client devices during the commonly delivering step, (i) reproducing content data corresponding to the change request, while maintaining reproduction of the commonly delivering reproduced content data, and (ii) transmitting the content data corresponding to the change request to the one of the client devices and the commonly delivering reproduced content data to the other of the client devices simultaneously.

According to still yet further another embodiment of the present invention, there is provided a program that allows a calculation processing apparatus to perform the above-described steps.

According to the embodiments of the present invention, the server device checks whether the number of generated change requests for delivery content from the client devices within a predetermined period (a first period) is equal to or greater than a predetermined number and determines whether a status is formed in which a tangle of change requests occurs based on the number of generated change requests. Then, for example, when a tangle of change requests occurs, the server device performs a process of invalidating a change request, for example, in a predetermined period (a second period) and the like, whereby the music or the like that is played all over the place in the party mode is not unreasonably changed.

Alternatively, in order not to generate adverse effects of a tangle of change requests right from the start, when there is a change request from a client device, the client device is disengaged from the party mode, and a delivery operation in the on-demand mode is performed only for the client device. Accordingly, there is no influence on users viewing the delivery output that is output from other client devices.

According to the embodiments of the present invention, an appropriate operation can be realized when a party-mode operation, that is, delivery of common content data to each client device is performed in a home network system or the like. First, since a change request for delivery content can be accepted from each client device, each user can request delivery of contents desired to be viewed or listened to also in a party-mode operation.

Furthermore, even when a tangle of a plurality of change requests occurs, an appropriate delivery operation can be performed as a party-mode operation without unreasonably changing the contents that may disturb other user's mood.

Alternatively, by changing the delivery content only for a client device from which a change request is transmitted, an appropriate delivery operation as a party-mode operation that does not cause adverse effects on other users can be performed.

### BRIEF DESCRIPTION OF THE DRAWINGS

FIG. 1 is a schematic diagram illustrating the configuration of a home network system according to an embodiment of the invention.

FIG. 2 is a block diagram of a contents server device according to an embodiment of the invention.

FIG. 3 is a block diagram of a client device according to an embodiment of the invention.

FIG. 4 is a block diagram of a device serving as both a server and a client according to an embodiment of the invention.

FIG. 5 is a schematic diagram illustrating the operation according to a first embodiment.

FIG. 6 is a schematic diagram illustrating the operation according to the first embodiment.

FIG. 7 is a schematic diagram illustrating the functional configuration of a contents server device according to the first embodiment.

FIG. 8 is a schematic diagram illustrating the functional configuration of a client device according to the first embodiment.

FIG. 9 is a flowchart of the process of a contents server device according to the first embodiment.

FIG. 10 is a flowchart of the process of a client device according to the first embodiment.

FIG. 11 is a schematic diagram illustrating the operation according to a second embodiment of the invention.

FIG. 12 is a schematic diagram illustrating the functional configuration of a contents server device according to the second embodiment.

FIG. 13 is a schematic diagram illustrating the functional configuration of a client device according to the second embodiment.

FIG. 14 is a flowchart of the process of a contents server device according to the second embodiment.

FIG. 15 is a flowchart of the process of a client device according to the second embodiment.

FIG. 16 is a schematic diagram illustrating the operation according to a third embodiment.

FIG. 17 is a schematic diagram illustrating the functional configuration of a contents server device according to the third embodiment.

FIG. 18 is a schematic diagram illustrating the functional configuration of a client device according to the third embodiment.

FIG. 19 is a flowchart of the process of a contents server device according to the third embodiment.

FIG. 20 is a flowchart of the process of a client device according to the third embodiment.

FIG. 21 is a schematic diagram illustrating the operation according to a fourth embodiment.

FIG. 22 is a schematic diagram illustrating the operation according to a fourth embodiment.

FIG. 23 is a schematic diagram illustrating the functional configuration of a contents server device according to the fourth embodiment.

FIG. 24 is a schematic diagram illustrating the functional configuration of a client device according to the fourth embodiment.

FIG. 25 is a flowchart of the process of a contents server device according to the fourth embodiment.

FIG. 26 is a flowchart of the process of a client device according to the fourth embodiment.

FIG. 27 is a schematic diagram illustrating the operation according to a fifth embodiment of the invention.

FIG. 28 is a schematic diagram illustrating the functional configuration of a contents server device according to the fifth embodiment.

FIG. 29 is a schematic diagram illustrating the functional configuration of a client device according to the fifth embodiment.

FIG. 30 is a flowchart of the process of a contents server device according to the fifth embodiment.

FIG. 31 is a flowchart of the process of a client device according to the fifth embodiment.

FIG. 32 is a schematic diagram illustrating the operation according to a sixth embodiment.

FIG. 33 is a schematic diagram illustrating the functional configuration of a contents server device according to the sixth embodiment.

FIG. 34 is a flowchart of the process of a contents server device according to the sixth embodiment.

FIG. 35 is a schematic diagram illustrating modified examples of the embodiments.

### DESCRIPTION OF THE PREFERRED EMBODIMENTS

Hereinafter, embodiment of the present invention will be described in the following order.

### <1. Configuration of Home Network System According to Embodiment>

[1-1: Configuration of System]

[1-2: Contents Server Device]

[1-3: Client Device]

[1-4: Device Serving As Both Server and Client]

### <2. First Embodiment>

[2-1: Overview of Operation]

[2-2: Functional Configuration of Server and Client]

[2-3: Example of Process of Server And Client]

### <3. Second Embodiment>

[3-1: Overview of Operation]

[3-2: Functional Configuration of Server and Client]

[3-3: Example of Process of Server And Client]

### <4. Third Embodiment>

[4-1: Overview of Operation

[4-2: Functional Configuration of Server and Client]

[4-3: Example of Process of Server And Client]

### <5. Fourth Embodiment>

[5-1: Overview of Operation]

[5-2: Functional Configuration of Server and Client]

[5-3: Example of Process of Server And Client]

### <6. Fifth Embodiment>

[6-1: Overview of Operation]

[6-2: Functional Configuration of Server and Client]

[6-3: Example of Process of Server And Client]

### <7. Sixth Embodiment>

[7-1: Overview of Operation]

[7-2: Functional Configuration of Server and Client]

[7-3: Example of Process of Server And Client]

### <8. Program>

### 1. Configuration of Home Network System According to Embodiment

### [1-1: Configuration of System]

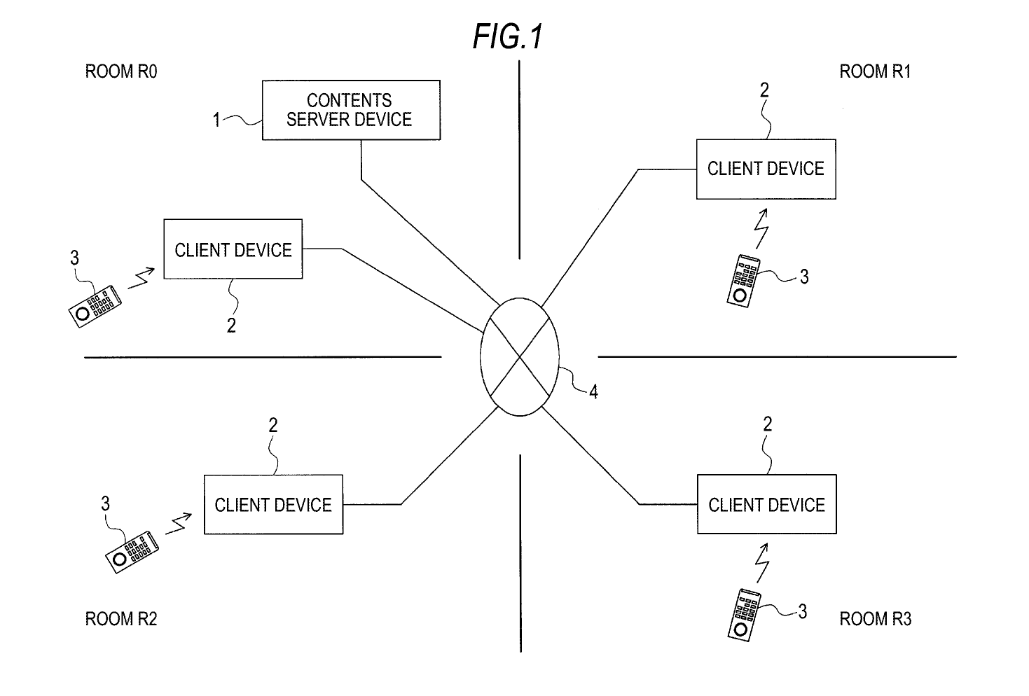

First, the configuration of a home network system according to an embodiment will be described with reference to FIG. 1.

FIG. 1 shows an example in which the home network system is used in four rooms including a room R0 to a room R3 of a house.

Here, although the system is referred to as a “home network system”, it is apparent that a place in which the system of this example is used is not limited to a “house”. For example, the system may be used in a company, a school, a public facility, or the like as well. In addition, a room described here may be considered as not only each “room” inside the same building but also the outside of a building such as a yard, a garage, or a warehouse inside a site or the inside of another building. In other words, in this example, the same audio content or video content is delivered in a party mode such that the same content can be viewed or listened to in each “room”. However, the above-described “room” to which the same content is delivered may be considered in a huge variety of forms. However, it is appropriate to consider the system as not a system that delivers the content in a wide range through a public network such as the Internet but a system that delivers the content in a narrow range to some degree.

The home network system according to the embodiment is configured such that one or more contents server devices 1 and a plurality of client devices 2 including at least two or more devices can communicate with one another through a network 4.

In the example shown in FIG. 1, a contents server device 1 is installed at a room R0. In addition, client devices 2 are installed in rooms R0 to R3.

The contents server device 1 can deliver content data such as an audio, a video, a text, or a game to each client device 2 through the network 4. For example, the contents server device 1 reproduces the content data by using an exchange-type optical disc player or the like in which a hard disk drive (HDD), a flash memory, a plurality of optical discs such as CDs (Compact Disc), DVDs (Digital Versatile Disc), and BDs (Blu-ray Disc (registered trademark)), or the like is stored. In addition, the contents server device 1 delivers the reproduced content data to each client device 2.

Each client device 2 includes a monitor display, a speaker, or the like as an output device that is configured separately or integrally. Each client device 2 receives the content data that is delivered through the network 4 and outputs the content data as a video or an audio from the output device.

Accordingly, a user present in each of the rooms R0 to R3 can view or listen to the delivered content data.

For example, an operation button configured on the casing of the client device 2, a touch panel unit operated on a monitor, a remote commander 3 shown in the figure, or the like is prepared in each client device 2, and accordingly, the user can perform an operation input.

The information of the operation input that is input by the user is transmitted to the contents server device 1 through the network 4. Through such an operation input, the user can perform an operation such as a content change request or the like to be described later.

The network 4, for example, is configured by a wired or wireless transmission channel through which communication can be made inside a house.

For example, in the case of wired communication, a lamp line, a television RF cable, a DLNA (Digital Living Network Alliance), an HDMI (High Definition Multimedia Interface), or the like may be considered. On the other hand, in the case of wireless communication, IEEE 1394.11a/b/n, Bluetooth, another communication method using a 2.4 GHz band, or the like can be considered.

In the home network system, it is assumed that the contents server device 1 can deliver the content in an on-demand mode or a party mode.

As described above, the on-demand mode is a mode in which content data according to a request is individually delivered to each client device 2. On the other hand, the party mode is a mode in which common content data is simultaneously delivered to all the client devices 2.

### [1-2: Contents Server Device]

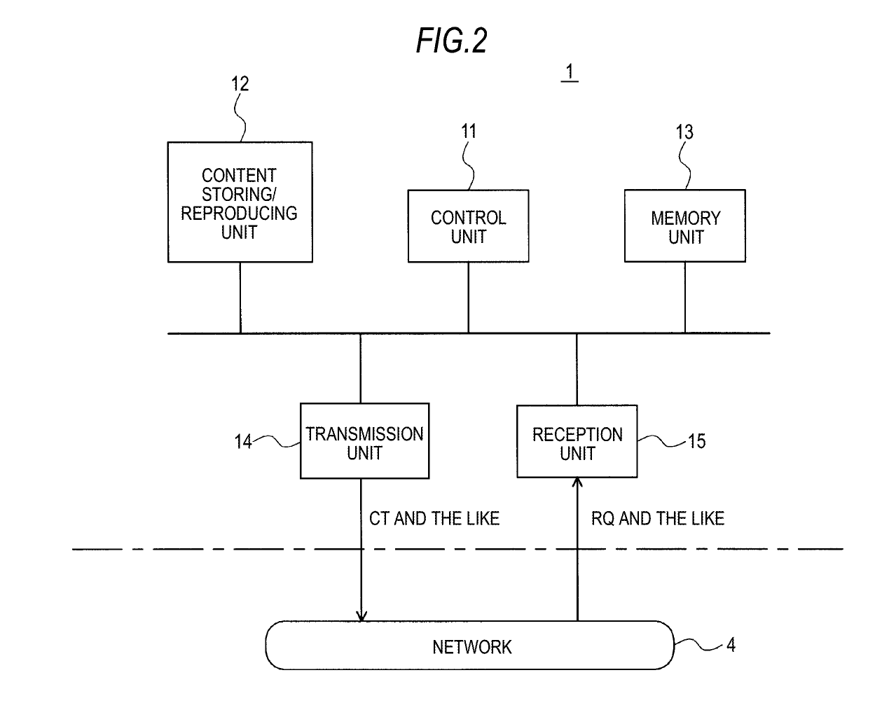

An example of the configuration of the contents server device 1 will be described with reference to FIG. 2.

The contents server device 1 includes a control unit 11, a content storing/reproducing unit 12, a memory unit 13, a transmission unit 14, and a reception unit 15.

The control unit 11 is configured by a microcomputer that includes a CPU (Central Processing Unit), a ROM (Read Only Memory), a RAM (Random Access Memory), and the like.

In the ROM inside the control unit 11, for example, various types of setting information used for a delivery operation and the like are stored, in addition to a program to be executed by the CPU. The RAM is a main memory device unit for the CPU.

The control unit 11 controls the overall operation of the contents server device 1. In other words, for the delivery operation in the party mode or the on-demand mode, the control unit 11 performs control of a reproduction operation of the content storing/reproducing unit 12, transmission control of content data CT or the like from the transmission unit 14, a process corresponding to a change request RQ, which is received by the reception unit 15, transmitted from the client device 2, or the like.

The memory unit 13 collectively represents the memory units such as the RAM, the ROM, the flash memory, and the like. This memory unit 13 may be used as a work area for the process of the control unit 11 or a storage area of a program. In addition, the memory unit 13 is used for storing various types of setting information, parameters, or the like used for the delivery operation.

In addition, the memory unit 13 may be used as a transmission buffer for the content data that is reproduced by the content storing/reproducing unit 12 for delivery.

The content storing/reproducing unit 12 is a device unit that can reproduce various types of the content data CT. The content data CT, for example, is stored in a hard disk, a flash memory, an optical disc, or the like. The content storing/reproducing unit 12 reproduces the content data CT read from such a storage medium based on a command transmitted from the control unit 11. Accordingly, the content storing/reproducing unit 12, for example, is implemented by an HDD, a flash memory player, an optical disc player, an exchange-type optical disc player, or the like.

The transmission unit 14 and the reception unit 15 serve as communication units for the client devices 2 through the network 4.

The transmission unit 14, based on the control of the control unit 11, performs a predetermined encoding process for the content data CT mainly reproduced by the content storing/reproducing unit 12 and performs network transmission of the encoded content data, that is, delivery of the encoded content data to each client device 2.

In addition, the reception unit 15 receives a signal such as a change request RQ used for requesting to change the delivered content data CT or the like transmitted from each client device 2. The reception unit 15 decodes the received signal and delivers the content of received information to the control unit 11.

In order to perform such a process, the transmission unit 14 and the reception unit 15 perform an encoding process, a decoding process, and transmission and reception processes corresponding to the wired or wireless communication method employed in the network 4.

Although not shown in FIG. 2, an operation unit that is used for user input for the contents server device 1, a command receiving unit that receives a command transmitted from a corresponding remote commander, or the like may be disposed. Alternatively, it may be configured such that the operation input for the contents server device 1 can be performed through user input for the client device 2, and the operation information for the contents server device 1 is supplied from the client device 2.

In this embodiment, it is assumed that delivery can be performed in the on-demand mode and the party mode. However, the operation for mode selection may be performed by using an operator that is disposed in the contents server device 1 or be performed by an operation input that is input to the client device 2 to be described later.

### [1-3: Client Device]

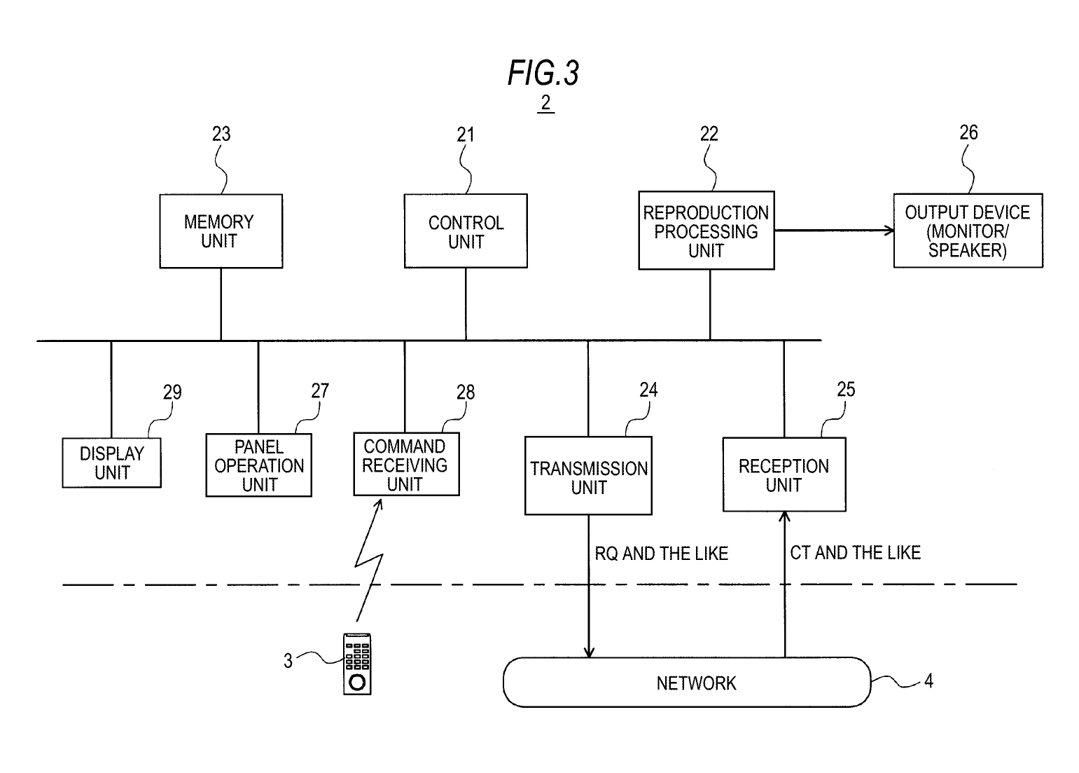

Subsequently, the configuration of the client device 2 will be described with reference to FIG. 3.

The client device 2 includes a control unit 21, a reproduction processing unit 22, a memory unit 23, a transmission unit 24, a reception unit 25, an output device 26, a panel operation unit 27, a command receiving unit 28, and a display unit 29.

The control unit 21 is configured by a microcomputer that includes a CPU, a ROM, a RAM, and the like.

In the ROM inside the control unit 21, for example, various types of setting information used for a reproduction operation for delivery content, a communication operation with the contents server device 1, and the like are stored, in addition to a program to be executed by the CPU. The RAM is a main memory device unit for the CPU.

The control unit 21 controls the overall operation of the client device 2. In other words, in the delivery operation in the party mode or the on-demand mode, the control unit 21 performs control of a reception of content data CT and the like, a process of controlling the transmission of a change request RQ and the like according to a user operation, and the like.

The memory unit 23 collectively represents the memory units such as the RAM, the ROM, the flash memory, and the like. This memory unit 23 may be used as a work area for the process of the control unit 21 or a storage area of a program. In addition, the memory unit 23 is used for storing various types of setting information, parameters, or the like used for a reproduction operation or a communication operation.

Furthermore, the memory unit 23 is used as a buffer memory of the received content data CT.

The transmission unit 24 and the reception unit 25 serve as communication units for the contents server device 1 through the network 4.

The reception unit 25 receives signals transmitted from the contents server device 1, for example, delivered content data CT, other various command signals, and the like. The reception unit 25 decodes the received signals. When the content data CT is received through the delivery operation, the reception unit 25, for example, transmits the received content data CT (stream data), for which a decoding process according to the communication method has been performed, to the memory unit 23 so as to be buffered under the control of the control unit 21.

On the other hand, when receiving a signal of a command, a notification, or the like from the contents server device 1, the reception unit 25 decodes the signal and delivers the content of the received information to the control unit 21.

The transmission unit 24 performs a predetermined encoding process for the signal transmitted to the contents server device 1 and transmits and outputs the encoded signal to the network 4, under the control of the control unit 21. For example, the transmission unit 24 performs a transmission process of a content change request RQ and the like.

By performing such processes, the transmission unit 24 and the reception unit 25 perform the encoding process, the decoding process, and the transmission and reception process according to the wired or wireless communication method employed in the network 4.

The reproduction processing unit 22 performs for the received content data CT a process for the reproduction and output thereof in the output device 26. For example, the received content data CT is buffered in the memory unit 23, and each data configuring the buffered content data CT is sequentially transmitted to the reproduction processing unit 22 at a predetermined timing. The reproduction processing unit 22 performs a process for output of the content data CT such as a decoding process for a compression process, an error correction process, and a D/A conversion process and supplies a video signal and an audio signal to the output device 26.

The output device 26, for example, is a monitor display device or a speaker device. A video or an audio as the content data CT is output by the output device 26 and is provided for a user's viewing or listening.

It is apparent that the monitor display device or the speaker device as the output device 26 may be integrally formed with the casing of the client device 2 or may be configured as a separate device.

The display unit 29, for example, is a small-size display panel that is disposed on the casing of the client device 2. The display unit 29 performs operation status display, menu display, icon display, equalizer display, title display, message display, and the like under the control of the control unit 21. The display unit 29, for example, is configured by a liquid crystal panel, an inorganic EL panel, or the like.

In addition, such displays can be performed by using the monitor display device of the output device 26. In such a case, the display unit 29 may be considered not to be arranged.

In addition, a case where a voice message is output instead of or together with the message display may be considered. In such a case, the speaker of the output device 26 may be considered to be used.

The panel operation unit 27 collectively represents operators such as operation keys, a jog dial, and the like that are disposed, for example, on the casing of the client device 2. In a case where touch panel input can be made in the display unit 29 or the monitor display device of the output device 26, the touch panel mechanism configures one of the panel operation units 27.

In addition, the command receiving unit 28 receives command information from the remote commander 3. The remote commander 3 is a device that transmits command information corresponding to a user operation by using a method using waves, infrared rays, or wires. The command information transmitted from the remote commander 3 is received and demodulated by the command receiving unit 28 and is delivered to the control unit 21.

The user can perform various operation inputs through an operation for the operators of the panel operation unit 27, a touch panel operation for the menu display or the icon display of the display unit 29 (or the monitor display device of the output device 26), or an operation using the remote commander 3.

The control unit 21 performs an operation, a setting process, or the like inside the client device 2 in accordance with a user's operation input or performs a process of transmitting a signal from the transmission unit 14 to the contents server device 1.

In this embodiment, the user can perform an operation input requesting to change the delivery content. When detecting the operation input, the control unit 21 performs a process of transmitting a change request RQ from the transmission unit 14 to the contents server device 1.

### [1-4: Device Serving As Both Server and Client]

The contents server device 1 and the client device 2 shown in FIGS. 2 and 3 have been described as separate devices. For a practical application, a device serving as both the server and the client having all the functions of both the contents server device 1 and the client device 2 may be considered.

For example, it may be configured such that a device serving as both the server and the client is arranged in each room R0 to R3 shown in FIG. 1, and each device arbitrarily serves as the contents server device 1 or the client device 2.

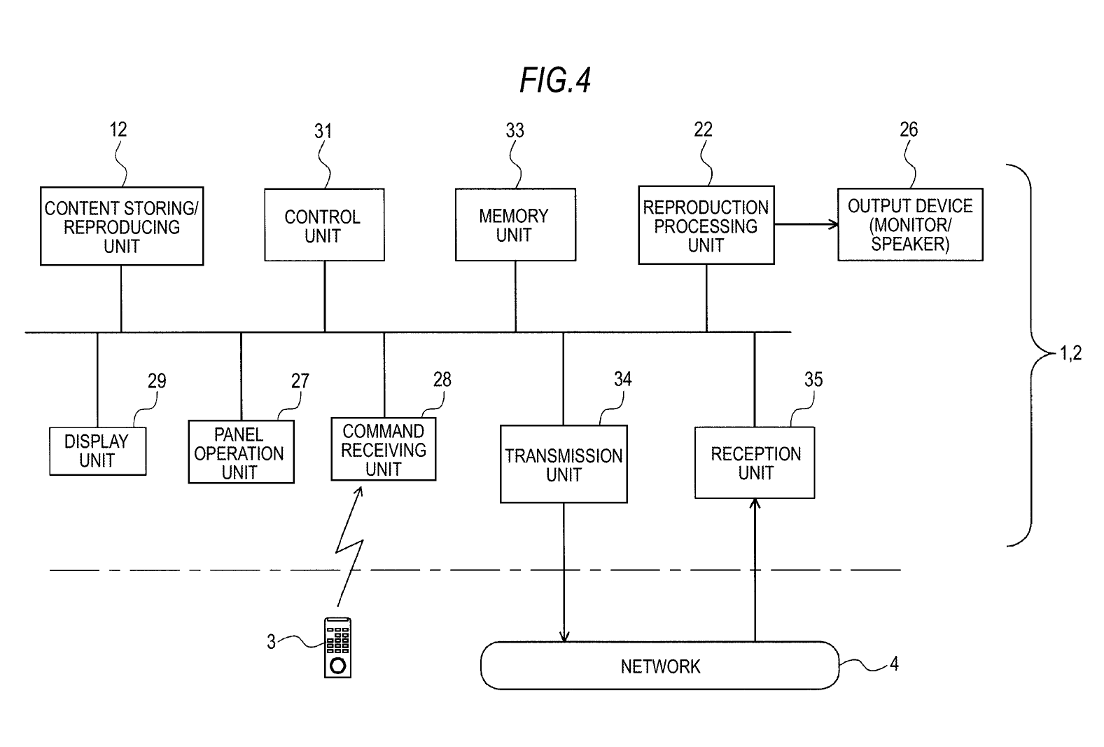

FIG. 4 shows an example of the configuration of the device serving as both the server and the client.

In this case, an example is represented in which a control unit 31, a content storing/reproducing unit 12, a memory unit 33, a reproduction processing unit 22, an output device 26, a panel operation unit 27, a command receiving unit 28, a display unit 29, a transmission unit 34, and a reception unit 35 are included.

The operations of the content storing/reproducing unit 12, the reproduction processing unit 22, the output device 26, the panel operation unit 27, the command receiving unit 28, and the display unit 29 are the same as described above.

The control unit 31 has the functions of both the above-described control units 11 and 21. In other words, when serving as the contents server device 1, the control unit 31 performs the same process as that of the control unit 11. On the other hand, when serving as the client device 2, the control unit 31 performs the same process as that of the control unit 21.

The memory unit 33 stores or buffers information that is necessary as the contents server device 1 and the client device 2.

The transmission unit 34 and the reception unit 35 perform communicating operations that are necessary when the above-described device serves as the contents server device 1 or the client device 2, under the control of the control unit 31.

When such a device serving as the server and the client is configured and is arranged in each of the rooms R0 to R3, a usage form can be configured in which a user arbitrarily selects a specific device serving as both the server and the client as a master, that is, a contents server device 1 and allows the device to deliver content to another device serving as both the server and the client.

### 2. First Embodiment

### [2-1: Overview of Operation]

Hereinafter, a delivery operation according to each embodiment will be described. In the description of each embodiment, it is assumed that the content data CT to be delivered is music content. However, generally, the embodiment can be applied to the case of delivery of another type of content such as video content, game content, or text content.

In each embodiment, the operation in the case of delivery in the party mode has distinctive features. Accordingly, the description of the operation in the party mode will be presented, and the detailed description of the operation in the on-demand mode will be omitted.

In order to identity a plurality of the client devices 2 in the description, reference numerals such as 2A, 2B, and 2C will be used for the client devices. Similarly, in order to identify the content data CT, reference numerals such as CT-A and CT-B will be used for the content data. In the case delivery of music content, for example, the content data CT-A and the content data CT-B may be regarded as different musical pieces.

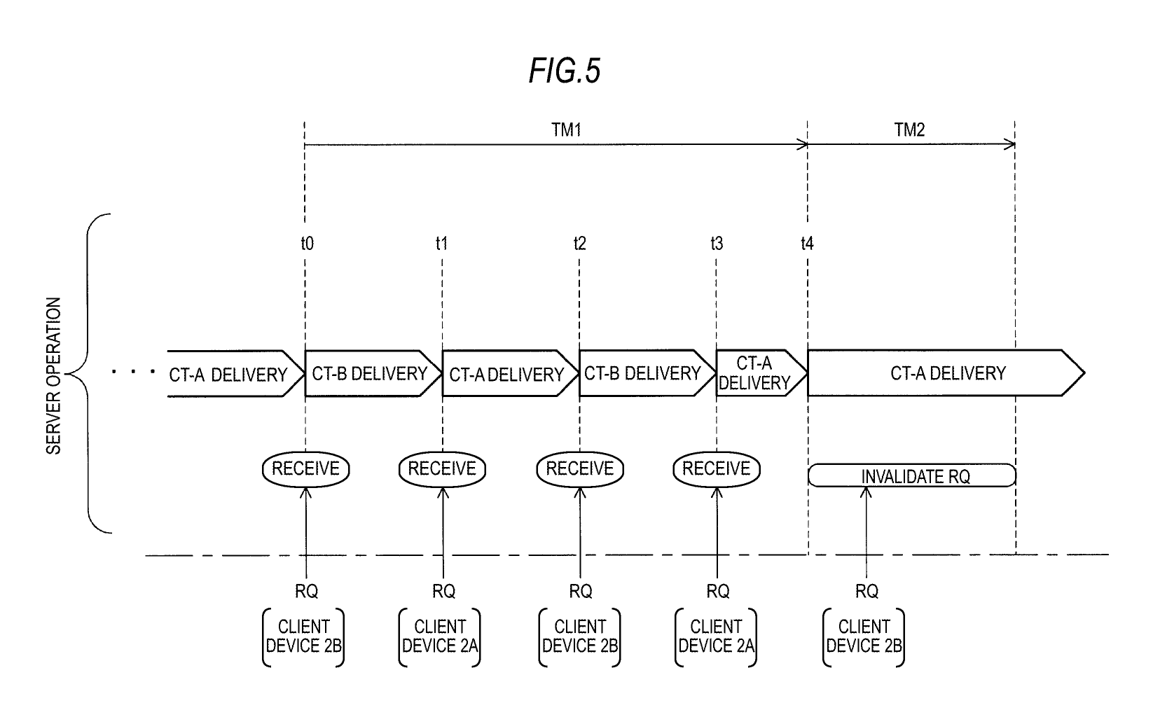

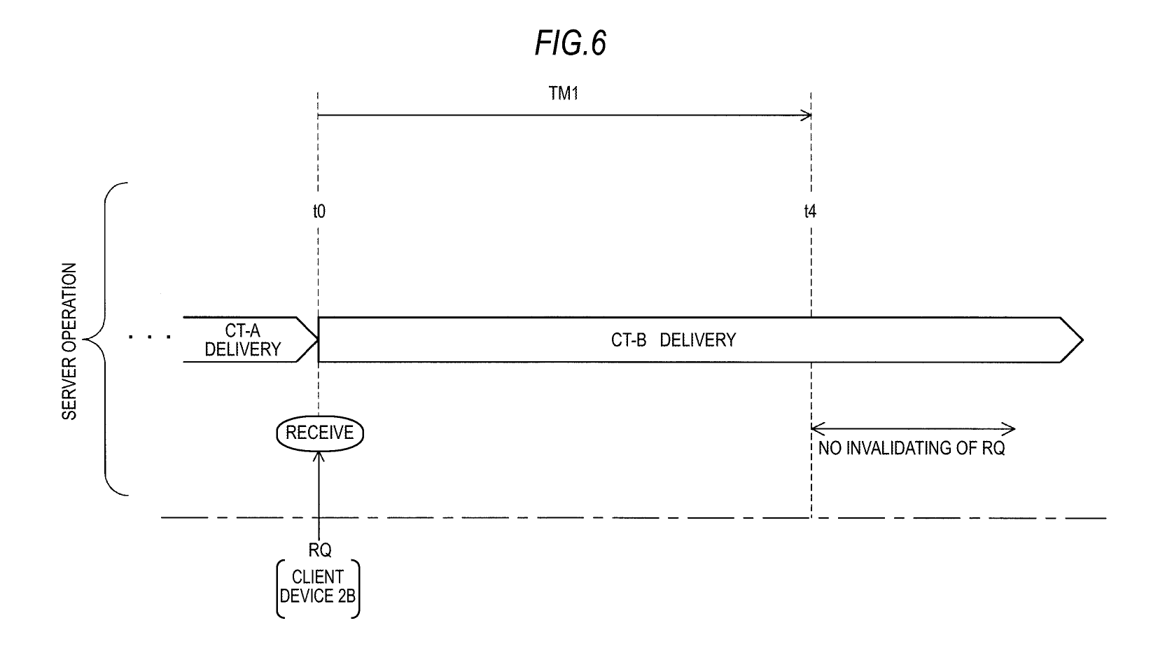

The overview of the operation according to a first embodiment will be described with reference to FIGS. 5 and 6.

FIG. 5 represents content data CT that is delivered in the party mode along the time axis.

First, it is assumed that the contents server device 1 delivers content data CT-A to all the client devices 2 until a time point t0.

At this time point t0, it is assumed that a user who is present in the room of a client device 2B desires to listen to another musical piece and performs an operation of requesting to deliver another content data CT-B through an operation input for the client device 2B. The client device 2B transmits a change request RQ having such content to the contents server device 1.

The contents server device 1 receives the change request RQ that is transmitted at time point t0 as described above. The contents server device 1 changes the delivery content to the content data CT-B in response to the change request RQ and delivers the changed content to each client device 2.

In other words, the musical piece delivered to all the rooms R0 to R3 is changed over.

Here, it is assumed that a user who is present in another room is not satisfied with the change to the content data CT-B and performs an operation of requesting to deliver the original content data CT-A through an operation input for the client device 2A at time point t1. The client device 2A transmits a change request RQ having such content to the contents server device 1.

The contents server device 1 receives the change request RQ that is transmitted at time point t1 as described above. The contents server device 1 changes the delivery content to the content data CT-A again in response to the change request RQ and delivers the changed content to each client device 2.

In other words, the musical piece delivered to all the rooms R0 to R3 is changed over to the content data CT-A again.

FIG. 5 represents a state in which the user using the client device 2B and the user using the client device 2A contest to make the change requests RQ at time points t2 and t3 after that, and the change requests RQ are tangled.

Since the contents server device 1 changes the delivery content every time a change request RQ is received, the music played in all the rooms R0 to R3 is changed over many times, and a situation occurs in which it is difficult to listen to the music.

Such a situation is not desirable, for example, during a party or the like. Accordingly, as an operation according to the first embodiment, generation of frequency change requests RQ is not permitted.

More specifically, the contents server device 1 starts to make a count of a first period TM1 from when the first change request RQ is received at the time point to.

Until a time point t4 when this period TM1 elapses, the contents server device 1 checks the status of the reception of an additional change request. In other words, the contents server device 1 checks whether another change request RQ has been received. When another change request RQ is received, the contents server device 1 accepts the change request RQ and changes the delivery content.

However, when the change requests RQ are frequently generated within the period TM1, the contents server device 1 performs a process of invalidating the change request RQ during a second period TM2 after the elapse of the period TM1. In other words, in a case where there is a status (a tangle of the change requests RQ) such as a so-called channel conflict, even when a change request RQ is received from the client device 2 in the period TM2, the contents server device 1 does not change the delivery content by invalidating the change request RQ.

In addition, the contents server device 1 retroactively invalidates the tangled change requests RQ within the period TM1 after the elapse of the period TM1 and delivers the content data CT-A, which has been originally delivered, from a time point t4.

The contents server device 1 completes the process of invalidating the change request RQ after the elapse of the second period TM2 and is returned to a state of accepting a change request RQ as is normal. Thereafter, when there is a change request RQ, a count of the period TM1 is made from when the first change request RQ is received, and the same process is performed.

FIG. 6 represents a case where an additional change request RQ is not received within the period TM1.

When receiving a change request RQ at the time point to, for example, from the client device 2B, the contents server device 1 changes the delivery content to the content data CT-B, similarly to the case shown in FIG. 5. Then, the contents server device 1 starts to make a count of the period TM1.

In a case where another change request RQ is received within this period TM1 or in a case where the number of received change requests RQ until the time point t4 when the period TM1 elapses from the time point t0 is less than a predetermined number even when another change request RQ has been received, the contents server device 1 determines that the change requests RQ are not tangled. In such a case, the process of invalidating the change request RQ after the time point t4 is not performed. Then, the delivery of the content data CT-B that has been changed at the time point t0 is continued.

As above, according to the first embodiment, when a change request RQ requesting to change the delivery content is received from a client device during the delivery operation in the party mode, first, the status of the reception of an additional change request RQ is checked within the first period TM1 that is started to be counted based on the reception. Then, the process after the elapse of the period TM1 is determined based on the status of the reception of the change request within the period TM1.

Particularly when the number of detected change requests RQ within the period TM1 is equal to or greater than a predetermined number, the process of invalidating the received change request RQ is performed in the second period TM2 that is started to be counted after the elapse of the first period TM1. In such a case, the change requests RQ (the change requests RQ made at time points t0, t1, t2, and t3 shown in FIG. 5) within the period TM1 are invalidated, and the original content data CT-A is delivered from the time point t4. For example, the delivery is resumed from the delivery point of the content delivered at the time point t0.

On the other hand, when the number of the detected change requests RQ within the period TM1 is less than the predetermined number, the process of invalidating the change request RQ is not performed after the elapse of the first period TM1. As the delivery content, the delivery of content data after being changed in accordance with the last change request RQ within the period TM1 is continued.

### [2-2: Functional Configuration of Server and Client]

The configuration of the contents server device 1 and the client device 2 for implementing such operations, particularly, the functional configuration of the control units 11 and 21 will be described.

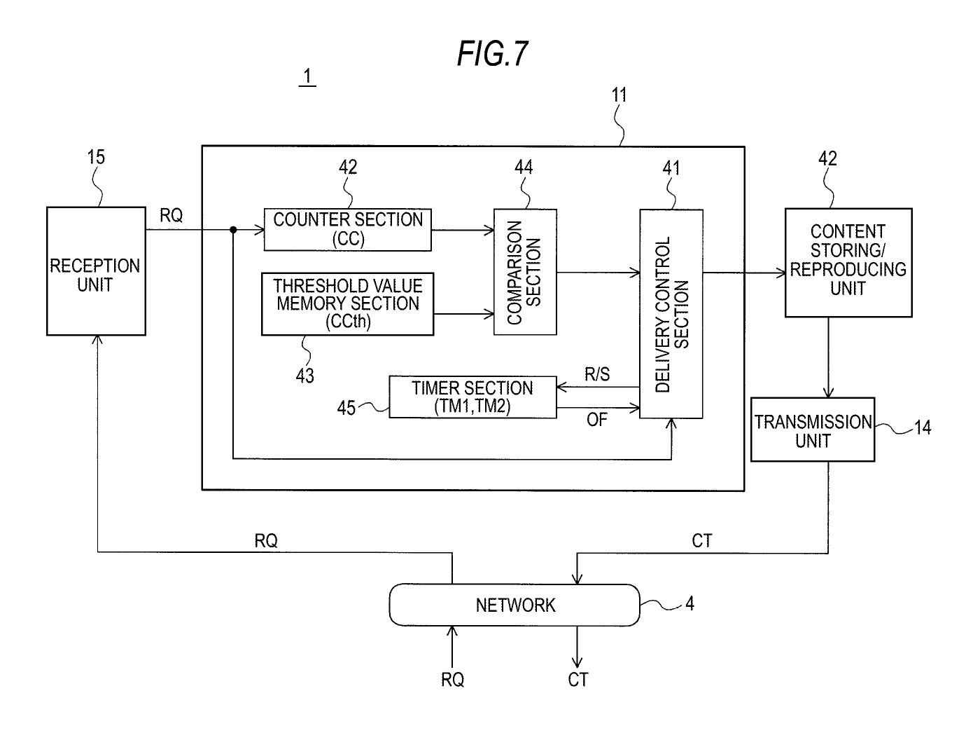

FIG. 7 shows the configuration of the contents server device 1 and particularly represents an example of the configuration of the function that is realized by the hardware and the software (program) of the control unit 11.

As the functional configuration of the control unit 11, a delivery control section 41, a counter section 42, a threshold value memory section 43, a comparison section, and a timer section 45 are included.

The delivery control section 41 is a functional portion that controls the delivery operation in the party mode or the on-demand mode. The delivery control section 41 controls to designate content data CT to be delivered, allow the content storing/reproducing unit 12 to reproduce the designated content data CT to be delivered, and deliver the reproduced content data CT from the transmission unit 14 to each client device 2.

A change request RQ from the client device 2 is received by the reception unit 15 and is supplied to the control unit 11. Inside the control unit 11, the change request RQ is delivered to the counter section 42 and the delivery control section 41.

In order to deliver the requested content data CT in response to the change request RQ, the delivery control section 41 directs the content storing/reproducing unit 12 to change the content data CT to be reproduced.

In addition, when the change request RQ is invalidated similarly to the period TM2 shown in FIG. 5, the delivery control section 41 processes the change request RQ as an invalid signal.

The counter section 42 has a counting function for counting the number CC of the received change requests RQ. The number of the change requests RQ in the above-described period TM1 is counted as a counted value (the number of change requests) CC.

The threshold value memory section 43 has a function of storing a threshold value CCth that is used for determining the number of the change requests RQ.

The comparison section 44 compares the number CC of change requests output by the counter section 42 and the threshold value CCth. Then, the comparison section 44 outputs a comparison result signal indicating whether CC≧CCth to the delivery control section 41.

When the number CC of change requests is equal to or greater than the threshold value CCth within the period TM1, the delivery control section 41 determines that a tangle of the change requests RQ occurs. On the other hand, when the number CC of the change requests is less than the threshold value CCth, the delivery control section 41 determines that a tangle of the change requests RQ does not occur.

The timer section 45 has a time counting function which is started by the delivery control section 41 and counts the periods TM1 and TM2. The delivery control section performs counting by transmitting a reset/start signal (R/S) to the timer section 45. In addition, the timer section 45 notifies the delivery control section 41 of the elapses of the periods TM1 and TM2 by transmitting a timer overflow signal OF to the delivery control section 41 when the periods TM1 and TM2 elapse.

More specifically, when there is the first change request RQ (the first change request in a case where counting of the periods TM1 and TM2 is not performed), the delivery control section 41 starts to make a count of the period TM1 by transmitting a counting start signal to the timer section 45.

The delivery control section 41 can check the elapse of the period TM1 based on the overflow signal OF transmitted from the timer section 45.

When performing the process of invalidating the change request RQ in the period TM2, the delivery control section 41 starts to make a count of the period TM2 by transmitting a reset/start signal to the timer section 45 after the elapse of the period TM1.

Similarly, the delivery control section 41 can check the elapse of the period TM2 based on the overflow signal OF transmitted from the timer section 45.

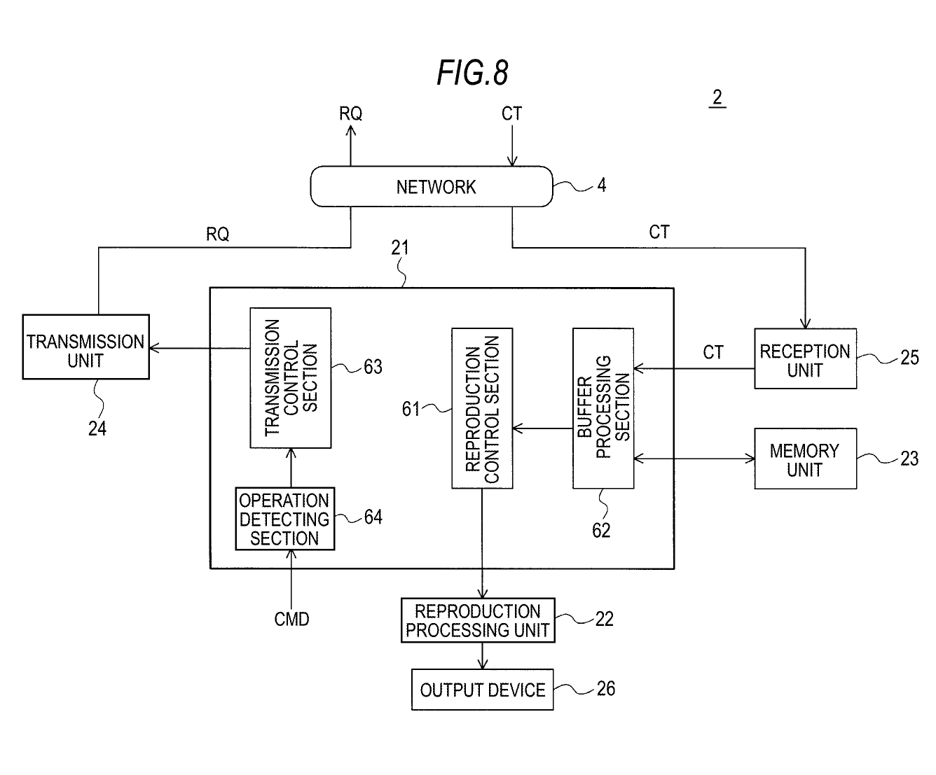

FIG. 8 shows the configuration of the client device 2 and particularly represents an example of the configuration of the function that is realized by the hardware and the software (program) of the control unit 21.

As the functional configuration of the control unit 21, a reproduction control section 61, a buffer processing section 62, a transmission control section 63, and an operation detecting section 64 are included.

The reproduction control section 61 has a function of controlling the reproduction and the output of the delivered content data CT. The buffer processing section 62 has a function of managing buffering of the received content data CT.

The content data CT delivered from the contents server device 1 is received by the reception unit 25 and, first, is buffered in the memory unit 23 under the control of the buffer processing section 62. The buffer processing section 62 sequentially reads out the buffered data from the memory unit 43 and delivers the read-out data to the reproduction control section 61. The reproduction control section 61 transfers the data to the reproduction processing unit 22 and controls to output the data from the output device 26 by allowing the reproduction processing unit 22 to perform a necessary process such as a compression decoding process.

The operation detecting section 64 has a function of detecting a command signal CMD. The transmission control section 63 has a function of controlling a transmission operation.

As described above, the user can perform an operation input by using the panel operating unit 27, the touch panel, or the remote commander 3. As one of the operations using these, there is a change requesting operation. When detecting a command signal CMD as a change request, the operation detecting section 64 notifies the transmission control section 63 of the information.

In response to the command signal CMD as the change request, the transmission control section 63 generates transmission data as a change request RQ and controls to transmit the transmission data from the transmission unit 24 to the contents server device 1.

### [2-3: Example of Process of Server And Client]

According to the above-described functional configuration, the operations described with reference to FIGS. 5 and 6 are realized. Hereinafter, an example of the process of the contents server device 1 and the client device 2 will be described.

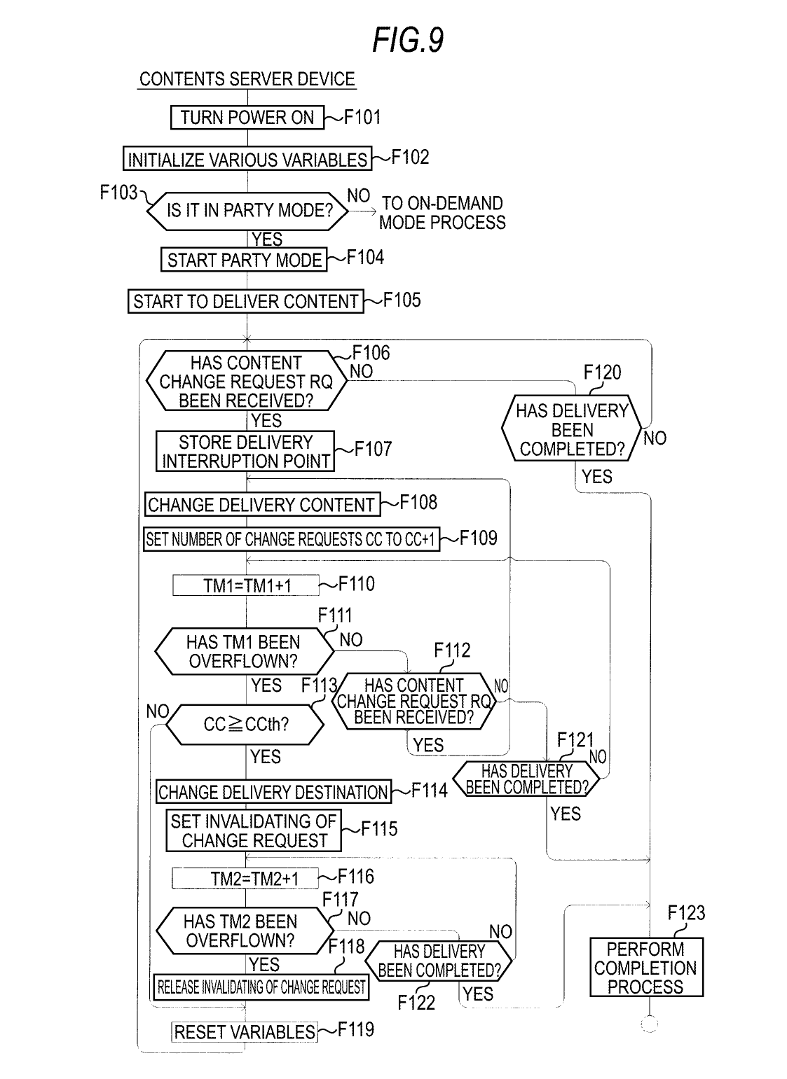

First, an example of the process of the control unit 11 (mainly, the delivery control section 41) of the contents server device 1 according to the functional configuration shown in FIG. 7 will be described with reference to FIG. 9.

Step F101 represents a process that is started by turning on the power. When being started by turning on the power, the control unit 11 proceeds to Step F102 and initializes various variables.

In Step F103, the control unit 11 checks the mode setting of the party mode or the on-demand mode. The mode setting is performed through a user's setting operation or the like. However, for example, the control unit 11 determines a mode so as to start with the party mode at this time or the like when the operation has been previously completed in the party mode. Alternatively, it may be configured such that the user selects a mode.

In Step F103, when the on-demand mode is determined at this time, the control unit 11 proceeds to the process of the on-demand mode. The description of the process in the on-demand mode will be omitted.

On the other hand, when the party mode is determined, the control unit 11 proceeds to Step F104 and performs a process of starting the process of the party mode. For example, the control unit 11 performs a process of determining content to be delivered or the like.

In Step F105, the control unit 11 performs delivery start control. In other words, the control unit 11 directs the content storing/reproducing unit 12 to start to reproduce predetermined content data CT. Then, the control unit 11 supplies the reproduced contents data CT to the transmission unit 14 and allows the transmission unit 14 to deliver the reproduced content data CT to all the client devices 2.

Thereafter, the control unit 11 allows the content storing/reproducing unit 12 and the transmission unit 14 to sequentially reproduce and deliver the content data CT continuously. The content data CT to be reproduced may be in order of content numbers that are stored in a recording medium by the content storing/reproducing unit 12, or the content may be randomly selected and sequentially directed to be reproduced by the control unit 11.

In either case, after Step F105, basically a plurality of musical pieces are sequentially delivered in common to all the client devices 2 until delivery is completed.

As above, in the middle of the content delivery in the party mode, the control unit 11 monitors the reception of a change request RQ in Step F106 and monitors a delivery completion trigger in Step F120.

In Step F120, the control unit 11 monitors the operation or the status as a delivery completion trigger. For example, there is a case where the delivery operation is completed in accordance with a user's delivery completing operation, a case where the delivery operation is completed in accordance with a power-off operation, and the like. In addition, there is a case where the delivery operation is completed in accordance with the completion of the reproduction and the delivery of all the contents (or all the contents selected as delivery targets).

When such a completion trigger is detected, the control unit 11 proceeds from Step F120 to Step F123 and performs a process of completing the delivery operation in the party mode.

In Step F106, the control unit 11 monitors whether a change request RQ has been received by the reception unit 15.

When detecting the reception of the change request RQ in Step F106, the control unit 11 starts the process for performing the operations described with reference to FIGS. 5 and 6. The change request RQ detected in Step F106 is a change request RQ that is at the time point t0 shown in FIGS. 5 and 6, that is, a starting point of a count of the period TM1.

First, in Step F107, the control unit 11 stores an interruption point of the content data CT that is in the middle of a delivery operation at a time point when the change request RQ is received. In the case shown in FIG. 5, since content data CT-A is delivered until the time point t0, a reproduction point at the time point t0 in the middle of a musical piece as the content data CT-A becomes the interruption point described here.

Next, the control unit 11 controls to change the delivery content in response to the change request RQ in Step F108. For example, the control unit 11 allows the content storing/reproducing unit 12 and the transmission unit 14 to reproduce and deliver the content data CT-B.

In addition, the control unit 11 increments the number CC of change requests as the function of the counter section 42 in Step F109. Initially, CC=1.

Furthermore, the control unit 11 performs a process of making a count of the period TM1 as the function of the timer section 45 in Step F110. Here, the control unit 11 increments “TM1” as a counting value of the timer section 45.

Thereafter, until the counting value TM1 is overflown, in other words, until the period TM1 described with reference to FIGS. 5 and 6 elapses, the control unit 11 performs the increment operation of Step F110 while performing monitoring of the reception of a change request RQ in Step F112 and monitoring of a delivery completion trigger in Step F121. In other words, the control unit 11 advances time counting as the period TM1.

When a delivery completion trigger occurs before the elapse of the period TM1, the control unit 11 proceeds from Step F121 to Step F123 and performs a delivery completing process.

In addition, when receiving another change request RQ before the elapse of the period TM1, the control unit 11 returns the process from Step F112 to Step F108.

In this case, the control unit 11 controls to change delivery content in response to the new change request RQ in Step F108. Accordingly, the musical piece that is delivered is changed.

In addition, the control unit 11 increments the number CC of change requests as the function of the counter section 42 in Step F109.

As above, every time that a change request RQ is received until the elapse of the period TM1, the control unit 11 changes the delivery content and increments the number CC of change requests.

When the counting value “TM1” in the timer section 45 is overflown, in other words, when the period TM1 elapses, the control unit 11 proceeds from Step F111 to Step F113 and checks a comparison result at this time point based on the function of the comparison section 44. In other words, it is determined whether the number of received change requests RQ within the period TM1 is equal to or greater than a predetermined number as the threshold value CCth.

When the threshold value is set as CCth=3, for example, it is determined whether the number of the received change requests RQ including the first change request RQ is equal to or greater than three.

When CC<CCth, the control unit 11 determines that a tangle of change requests RQ (a conflict of the selection of delivery content) does not occur in the period TM1 and proceeds to Step F119. Then, the control unit 11 resets the variables, that is, the counting value “TM1” and the number CC of change requests in this case and returns the process back to the monitoring loop of Steps F106 and F120.

This is an operation in a case where the description is presented with reference to FIG. 6.

On the other hand, when CC≧CCth, the control unit 11 determines that a tangle of change requests RQ occurs in the period TM1, and proceeds to Step F114.

In Step F114, first, the control unit 11 changes a delivery destination. Here, the control unit 11 allows the content storing/reproducing unit 12 and the transmission unit 14 to reproduce and deliver the content by controlling the content storing/reproducing unit 12 so as to resume the delivery operation from the delivery interruption point stored in Step F107. In other words, the change requests RQ until the time point when the period TM1 elapses, that is, the change requests RQ detected in Step F106 or Step F112 are regarded not to have been received, and the state is returned to a state before the reception of the change requests RQ.

Next, the control unit 11 performs invalidation setting of a change request RQ in Step F115. In other words, thereafter, even when a change request RQ is received, the change request RQ is invalidated, and the delivery content is not changed.

Then, in Step F116, the control unit 11 performs a process of making a count of the period TM2 as the function of the timer section 45. Here, “TM2” as a counting value in the timer section 45 is incremented.

Thereafter, until the counting value TM2 is overflown, in other words, until the period TM2 described with reference to FIG. 5 elapses, the control unit 11 performs the increment operation of Step F116 while monitoring a delivery completion trigger in Step F122. In other words, the control unit 11 advances time counting as the period TM2.

When a delivery completion trigger occurs before the elapse of the period TM2, the control unit 11 proceeds from Step F121 to Step F123 and performs a delivery completing process.

In addition, although there is a case where a change request RQ is received before the elapse of the period TM2, the invalidation setting is performed in the above-described Step F115, and accordingly, even when a change request RQ is received, the control unit 11 does not recognize it as a change request RQ. In other words, a change request RQ is ignored until the period TM2 elapses.

When the counting value “TM2” in the timer section 45 is overflown, in other words, when the period TM2 elapses, the control unit 11 proceeds from Step F117 to Step F118 and releases the invalidation setting of a change request RQ. Then, the variables, that is, the counting values “TM1”, “TM2”, and the number CC of change requests in this case are reset in Step F119, and the process is retuned back to the monitoring loop of Steps F106 and F120. This is the operation in the case shown in FIG. 5.

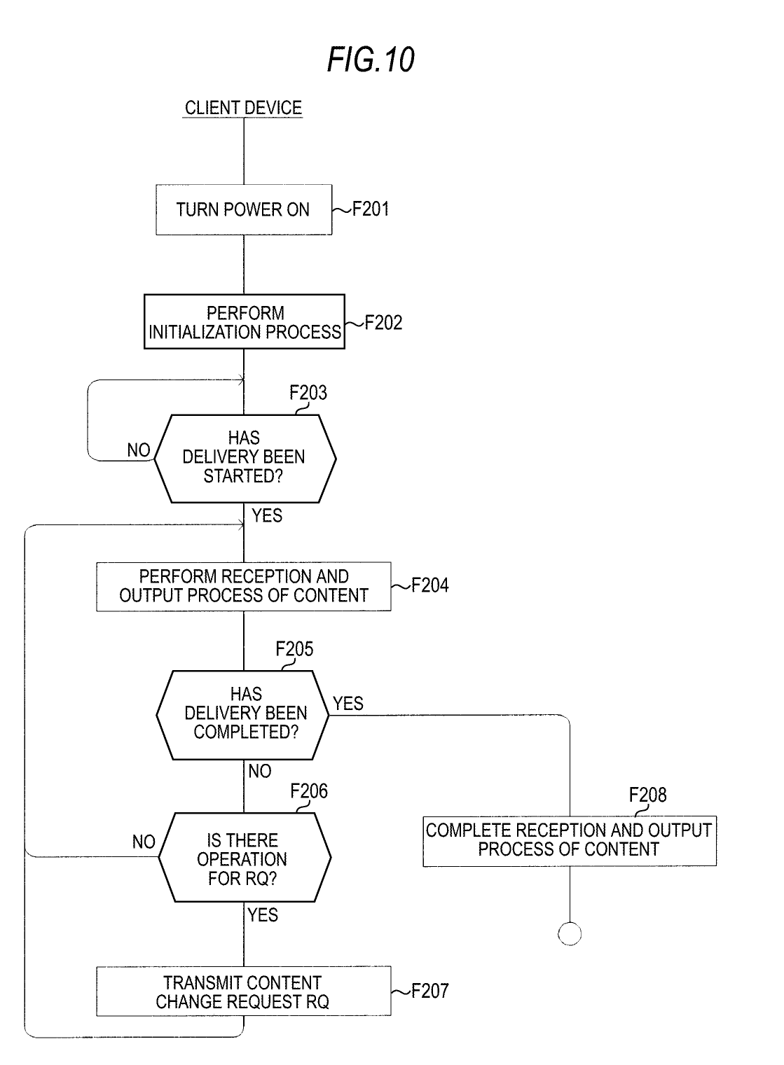

Next, an example of the process of the control unit 21 of the client device 2 will be described with reference to FIG. 10.

Step F201 represents a process that is started by turning on the power. When being started by turning on the power, the control unit 21 proceeds to Step F202 and performs various initialization processes.

In Step F203, the start of a delivery operation of the contents server device 1 is waited. When delivery, that is, the reception of content data CT in the reception unit 25 is started, the process proceeds from Step F203 to Step F204, and the control unit 11 receives and outputs the content data CT. In other words, thereafter, a buffering process of the received content data CT and the supply of the received content data CT to the reproduction processing unit 22 are performed, and the control unit 11 allows the output device to output an audio or a video.

After the start of the delivery operation, the control unit 21 performs a process of monitoring the completion of delivery in Step F205 and monitors a user operation for a change request in Step F206 while performing the process of Step F204.

When the delivery operation of the contents server device 1 is completed, and the content data CT is not received, the control unit 21 proceeds from Step F205 to Step F208. Then, the control unit 21 completes the output of the audio or video as the content data CT from the output device by stopping buffering of the received content data CT and supplying the received content data CT to the reproduction processing unit 22.

When detecting an operation for a change request as a user operation, the control unit 21 proceeds from Step F206 to Step F207. Then, in Step F207, the control unit 21 performs a process of transmitting a change request RQ from the transmission unit 24 to the contents server device 1.

In addition, although there are actually processes corresponding to other user operations, the processes are omitted in FIG. 10.

As above, the client device 2 transmits a change request RQ in accordance with a user operation while outputting the delivery content. Accordingly, the user using the client device 2 can request to change the delivery content at an arbitrary time point during the delivery operation.

As the contents server device 1 and the client device 2 perform the above-described processes represented in FIGS. 9 and 10, the operations described with reference to FIGS. 5 and 6 are realized.

According to the above-described first embodiment, the following advantages can be acquired.

First, in the middle of the delivery operation in the party mode, users using the client devices 2 disposed in each of the rooms R0 to R3 can freely request to change the delivery content. Then, the delivery content is changed in accordance with the transmission of a change request RQ. Accordingly, it is convenient when any of the users desires to view or listen to a specific piece, a video, or the like.

Then, particularly when there is no conflict in the selection of content, the changed content is delivered (the state represented in FIG. 6). In other words, content delivery according to a user's wish can be realized in the party mode.

On the other hand, there are cases where the change requests RQ are frequently generated temporarily, and there is a conflict in the selection of delivery content. Occasionally, when the delivery content is changed, it may offend other users or spoil the mood of a party or the like.

Thus, frequent changes are allowed only over a short time within the period TM1, and a request change RQ is invalidated in the following period TM2. In other words, when there is a conflict in the change requests RQ, the influence of the conflict on the delivery content is temporarily, and immediately a calm state (the period TM2) is formed in which the content is not changed. By limiting the period during which the content can be frequently changed as above, an adverse effects on the other users can be suppressed as to be minimal.

In other words, according to the first embodiment, by setting the period, during which the content can be frequently changed, to an allowable short period, a delivery operation corresponding to a user's wish can be performed without any conflict while the delivery operation is performed so as not to spoil the mood too much.

Furthermore, accordingly, an unnecessary authority conflict can be prevented. In addition, by setting the prohibition period, during which a content change request is not accepted, to a long period, a user gives up to change the content storing, whereby an advantage of preventing reoccurrence of the unnecessary authority conflict can be expected as well.

In addition, since the delivery content is unconditionally changed in response to a change request RQ during the period TM1, it is not appropriate to set the period TM1 to too long. Thus, the period TM1 is considered to be set in the range of about 30 seconds to about 3 minutes.

However, the appropriate time may be considered to be in a broad range in accordance with a use form, the situation at the time of use, the type of guests for the party, and the like. For example, the period TM1 may be considered to be about 10 minutes. Accordingly, a case where the length of the period TM1 is set by a user may be considered.

In addition, since the period TM2 may be considered as a vindicatory process for a case where there is a conflict, there are many cases where the period TM2 is preferably long to some degree. For example, as the period, time that is five to ten times the period TM1 may be considered to be set.

However, the invalidation period may be considered to be set not to be long, and the period TM2 may be considered to be settable by the user.

In addition, the determination on whether or not there is a conflict is made based on whether or not the number CC of change requests is equal to or greater than the threshold value CCth. Preferably, the value of CCth is set to an appropriate value according to the length of the period TM1, the degree of allowance for a content change, and the like.

In addition, when there is a conflict, after the elapse of the period TM1, the delivery operation is resumed from the interruption point of the content data CT that is delivered until the first change request RQ is received. However, another example may be considered.

For example, the delivery operation may be resumed not from the interruption point but from the start (the head of the piece) of the delivery content before the change request RQ is received.

Alternatively, the content data CT that is delivered at the end time point of the period TM1 may be delivered.

In addition, in the above-described example, change requests RQ from all the client devices 2 in the period TM2 are invalidated. However, a change request RQ from a specific client device 2 may be invalidated. In other words, a case may be considered in which only client devices 2 that cause a tangle of change requests RQ in the period TM1, for example, change requests from only client devices 2B and 2A of the example shown in FIG. 5 are invalidated, and change requests RQ from other client devices 2C and the like are regarded as valid, for which a content changing process is performed.

In addition, in the example of the process represented in FIG. 9, although the number CC of change requests at the time point after the elapse of the period TM1 and the threshold value CCth are compared, the number CC of change requests and the threshold value CCth may be compared continually in the middle of making a count of the period TM1.

In such a case, it may be configured such that the period TM1 ends at a time point when the number CC of change requests is equal to or greater than the threshold value CCth, and the process of Step F114 and thereafter, that is, the changing to the delivery of the original content storing, the invalidating of a change request RQ, and the making of a count of the period TM2 are performed.

### 3. Second Embodiment

### [3-1: Overview of Operation]

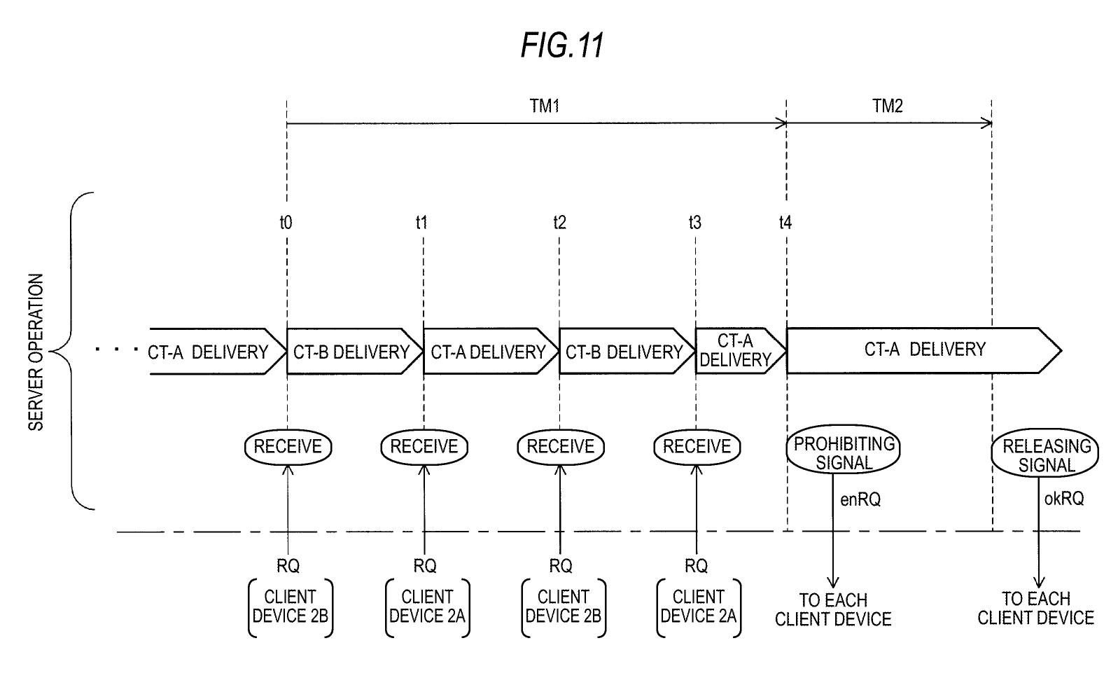

Subsequently, a second embodiment will be described. FIG. 11 represents an overview of the operation according to the second embodiment. Similarly to the above-described case shown in FIG. 5, content data CT delivered in the party mode is represented along the time axis.

First, it is assumed that the contents server device 1 delivers content data CT-A to all the client devices 2 until a time point t0.

At the time point t0, a change request RQ is assumed to be transmitted from the client device 2B.

When there is the first change request RQ at the time point t0, similarly to the above-described first embodiment, the contents server device 1 changes the delivery content and, during the period TM1, also accepts another change request RQ and changes the delivery content.

FIG. 11 shows a state in which a user using the client device 2B and a user using a client device 2A make conflicting change requests RQ at time points t1, t2, t3, and the like thereafter, and the change requests RQ are tangled.

Since the contents server device 1 changes the delivery content every time a change request RQ is received, the music played in all the rooms R0 to R3 is changed over many times, and a situation temporarily occurs in which it is difficult to listen to the music.

Also in the second embodiment, it is determined whether such a situation occurs in the period TM1, and an operation to be performed after the elapse of the period TM1 is determined.

In particular, in a case where the change requests RQ are frequently generated within the period TM1, the contents server device 1 transmits a transmission prohibiting signal enRQ of a change request to each client device 2 after the elapse of the period TM1.

In response to this, each client device 2 performs a process of prohibiting the transmission of a change request RQ. In other words, even when a user performs an operation for a change request, the client device 2 does not transmit a change request RQ to the server device 1.

In addition, the contents server device 1 retroactively invalidates the tangled change requests RQ within the period TM1 after the elapse of the period TM1 and delivers the content data CT-A, which has been originally delivered, from a time point t4.

In addition, the contents server device 1 makes a count of the period TM2 from a time point when the period TM1 elapses and transmits a transmission prohibition releasing signal okRQ to each client device 2 after the elapse of the period TM2. In response to this, each client device 2 releases the process of prohibiting the transmission of a change request RQ. In other words, thereafter, the client device 2 transmits a change request RQ to the contents server device 1 in accordance with a user operation for a change request.

Accordingly, after the second period TM2 elapses, there is a possibility that a change request RQ is transmitted to the contents server device 1 again. When there is a change request RQ, a count of the period TM1 from the reception of the first change request RQ is made, and the same process is performed.

In addition, when a tangle of change requests RQ does not occur within the period TM1, the same operation as that of the first embodiment shown in FIG. 6 is performed.

As above, according to the second embodiment, when a change request RQ requesting to change the content delivered from a client device is received in the middle of a delivery operation in the party mode, first, the status of the reception of an additional change request RQ is checked within the first period TM1 counting of which is started based on the reception. Then, the process to be performed after the elapse of the period TM1 is determined based on the status of the reception of the change request within the period TM1.

Particularly when the number of the detected change requests RQ within the period TM1 is equal to or greater than a predetermined number, a transmission prohibiting signal enRQ of a change request is transmitted to each client device 2, and a signal for releasing the change request transmission prohibition okRQ is transmitted to each client device 2 after the elapse of the period TM2. Accordingly, the client device 2 side is not allowed to transmit a change request RQ in the period TM2.

In addition, in such a case, change requests RQ (the change requests RQ made at time points t0, t1, t2, and t3 shown in FIG. 11) within the period TM1 are invalidated, and the original content data CT-A is delivered from the time point t4. For example, the delivery is resumed from the delivery point of the content delivered at the time point t0.

On the other hand, when the number of the detected change requests RQ within the period TM1 is less than the predetermined number, the process of invalidating the change request RQ is not performed after the elapse of the first period TM1. As the delivery content, the delivery of content data after being changed in accordance with the last change request RQ within the period TM1 is continued.

### [3-2: Functional Configuration of Server and Client]

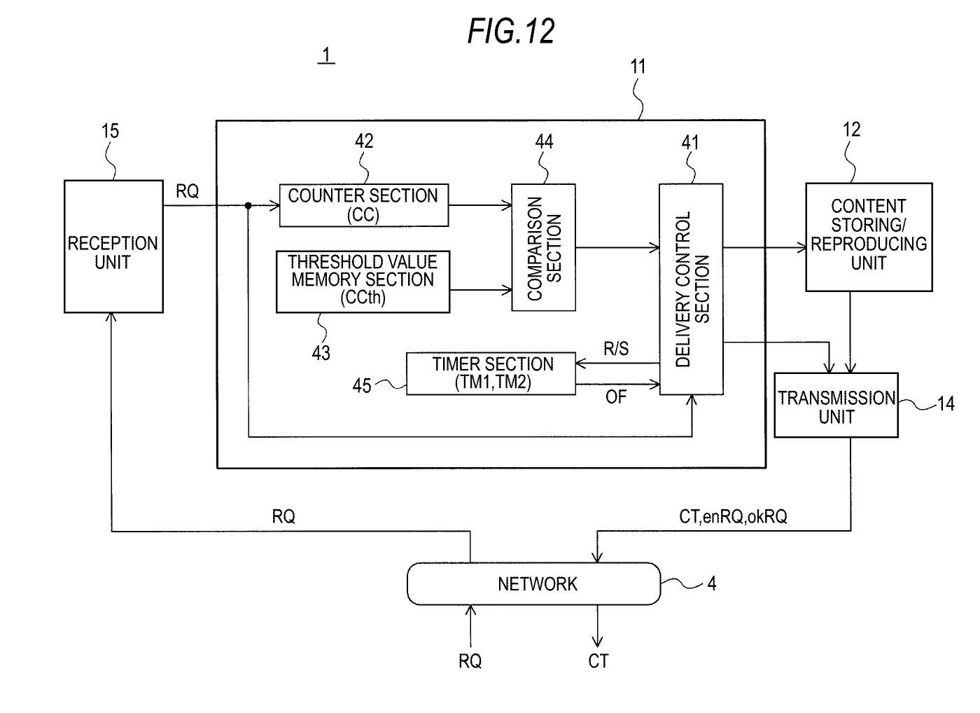

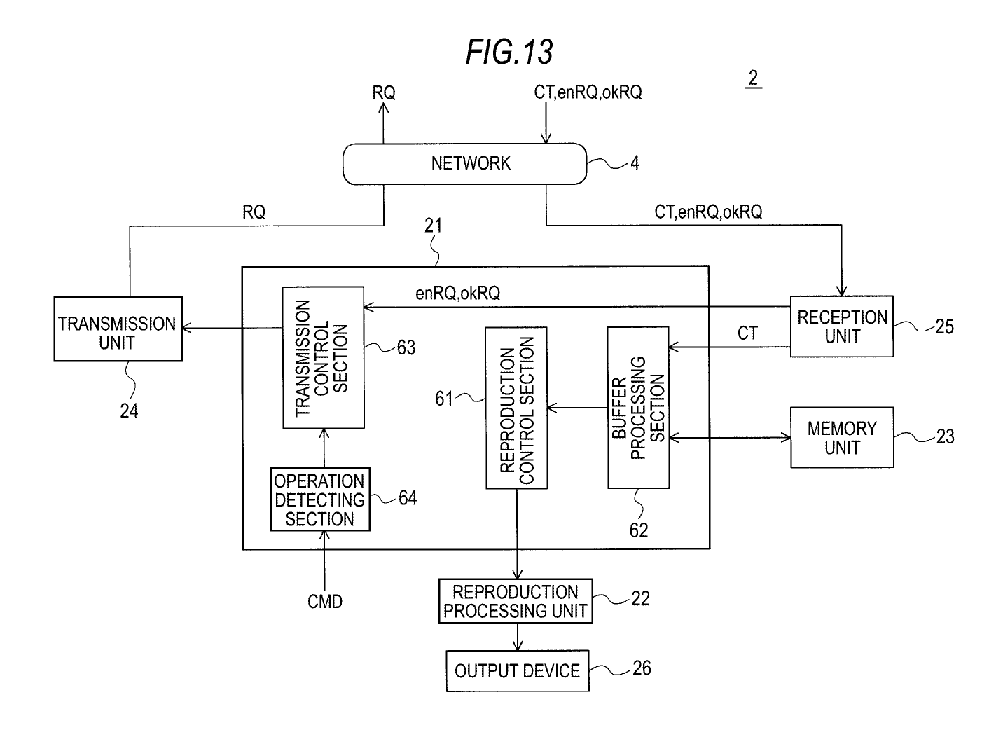

The functional configurations of the control units 11 and 21 of the contents server device 1 and the client device 2 for implementing such operations are shown in FIGS. 12 and 13.

As the functional configuration of the control unit 11 of the contents server device 1 shown in FIG. 12, a delivery control section 41, a counter section 42, a threshold value memory section 43, a comparison section 44, and a timer section are included, which is similar to that of the first embodiment.

In this case, the delivery control section 41 generates a transmission prohibiting signal enRQ and a transmission prohibition releasing signal okRQ and can transmit the generated signals from the transmission unit 14 to each client device 2, which is different from the first embodiment.

In the control unit 21 of the client device 2 shown in FIG. 13, similarly to that of the first embodiment, a reproduction control section 61, a buffer processing section 62, a transmission control section 63, and an operation detecting section 64 are included. In this case, a transmission prohibiting signal enRQ and a transmission prohibition releasing signal okRQ other than the content data CT may be received by the reception unit 25, and accordingly, the processing functions thereof are added. In other words, a transmission prohibition signal enRQ and a transmission prohibition releasing signal okRQ received by the reception unit 25 are supplied to the transmission control section 63, and the transmission control section 63 sets whether or not the transmission of a change request RQ is allowed in accordance with the signals. In particular, when the transmission prohibiting signal enRQ is input, the transmission control section 63 sets the transmission prohibition, and thereafter, even when an operation for a change request RQ is detected by the operation detecting section 64, the transmission control section 63 dose not perform a process of transmitting the change request RQ. In addition, thereafter, when a transmission prohibition releasing signal okRQ is input, the transmission control section 63 releases the set transmission prohibition.

### [3-3: Example of Process of Server And Client]

An example of the process of the contents server device 1 and the client device 2 according to the second embodiment will now be described.

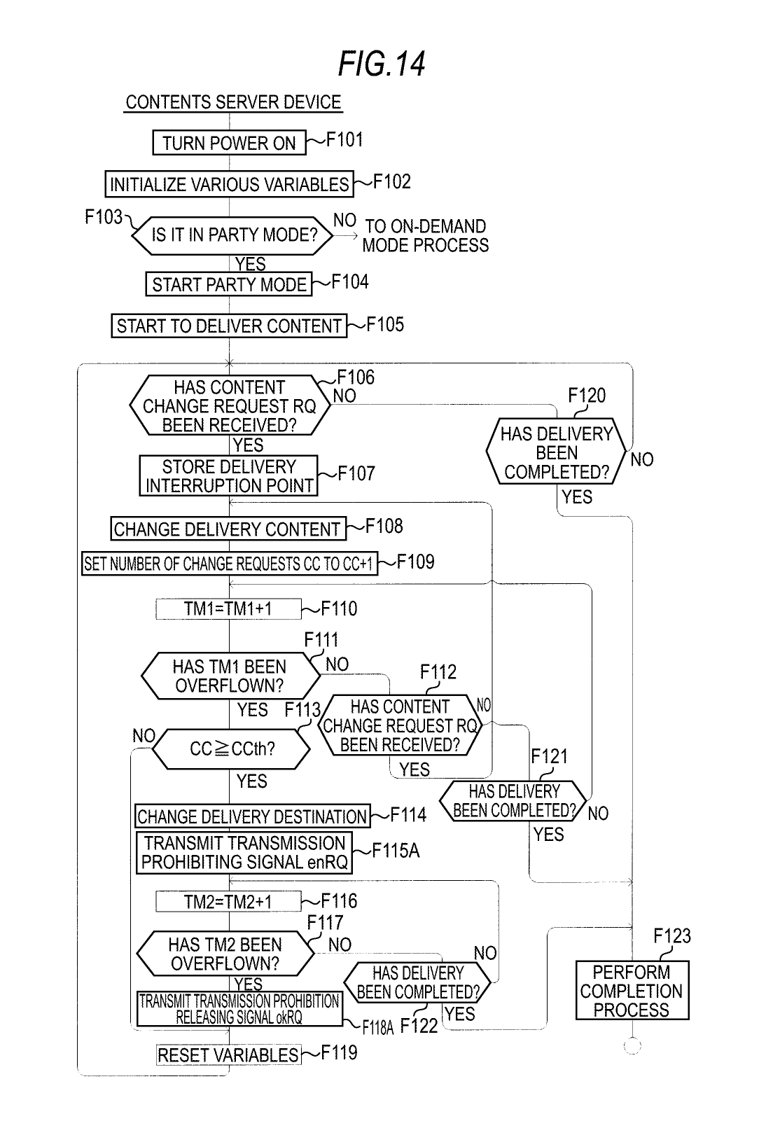

First, an example of the process of the control unit 11 (mainly the delivery control section 41) of the contents server device 1 will be described with reference to FIG. 14. The same step number is assigned to the same process as that according to the first embodiment shown in FIG. 9, and a duplicate description thereof will be omitted.

First Steps F101 to F105 are the same as those shown in FIG. 9.

In addition, Steps F106 to F114, F120, F121, and F124 after the start of a delivery operation in the party mode are the same as those shown in FIG. 3.

In other words, when a change request RQ is received by the reception unit 15 in the middle of a delivery operation in the party mode, the control unit 11 performs a process of the period TM1 similarly to that shown in FIG. 9.

Steps F113 to F119 will be described.

When CC<CCth at the time of the elapse of the period TM1 in Step F113, the control unit 11 determines that a tangle of change requests RQ (a conflict of the selection of delivery content) does not occur in the period TM1 and proceeds to Step F119. The control unit 11 resets the variables, that is, the counting value “TM1” and the number CC of change requests in this case, and the control unit 11 returns the process back to the monitoring loop of Steps F106 and F120.

On the other hand, when CC≧CCth at the time of elapse of the period TM1 in Step F113, the control unit 11 determines that a tangle of change requests RQ occurs in the period TM1 and proceeds to Step F114.

In Step F114, first, the control unit 11 changes a delivery destination. Here, the control unit 11 allows the content storing/reproducing unit 12 and the transmission unit 14 to reproduce and deliver the content by controlling the content storing/reproducing unit 12 so as to resume the delivery operation from the delivery interruption point stored in Step F107. In other words, the change requests RQ until the time point when the period TM1 elapses, that is, the change requests RQ detected in Step F106 or Step F112 are regarded not to have been received, and the state is returned to a state before the reception of the change requests RQ.

Next, the control unit 11 transmits a transmission prohibiting signal enRQ from the transmission unit 14 to each client device 2 by controlling to transmit the change request transmission prohibiting signal enRQ in Step F115A.

Then, in Step F116, the control unit 11 performs a process of making a count of the period TM2 as the function of the timer section 45.

Thereafter, until the counting value TM2 is overflown, in other words, until the period TM2 described with reference to FIG. 11 elapses, the control unit 11 performs the increment operation of Step F116 while monitoring a delivery completion trigger in Step F122. In other words, the control unit 11 advances time counting as the period TM2.

When a delivery completion trigger occurs before the elapse of the period TM2, the control unit 11 proceeds from Step F121 to Step F123 and performs a delivery completing process.

In addition, there is no case where a change request RQ is received until the period TM2 elapses. The reason for this is that each client device 2 does not transmit a change request RQ in response to the transmission prohibiting signal enRQ.

When the counting value “TM2” in the timer section 45 is overflown, in other words, when the period TM2 elapses, the control unit 11 proceeds from Step F117 to Step F118A, performs transmission control of a transmission prohibition releasing signal okRQ, and transmits a transmission prohibition releasing signal okRQ from the transmission unit 14 to each client device 2.

Then, in Step F119, the control unit 11 resets the variables, that is, the counting values “TM1”, “TM2”, and the number CC of change requests in this case and returns the process back to the monitoring loop of Steps F106 and F120.

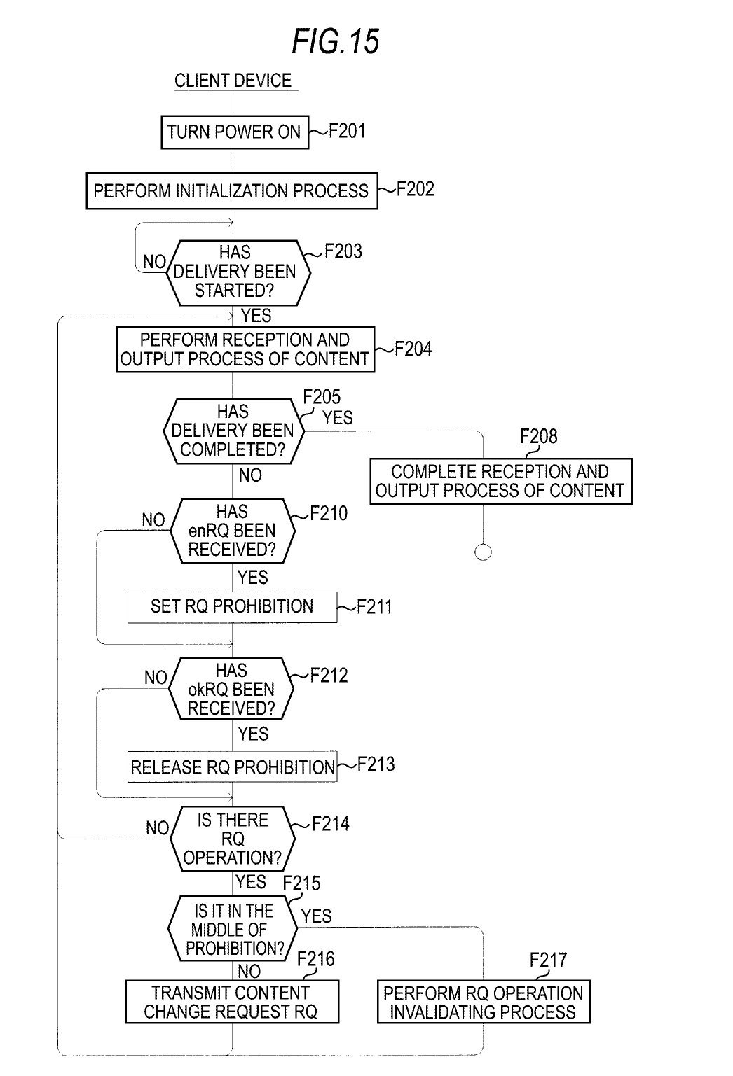

Next, an example of the process of the control unit 21 of the client device 2 will be described with reference to FIG. 15. Here, the same step number is assigned to the same process as that of the first embodiment shown in FIG. 10, and the description thereof will be omitted.

Steps F201 to F205 and F208 are the same as those shown in FIG. 10.

After the start of the delivery operation, the control unit 21 performs a monitoring process of Steps F210, F212, and F214 in addition to the process of monitoring the completion of delivery in Step F205 while performing the process of receiving and outputting the content data CT of Step F204.

In Step F210, the control unit 21 monitors the reception of a transmission prohibiting signal enRQ. When receiving the transmission prohibiting signal enRQ from the contents server device 1, the control unit 21 sets the prohibition of the transmission of a change request RQ in Step F211.

In Step F212, the control unit 21 monitors the reception of a transmission prohibition releasing signal okRQ. When receiving the transmission prohibition releasing signal okRQ from the contents server device 1, the control unit 21 releases the set prohibition of the transmission of a change request RQ in Step F213.

When detecting an operation for a change request as a user operation, the control unit 21 proceeds from Step F214 to Step F215. Then, the control unit 21 checks whether or not the transmission prohibition is currently set.

When the transmission prohibition is not set, the control unit 21 proceeds to Step F216 and performs a process of transmitting the change request RQ from the transmission unit 24 to the contents server device 1.

On the other hand, when the transmission prohibition is set, the control unit 21 proceeds to Step F217 and processes the user's operation for a change request as an invalid operation without performing the process of transmitting the change request RQ.

As the contents server device 1 and the client device 2 perform the above-described processes represented in FIGS. 14 and 15, the operations according to the second embodiment described with reference to FIG. 11 are realized.

According to the second embodiment, the same advantages as those of the first embodiment can be acquired.

In other words, in the middle of the delivery operation in the party mode, users using the client devices 2 disposed in each of the rooms R0 to R3 can freely request to change the delivery content. Then, particularly when there is no conflict in the selection of content storing, the changed content is delivered.

On the other hand, even when change requests RQ are frequently generated temporarily, a frequent change in the delivery content is allowed only over a short time within the period TM1, and a change request RQ is not allowed to be transmitted in the following period TM2. Accordingly, the displeasure of other users or deterioration of the mood does not last long.

In addition, since a change request RQ is not allowed to be transmitted from the client device 2 in the second period TM2, reoccurrence of an unnecessary authority conflict after that can be prevented.

In addition, the setting of the periods TM1 and TM2 and the setting of the threshold value CCth may be considered to be the same as those of the first embodiment.

In selecting content data CT to be delivered after the period TM1 in a case where there is a conflict, modified examples the same as those of the first embodiment may be considered to be employed.

In addition, in the above-described example, a transmission prohibiting signal enRQ is transmitted to all the client devices 2 in the period TM2. However, the transmission prohibiting signal enRQ may be transmitted only to specific client devices 2. In other words, it may be configured such that the transmission prohibiting signal enRQ is transmitted only to client devices 2 causing a tangle of change requests RQ in the period TM1, and other client devices 2 are maintained to be in a state in which a change request RQ can be continuously transmitted.

In addition, in the example of the process represented in FIG. 14, although the number CC of change requests at the time point after the elapse of the period TM1 and the threshold value CCth are compared, the number CC of change requests and the threshold value CCth may be compared continually in the middle of making a count of the period TM1.

In such a case, it may be configured such that the period TM1 ends at a time point when the number CC of change requests is equal to or greater than the threshold value CCth, and the process of Step F114 and after that, that is, the changing to the delivery of the original content storing, the transmitting of a transmission prohibiting signal enRQ, and the making of a count of the period TM2 are performed.

In addition, when a user operation is invalidated in Step F217 as the process of the client device 2 shown in FIG. 15, in order not to misguide to a malfunction or the like or to aggressively indicate the prohibition of the transmission for preventing a conflict, a message display or the like indicating the prohibition of the transmission of a change request RQ is preferably performed, for example, by using the display unit 29 or the like.

### 4. Third Embodiment

### [4-1: Overview of Operation]

Subsequently, a third embodiment will be described. FIG. 15 represents the content data CT delivered in the party mode along the time axis as an overview of the operation according to the third embodiment.

First, it is assumed that the contents server device 1 delivers the content data CT-A to all the client devices 2 until a time point t0.

At the time point t0, a change request RQ is assumed to be transmitted from the client device 2B.

When there is the first change request RQ at the time point t0, similarly to the above-described first embodiment, the contents server device 1 changes the delivery content and, during the period TM1, also accepts another change request RQ and changes the delivery content.

FIG. 15 shows a state in which a user using the client device 2B and a user using a client device 2A make conflicting change requests RQ at time points t1, t2, t3, and the like thereafter, and the change requests RQ are tangled.

Since the contents server device 1 changes the delivery content every time a change request RQ is received, the music played in all the rooms R0 to R3 is changed over many times, and a situation temporarily occurs in which it is difficult to listen to the music.

Also in the third embodiment, it is determined whether such a situation occurs in the period TM1, and an operation to be performed after the elapse of the period TM1 is determined.

In particular, in a case where the change requests RQ are frequently generated within the period TM1, the contents server device 1 transmits a transmission prohibiting signal enRQ of a change request to each client device 2 after the elapse of the period TM1.

In response to this, each client device 2 performs a process of prohibiting the transmission of a change request RQ. In other words, even when a user performs an operation for a change request, the client device 2 does not transmit a change request RQ to the server device 1.

In addition, the contents server device 1 retroactively invalidates the tangled change requests RQ within the period TM1 after the elapse of the period TM1 and delivers the content data CT-A, which has been originally delivered, from a time point t4.

Up to here, the operations are the same as those of the second embodiment. However, according to this third embodiment, the client device 2 side measures the second period TM2. In other words, when receiving the transmission prohibiting signal enRQ, the client device 2 makes a count of the period TM2 and maintains the set transmission prohibition of the change request RQ until the period TM2 elapses.

Then, after the elapse of the period TM2, the client device 2 independently releases the set transmission prohibition.

Accordingly, after the second period TM2 elapses, there is a possibility that a change request RQ is transmitted to the contents server device 1 again. When there is a change request RQ, a count of the period TM1 from the reception of the first change request RQ is made, and the same process is performed.

In addition, when a tangle of change requests RQ does not occur within the period TM1, the same operation as that of the first embodiment shown in FIG. 6 is performed.

As above, according to the second embodiment, when a change request RQ requesting to change the content delivered from a client device is received in the middle of a delivery operation in the party mode, first, the status of the reception of an additional change request RQ is checked within the first period TM1 counting of which is started based on the reception. Then, the process to be performed after the elapse of the period TM1 is determined based on the status of the reception of the change request within the period TM1.

Particularly when the number of the detected change requests RQ within the period TM1 is equal to or greater than a predetermined number, a transmission prohibiting signal enRQ of a change request is transmitted to each client device 2.

Accordingly, the client device 2 does not transmit a change request RQ during the period TM2, independently.

### [4-2: Functional Configuration of Server and Client]

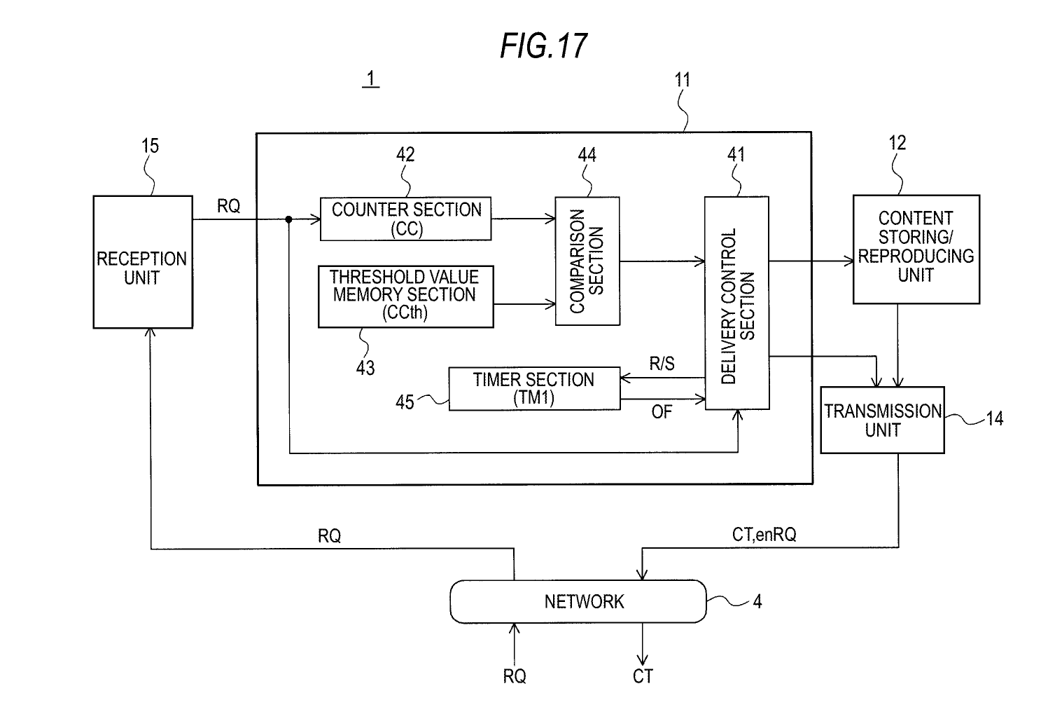

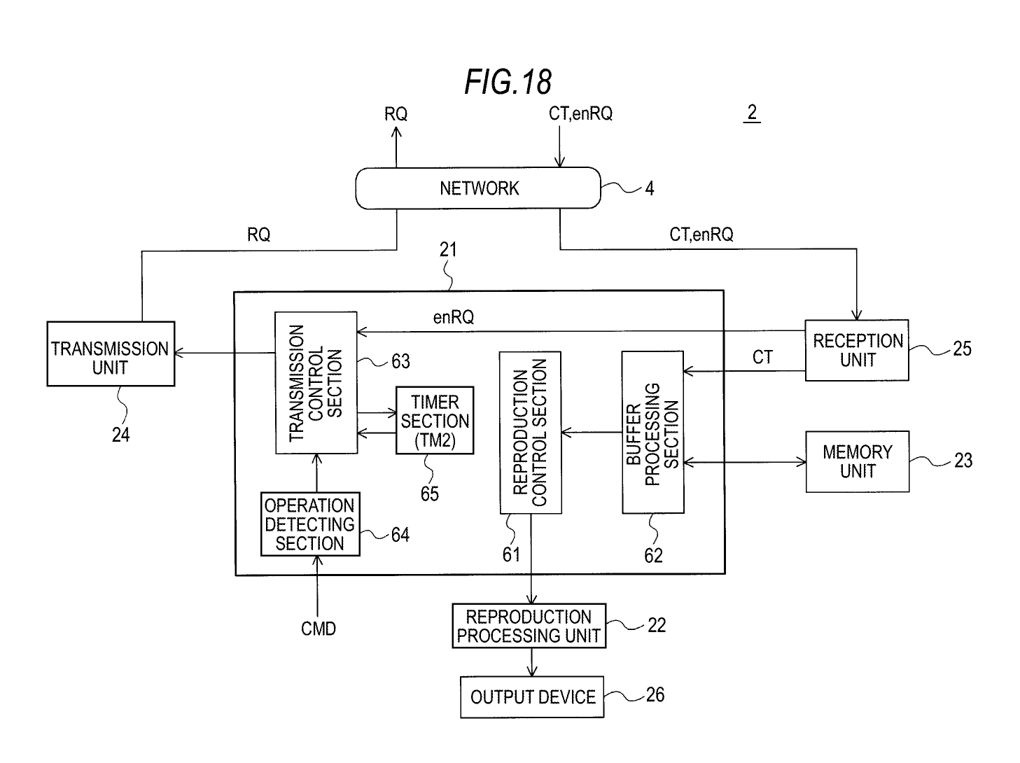

The functional configurations of the control units 11 and 21 of the contents server device 1 and the client device 2 for implementing such operations are shown in FIGS. 17 and 18.

As the functional configuration of the control unit 11 of the contents server device 1 shown in FIG. 17, a delivery control section 41, a counter section 42, a threshold value memory section 43, a comparison section 44, and a timer section 45 are included, which is similar to those of the first and second embodiments.

In this case, the delivery control section 41 generates a transmission prohibiting signal enRQ and can transmit the generated transmission prohibiting signal enRQ on signals from the transmission unit 14 to each client device 2, which is different from the first and second embodiments.

In addition, the timer section 45 has a function of making a count of the first period TM1.

In the control unit 21 of the client device 2 shown in FIG. 18, similarly to those of the first and second embodiments, a reproduction control section 61, a buffer processing section 62, a transmission control section 63, and an operation detecting section 64 are included. In addition, a timer section 65 is included.

In the case of the third embodiment, a transmission prohibiting signal enRQ other than the content data CT may be received by the reception unit 25. The transmission prohibiting signal enRQ received by the reception unit 25 is supplied to the transmission control section 63, and the transmission control section 63 sets the transmission prohibition of a change request RQ in response to the received transmission prohibiting signal enRQ. In particular, when the transmission prohibiting signal enRQ is input, the transmission control section 63 sets the transmission prohibition, and thereafter, even when an operation for a change request RQ is detected by the operation detecting section 64, the transmission control section 63 dose not perform a process of transmitting the change request RQ. Furthermore, the transmission control section 63 starts a count of the period TM2 by using the timer section 65.

Then, when the count of the period TM2 is completed in the timer section 65, the transmission control section 63 releases the set transmission prohibition.

### [4-3: Example of Process of Server And Client]

An example of the process of the contents server device 1 and the client device 2 according to the third embodiment will now be described.

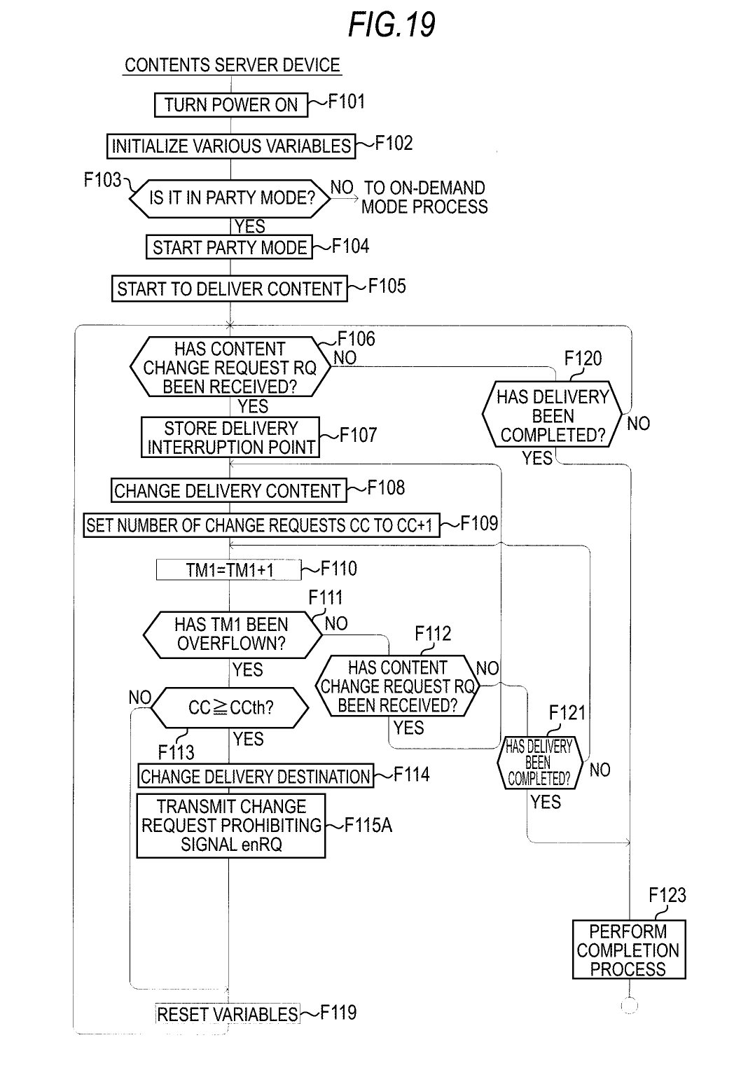

First, an example of the process of the control unit 11 (mainly the delivery control section 41) of the contents server device 1 will be described with reference to FIG. 19. The same step number is assigned to the same process as those shown in FIGS. 9 and 14, and only Steps F113 to F119 will be described by avoiding a duplicate description thereof.

When CC<CCth at the time of the elapse of the period TM1 in Step F113, the control unit 11 determines that a tangle of change requests RQ does not occur in the period TM1 and proceeds to Step F119. Then, the control unit 11 resets the variables, that is, the counting value “TM1” and the number CC of change requests and returns the process back to the monitoring loop of Steps F106 and F120.

On the other hand, when CC≧CCth at the time of the elapse of the period TM1 in Step F113, the control unit 11 determines that a tangle of change requests RQ occurs in the period TM1 and proceeds to Step F114.

In Step F114, first, the control unit 11 changes a delivery destination. Here, the control unit 11 allows the content storing/reproducing unit 12 and the transmission unit 14 to reproduce and deliver the content by controlling the content storing/reproducing unit 12 so as to resume the delivery operation from the delivery interruption point stored in Step F107. In other words, the change requests RQ until the time point when the period TM1 elapses, that is, the change requests RQ detected in Step F106 or Step F112 are regarded not to have been received, and the state is returned to a delivery state before the reception of the change requests RQ.

Next, the control unit 11 transmits a transmission prohibiting signal enRQ of a change request from the transmission unit 14 to each client device 2 by controlling to transmit the change request transmission prohibiting signal enRQ in Step F115A.

Then, the control unit 11 resets the variables, that is, the counting value “TM1” and the number CC of change requests in Step F119 and returns the process back to the monitoring loop of Steps F106 and F120.

In addition, after the control unit 11 transmits the transmission prohibiting signal enRQ in Step F115A, the process is returned to the monitoring loop of Steps F106 and F120 through Step F119. However, until the count of the second period TM2 is completed on the client device 2 side, a change request RQ is not transmitted.

Next, an example of the process of the control unit 21 of the client device 2 will be described with reference to FIG. 15. Here, the same step number is assigned to the same process as that shown in FIGS. 10 and 15, and the description thereof will be omitted.

After the start of the delivery operation, the control unit 21 performs a monitoring process of Steps F210, F221, and F214 in addition to the process of monitoring the completion of delivery in Step F205 while performing the process of receiving and outputting the content data CT of Step F204.

In Step F210, the control unit 21 monitors the reception of a transmission prohibiting signal enRQ. When receiving the transmission prohibiting signal enRQ from the contents server device 1, the control unit 21 sets the prohibition of the transmission of a change request RQ in Step F211.

Then, in Step F220, the count of the period TM2 is started based on the function of the timer section 65.

In Step F221, during the counting operation of the timer section 65, it is checked whether the count of TM2 is overflown. In other words, the elapse of the period TM2 is checked.

In addition, this checking process is a process only after the start of the counting in Step F220, and, normally (during a period in which the count of the period TM2 is not performed), the process may be omitted based on a negative result.

Then, after the starting of the count in Step F220, when the elapse of the period TM2 is confirmed, the control unit 21 proceeds to Step F222 and releases the set transmission prohibition of a change request RQ.

Then, in Step F223, a variable “TM2” as a counting value of the period TM2 is reset in Step F223.

When detecting an operation for a change request as a user operation, the control unit 21 proceeds from Step F214 to Step F215. Then, the control unit 21 checks whether or not the transmission prohibition is currently set.

When the transmission prohibition is not set, the control unit 21 proceeds to Step F216 and performs a process of transmitting the change request RQ from the transmission unit 24 to the contents server device 1.

On the other hand, when the transmission prohibition is set, the control unit 21 proceeds to Step F217 and processes the user's operation for a change request as an invalid operation without performing the process of transmitting the change request RQ.

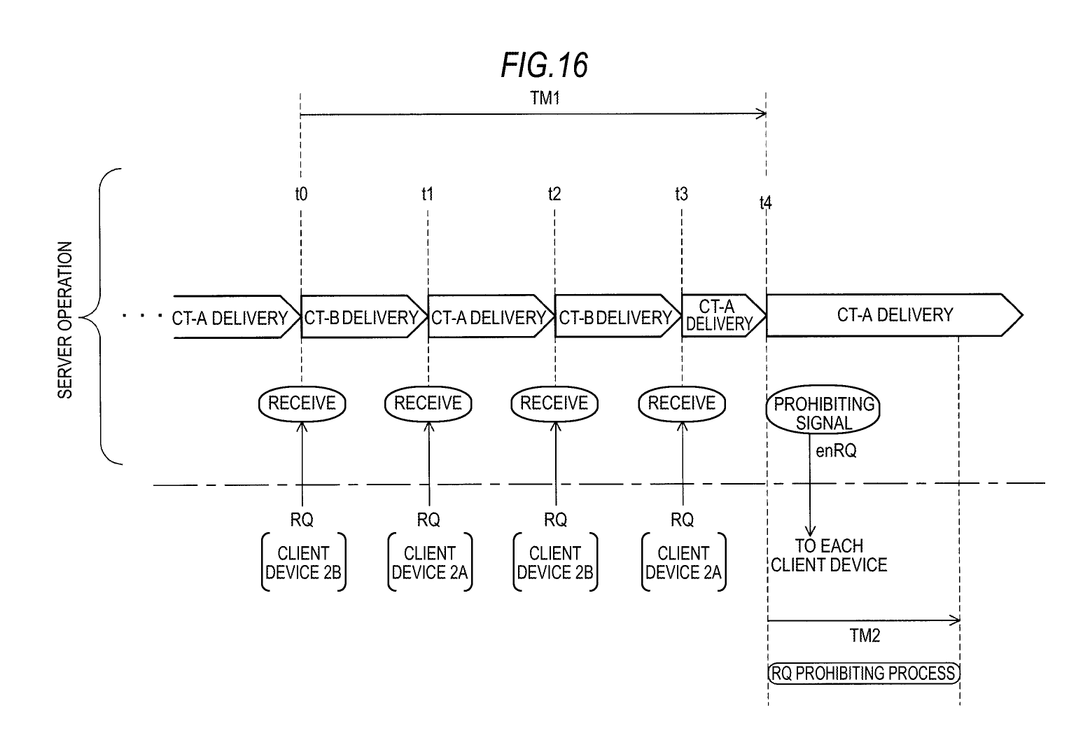

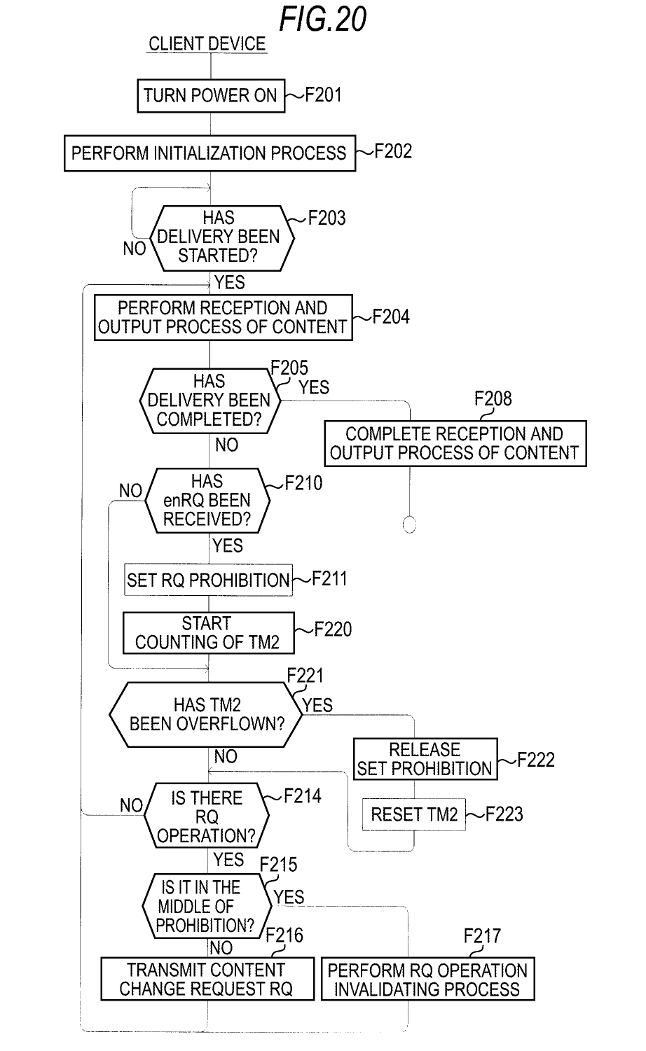

As the contents server device 1 and the client device 2 perform the above-described processes represented in FIGS. 19 and 20, the operations according to the third embodiment described with reference to FIG. 16 are realized.

According to the third embodiment, the same advantages as those of the first embodiment can be acquired.

In other words, in the middle of the delivery operation in the party mode, users using the client devices 2 disposed in each of the rooms R0 to R3 can freely request to change the delivery content. Then, particularly when there is no conflict in the selection of the content, the changed content is delivered.

On the other hand, even when change requests RQ are frequently generated temporarily, a frequent change in the delivery content is allowed only over a short time within the period TM1, and a change request RQ is not allowed to be transmitted in the following period TM2 on the client device side. Accordingly, the displeasure of other users or deterioration of the mood does not last long.

In addition, since a change request RQ is not allowed to be transmitted from the client device 2 in the second period TM2, reoccurrence of an unnecessary authority conflict after that can be prevented.

In addition, according to the third embodiment, since the client device 2 side makes a count of the period TM2 and releases the set transmission prohibition in accordance with the counting, there is an advantage of lessening the processing load of the contents server device 1.

In addition, the setting of the periods TM1 and TM2 and the setting of the threshold value CCth may be considered to be the same as those of the first embodiment.

In selecting content data CT to be delivered after the period TM1 in a case where there is a conflict, modified examples the same as those of the first embodiment may be considered to be employed.

In addition, in the above-described example, a transmission prohibiting signal enRQ is transmitted to all the client devices 2 in the period TM2. However, the transmission prohibiting signal enRQ may be transmitted only to specific client devices 2. In other words, it may be configured such that the transmission prohibiting signal enRQ is transmitted only to client devices 2 causing a tangle of change requests RQ in the period TM1, and other client devices 2 are maintained to be in a state in which a change request RQ can be continuously transmitted.

In addition, in the example of the process represented in FIG. 19, although the number CC of change requests at the time point after the elapse of the period TM1 and the threshold value CCth are compared, the number CC of change requests and the threshold value CCth may be compared continually in the middle of making a count of the period TM1.

In such a case, it may be configured such that the period TM1 ends at a time point when the number CC of change requests is equal to or greater than the threshold value CCth, and the process of Steps F114 and F115A, that is, the changing to the delivery of the original content and the transmitting of a transmission prohibiting signal enRQ are performed.

In addition, when a user operation is invalidated in Step F217 as the process of the client device 2 shown in FIG. 20, similarly to the second embodiment, a message display or the like indicating the prohibition of the transmission of a change request RQ is preferably performed, for example, by using the display unit 29 or the like.

### 5. Fourth Embodiment

### [5-1: Overview of Operation]

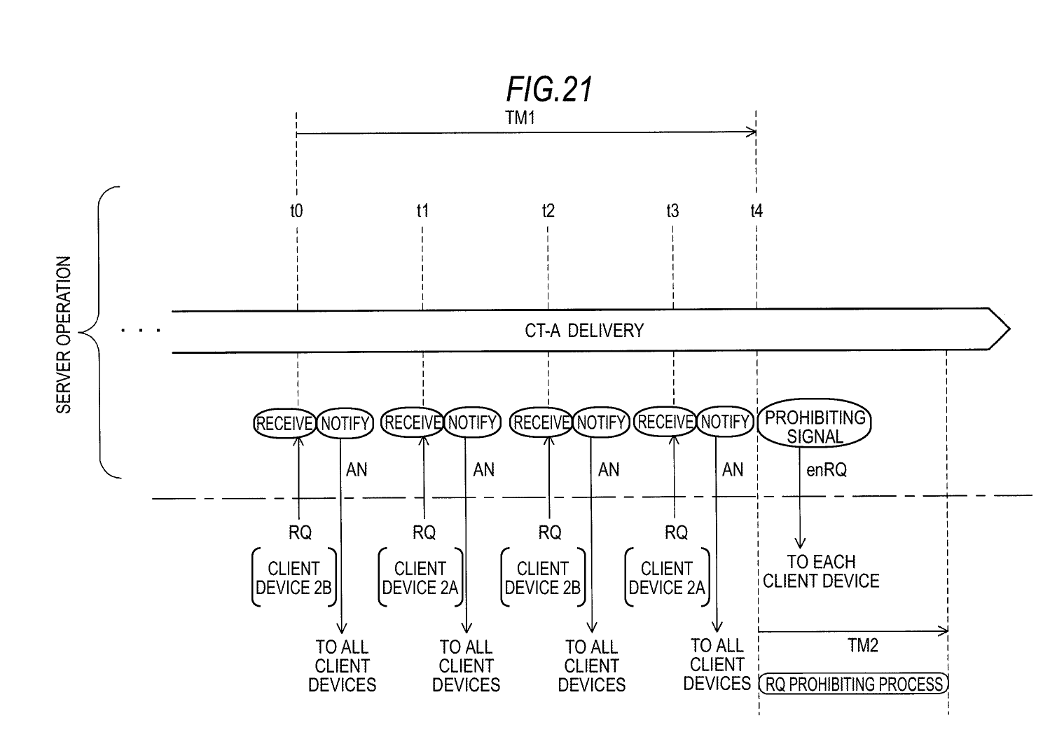

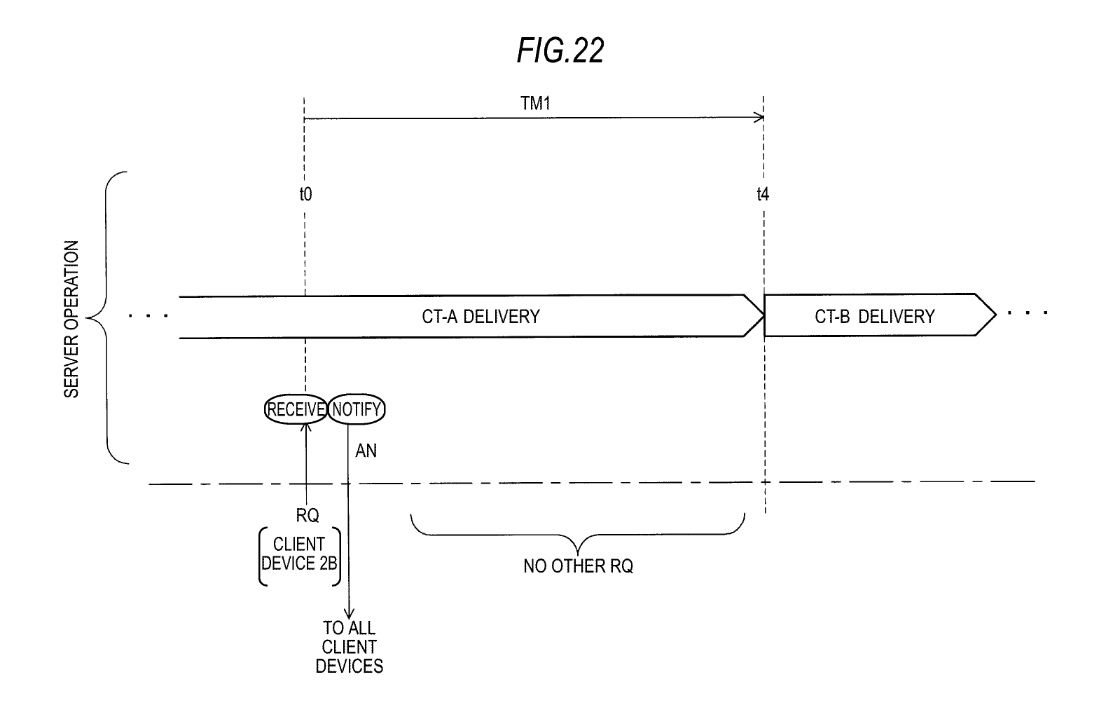

The overview of the operation according to a fourth embodiment will be described with reference to FIGS. 21 and 22. FIGS. 21 and 22 represent the content data CT that is delivered in the party mode along the time axis.

First, it is assumed that the contents server device 1 delivers the content data CT-A to all the client devices 2 until a time point t0. In addition, at the time point t0, it is assumed that there is a change request RQ from a client device 2B.

The contents server device 1 receives the change request RQ that is transmitted at time point t0 as described above.

However, according to the fourth embodiment, the contents server device 1 does not immediately change delivery content to the content data in accordance with the first change request RQ. The musical piece that is delivered to all the rooms R0 to R3 is maintained to be the content data CT-A.

At this time, the contents server device 1 transmits an announcement signal AN, which is used for notifying of the presence of a change request RQ, to all the client devices 2.

Each client device 2 notifies a user present at the room, at which each client device 2 is disposed, that there is a change request RQ for changing the delivery content from a user through a message display, an output of a voice message, or the like in accordance with the reception of the announcement signal AN.

In addition, the contents server device 1 may be configured such that the content of the content data CT requested to be changed to, that is, the title information such as the title or the like of a musical piece, a song, or a video content is included in the announcement signal AN, and each client device 2 presents such title information as being included in the message display (voice). In other words, users other than the user who sent the change request RQ may be notified of the content data CT that is to be changed to.

Here, an example is represented in which the announcement signal AN is transmitted to all the client devices 2. However, the announcement signal may be transmitted to other client devices 2 acquired by excluding the client device 2B that sent the change request RQ. The reason for this is that the change request RQ is transmitted by a user (or a person present in the same room) using the client device 2B, and accordingly, the user is understood to know the occurrence of the change request RQ.

However, in this example, as described above, even when a change request RQ is received, for example, at a time point t0, the contents server device 1 does not immediately change the delivery content. Accordingly, there is a case where the user using the client device 2B does not know whether or not the change request RQ is correctly transmitted. Thus, it is appropriate to display a message indicating the reception of the change request in the client device 2B by transmitting the announcement signal AN (or a reception completion signal) to the client device 2B as well.

In the case of this example, the contents server device 1 makes a count of the period TM1 from a time point t0 used as a starting point in accordance with the first reception of the change request RQ at the time point t0. Until a time point t4 when this period TM1 elapses, the contents server device 1 checks the status of a reception of an additional change request. In other words, the contents server device 1 checks whether or not another change request RQ is received.

Then, the contents server device 1 changes the delivery content in response to the change request RQ in a case where the number of change requests RQ received until the time point t4 when the period TM1 elapses from the time point t0 is less than a predetermined number such as a case where another change request RQ is not received within the period TM1.

For example, FIG. 22 shows a case where another change request RQ is not received until the period TM1 elapses after the generation of a change request RQ at the time point to.

In this case, the contents server device 1 determines that the change requests RQ are not tangled. In the case, the contents server device 1 changes the delivery content in response to a latest change request RQ at that time point after the time point t4. For example, when the change request RQ at the time point t0 is for requesting to deliver the content data CT-B, the delivery content is changed over to the content data CT-B from the time point t4.

Accordingly, the musical piece delivered to all the rooms R0 to R3 is changed.

Meanwhile another user knowing that there is the change request RQ at the time point t0 in accordance with the output of a message in each client device 2 may not be satisfied with the change in the delivery content.

In such a case, it is assumed that another user performs an operation of requesting to deliver the original content data CT-A (or another content data) through an operation input for the client device 2A at a time point t1 shown in FIG. 21. The client device 2A transmits a change request RQ having such content to the contents server device 1.

The contents server device 1 receives the change request RQ that is transmitted at the time point t1 as above.

In this case, the contents server device 1 receives the change request RQ. However since the period TM1 has not elapsed yet, the contents server device 1 does not change the delivery content at the time point t1.

On the other hand, the contents server device 1 transmits an announcement signal AN to each client device 2 in accordance with the reception of the change request RQ. Accordingly, the reception and the content of the change request RQ at the time point t1 are presented to other users.

FIG. 5 represents a state in which the user using the client device 2B and the user using the client device 2A contest to make the change requests RQ at time points t2 and t3 after that, and the change requests RQ are tangled.

However, since the contents server device 1 does not instantly change the delivery content in accordance with the reception of the change request RQ, the music played at all the rooms R0 to R3 is not changed.

Then, the contents server device 1 checks the number of received change requests RQ at the time point t4 when the period TM1 elapses.

When the change requests RQ are frequently generated within the period TM1, the contents server device 1 determines that there is a tangle of change requests RQ and does not change the delivery content at the time point t4. In other words, the contents server device 1 retroactively invalidates the change requests RQ at time points t0, t1, t2, and t3 shown in FIG. 21.

Accordingly, the music (the content data CT-A) played at all the rooms is not changed. However, when the content data CT-A is completed (when the piece is over) before the time point t4 or after that, the music is changed to the next content data CT in a predetermined order.

In addition, when determining that there is a tangle of the change requests RQ, the contents server device 1 transmits a transmission prohibiting signal enRQ of a change request to each client device 2 at the time point t4.

In response to the transmission of the change request transmission prohibiting signal enRQ, each client device 2 performs a process of prohibiting the transmission of a change request RQ. In other words, even when a user performs an operation of a change request, the client device 2 does not transmit the change request RQ to the contents server device 1.

Each client device 2 side measures the second period TM2. In other words, when receiving the transmission prohibiting signal enRQ, the client device 2 makes a count of the period TM2 and maintains the set transmission prohibition of the change request RQ until the period TM2 elapses.

Then, after the elapse of the period TM2, the client device 2 independently releases the set transmission prohibition.

Accordingly, after the second period TM2 elapses, there is a possibility that a change request RQ is transmitted to the contents server device 1 again. When there is a change request RQ, a count of the period TM1 from the reception of the first change request RQ is made, and the same process is performed.

As above, according to the fourth embodiment, when a change request RQ requesting to change the delivery content is received from a client device in the middle of a delivery operation in the party mode, the delivery content is not changed at that time point. Then, the status of the reception of an additional change request RQ within the first period TM1 in which counting is started based on the reception of the first change request RQ is checked. Then, the process after the elapse of the period TM1 is determined based on the status of the reception of a change request within the period TM1.

Particularly when the number of the detected change requests RQ within the period TM1 is equal to or greater than a predetermined number, a transmission prohibiting signal enRQ of a change request is transmitted to each client device 2.

Accordingly, the client device 2 does not transmit a change request RQ during the period TM2, independently.

As a result, the delivery content is not changed in response to a change request RQ received until the elapse of the period TM1.

On the other hand, when the number of the detected change requests RQ within the period TM1 is less than the predetermined number, the process of invalidating the change request RQ is not performed after the elapse of the first period TM1. The delivery content is changed over to the delivery of content data after being changed in accordance with the last change request RQ within the period TM1.

### [5-2: Functional Configuration of Server and Client]

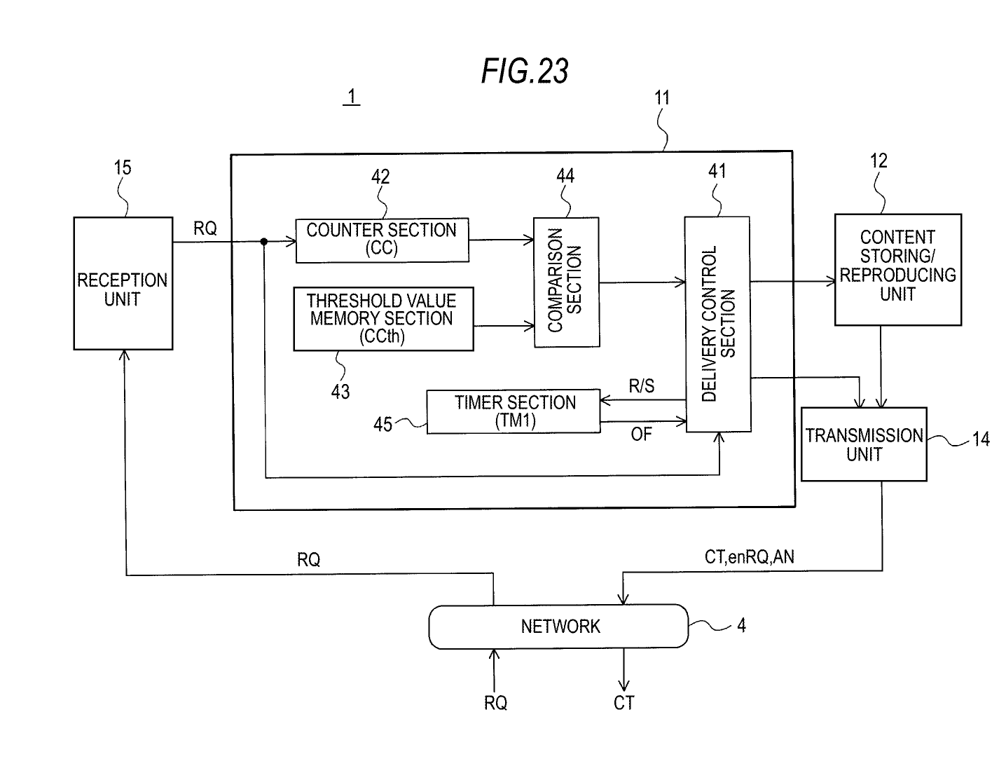

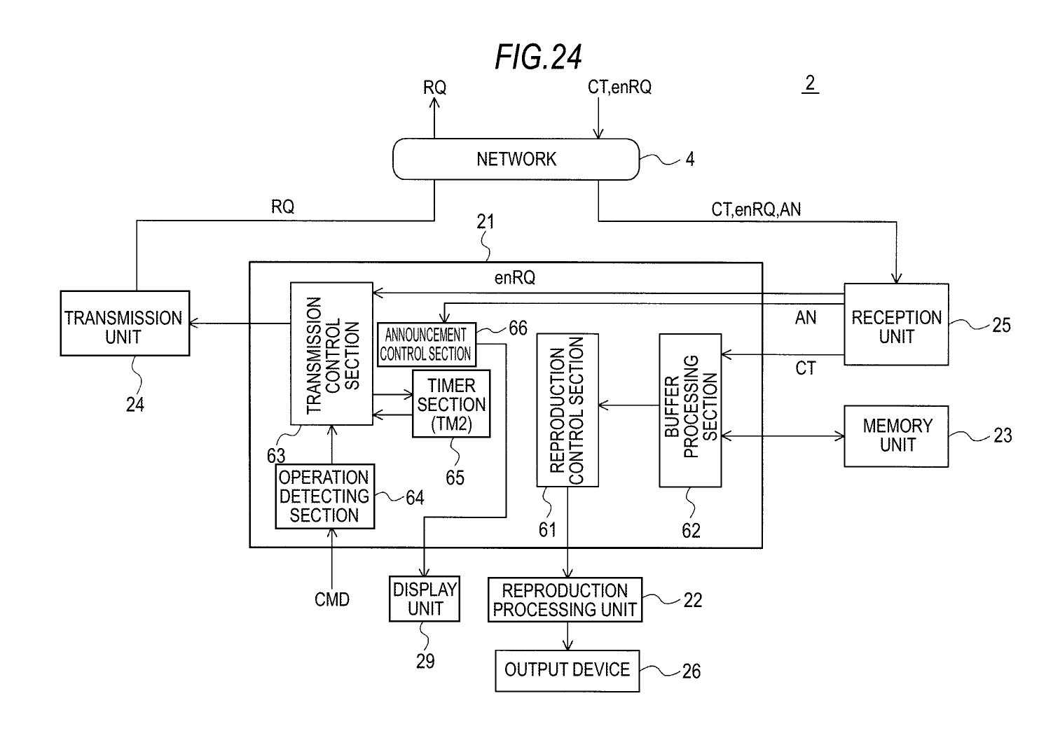

The functional configurations of the control units 11 and 21 of the contents server device 1 and the client device 2 for implementing such operations are shown in FIGS. 23 and 24.

As the functional configuration of the control unit 11 of the contents server device 1 shown in FIG. 23, a delivery control section 41, a counter section 42, a threshold value memory section 43, a comparison section 44, and a timer section 45 are included, which is similar to those of the first to third embodiments.

In this case, the delivery control section 41, in addition to generation of a transmission prohibiting signal enRQ so as to be transmitted from the transmission unit 14 to each client device 2, generates an announcement signal AN at the time of the reception of a change request RQ and transmits the generated announcement signal AN from the transmission unit 14 to each client device 2, which is different from the first to third embodiments.

In addition, the timer section 45 has a function of making a count of the first period TM1.

In the control unit 21 of the client device 2 shown in FIG. 24, similarly to that of the third embodiment, a reproduction control section 61, a buffer processing section 62, a transmission control section 63, an operation detecting section 64, and a timer section 65 are included. In addition, an announcement control section 66 is included.

In the case of the fourth embodiment, a transmission prohibiting signal enRQ and an announcement signal AN other than the content data CT may be received by the reception unit 25. The transmission prohibiting signal enRQ received by the reception unit 25 is supplied to the transmission control section 63, and the transmission control section 63 sets the transmission prohibition of a change request RQ in response to the received transmission prohibiting signal enRQ. In particular, when the transmission prohibiting signal enRQ is input, the transmission control section 63 sets the transmission prohibition, and thereafter, even when an operation for a change request RQ is detected by the operation detecting section 64, the transmission control section 63 dose not perform a process of transmitting the change request RQ. Furthermore, the transmission control section 63 starts a count of the period TM2 by using the timer section 65.

Then, when the count of the period TM2 is completed in the timer section 65, the transmission control section 63 releases the set transmission prohibition.

In addition, the announcement signal AN received by the reception unit 25 is supplied to the announcement control section 66, and the announcement control section 66 controls a message display in the display unit 29 in accordance with the received signals.

In other words, the announcement control section 66 presents a message including content indicating the reception of the change request RQ from a client device 2 and the title of the content data CT, to which the delivery data is requested to be changed, from the display unit 29 to the user based on the announcement signal AN. For example, a message of “There has been an operation for changing to “AAA”” (here, “AAA” is the title of a song or the like) is displayed.

In addition, a message may be displayed on a monitor display of the output device 26.

In addition, when a voice message is output, the announcement control section 66 outputs a voice message from a speaker of the output device 26 through the reproduction processing unit 22.

### [5-3: Example of Process of Server And Client]

An example of the process of the contents server device 1 and the client device 2 according to the fourth embodiment will now be described.

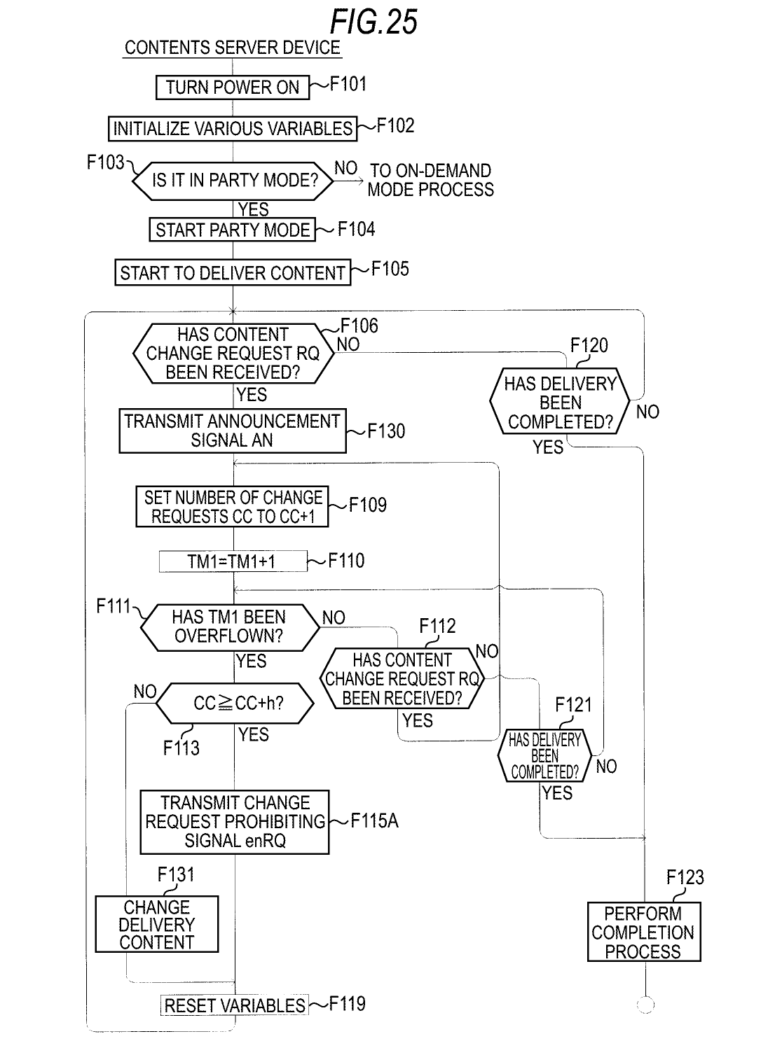

First, an example of the process of the control unit 11 (mainly the delivery control section 41) of the contents server device 1 will be described with reference to FIG. 25. The same step number is assigned to the same process as those shown in FIGS. 9, 14, and 19. Here, the descriptions of Steps F101 to F105 are omitted, and the process after the start of content delivery in the party mode in Step F105 will be described.

In the middle of the content delivery in the party mode, the control unit 11 monitors the reception of a change request RQ in Step F106 and monitors a delivery completion trigger in Step F120.

When such a delivery completion trigger is detected, the control unit 11 proceeds from Step F120 to Step F123 and performs a process of completing the delivery operation in the party mode.

When detecting the reception of the change request RQ in Step F106, the control unit 11 starts the process for performing the operations described with reference to FIGS. 21 and 22. The change request RQ detected in Step F106 is a change request RQ that becomes the time point t0 shown in FIGS. 21 and 22, that is, a starting point of a count of the period TM1.

First, in Step F130, the control unit 11 transmits an announcement signal AN to each client device 2. In other words, the control unit 21 generates an announcement signal AN including the content (the title or the like of the content data CT to which the content delivery is changed) of the received change request RQ and transmits the announcement signal AN from the transmission unit 14.

In addition, the control unit 11 increments the number CC of change requests as the function of the counter section 42 in Step F109. Initially, CC=1.

Furthermore, the control unit 11 performs a process of making a count of the period TM1 as the function of the timer section 45 in Step F110. Here, the control unit 11 increments “TM1” as a counting value of the timer section 45.

Thereafter, until the counting value TM1 is overflown, in other words, until the period TM1 described with reference to FIGS. 21 and 22 elapses, the control unit 11 performs the increment operation of Step F110 while performing monitoring of the reception of a change request RQ in Step F112 and monitoring of a delivery completion trigger in Step F121. In other words, the control unit 11 advances time counting as the period TM1.

When a delivery completion trigger occurs before the elapse of the period TM1, the control unit 11 proceeds from Step F121 to Step F123 and performs a delivery completing process.

In addition, when receiving another change request RQ before the elapse of the period TM1, the control unit 11 returns the process from Step F112 to Step F109.

In this case, the control unit 11 increments the number CC of change requests as the function of the counter section 42 in Step F109.

As above, every time that a change request RQ is received until the elapse of the period TM1, the control unit 11 increments the number CC of change requests.

However, until the period TM1 elapses, controlling of the change in the delivery content is not performed.

When the counting value “TM1” in the timer section 45 is overflown, in other words, when the period TM1 elapses, the control unit 11 proceeds from Step F111 to Step F113 and checks a comparison result at this time point based on the function of the comparison section 44. In other words, it is determined whether the number of received change requests RQ within the period TM1 is equal to or greater than a predetermined number as the threshold value CCth.

When CC<CCth, the control unit 11 determines that a tangle of change requests RQ (a conflict of the selection of delivery content) does not occur in the period TM1, proceeds to Step F131, and performs a process of changing the delivery content.

In other words, the control unit 11 controls to change the delivery content in response to the latest change request RQ until the period TM1 elapses. For example, in the case of the example shown in FIG. 22, the control unit 11 allows the content storing/reproducing unit 12 and the transmission unit 14 to reproduce and deliver the content data CT-B.

Then, the process proceeds to Step F119, the variables, that is, the counting values “TM1” and the number CC of change requests in this case are reset, and the process is retuned back to the monitoring loop of Steps F106 and F120.

This is the operation in the case shown in FIG. 22.

On the other hand, when CC≧CCth, the control unit 11 determines that a tangle of change requests RQ occurs in the period TM1 and proceeds to Step F115A.

The control unit 11 transmits a transmission prohibiting signal enRQ of a change request from the transmission unit 14 to each client device 2 by controlling to transmit the change request transmission prohibiting signal enRQ in Step F115A.

Then, the control unit 11 resets the variables, that is, the counting value “TM1” and the number CC of change requests in Step F119 and returns the process back to the monitoring loop of Steps F106 and F120.

This is an operation in a case where the description is presented with reference to FIG. 21. Finally, the delivery content is not changed in response to the change request RQ in the period TM1.

In addition, after the control unit 11 transmits the transmission prohibiting signal enRQ in Step F115A, the process is returned to the monitoring loop of Steps F106 and F120 through Step F119. However, until the count of the second period TM2 is completed on the client device 2 side, a change request RQ is not transmitted.

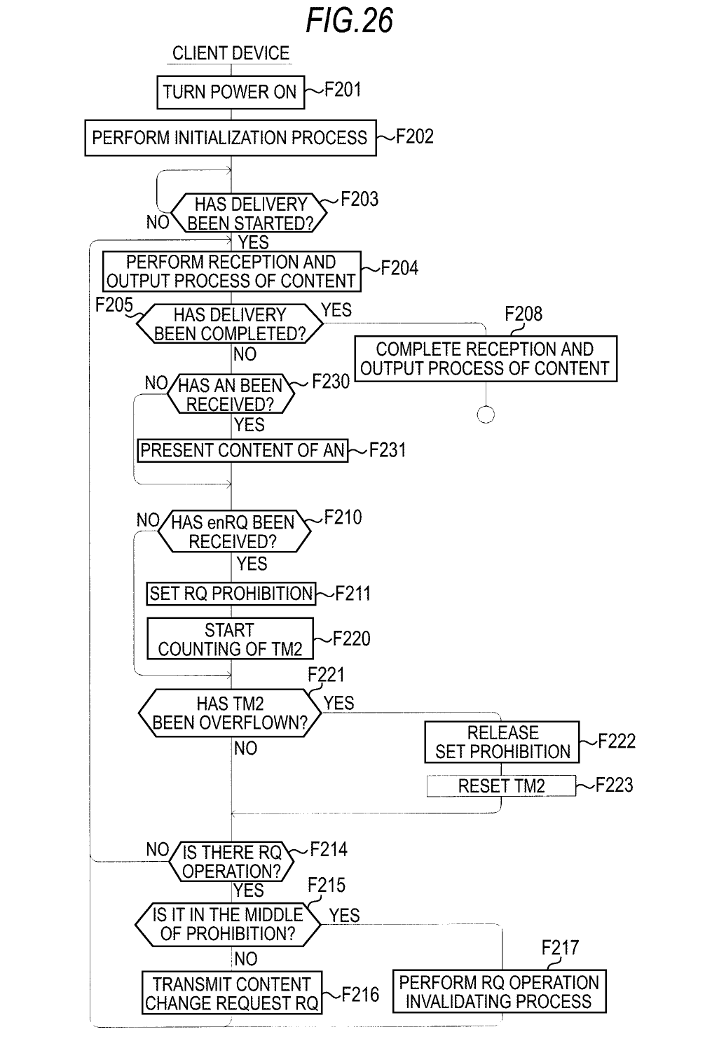

Next, an example of the process of the control unit 21 of the client device 2 will be described with reference to FIG. 26. Here, the same step number is assigned to the same process as those shown in FIGS. 10, 15, and 20. The description will be presented from Step F204 after the start of the content delivery.

After the start of the delivery operation, the control unit 21 performs a monitoring process of Steps F230, F210, F221, and F214 in addition to the process of monitoring the completion of delivery in Step F205 while performing the process of receiving and outputting the content data CT of Step F204.

In Step F230, a reception of an announcement signal AN is monitored. When receiving an announcement signal AN from the contents server device 1, the control unit 21 controls presentation in accordance with the announcement signal AN in Step F231 based on the function of a presentation control section 66. For example, the control unit 21 displays a message in the display unit 29 or the like or outputs a voice message using the speaker of the output device 26.

For example, by presenting a message such as “There has been a change request for changing to “AAA””, the generation of a change request, a display of the title of the content to which the content delivery is requested to be changed, and the like are performed.

In Step F210, the control unit 21 monitors the reception of a transmission prohibiting signal enRQ. When receiving the transmission prohibiting signal enRQ from the contents server device 1, the control unit 21 sets the prohibition of the transmission of a change request RQ in Step F211.

Then, in Step F220, the count of the period TM2 is started based on the function of the timer section 65.

In Step F221, during the counting operation of the timer section 65, it is checked whether the count of TM2 is overflown. In other words, the elapse of the period TM2 is checked.

In addition, this checking process is a process only after the start of the counting in Step F220, and, normally (during a period in which the count of the period TM2 is not performed), the process may be omitted based on a negative result.

Then, after the starting of the count in Step F220, when the elapse of the period TM2 is confirmed, the control unit 21 proceeds to Step F222 and releases the set transmission prohibition of a change request RQ.

Then, in Step F223, a variable “TM2” as a counting value of the period TM2 is reset in Step F223.

When detecting an operation for a change request as a user operation, the control unit 21 proceeds from Step F214 to Step F215. Then, the control unit 21 checks whether or not the transmission prohibition is currently set.

When the transmission prohibition is not set, the control unit 21 proceeds to Step F216 and performs a process of transmitting the change request RQ from the transmission unit 24 to the contents server device 1.

On the other hand, when the transmission prohibition is set, the control unit 21 proceeds to Step F217 and processes the user's operation for a change request as an invalid operation without performing the process of transmitting the change request RQ.

As the contents server device 1 and the client device 2 perform the above-described processes represented in FIGS. 25 and 26, the operations described with reference to FIGS. 21 and 22 are realized.

According to the fourth embodiment, the following advantages can be acquired.

In other words, in the middle of the delivery operation in the party mode, users using the client devices 2 disposed in each of the rooms R0 to R3 can freely request to change the delivery content. Then, particularly when there is no conflict in the selection of the content, after a waiting period elapses from the time of the reception of the change request RQ, in other words, after the period TM1 elapses from the time of the reception of the first change request RQ, the delivery content is changed.

On the other hand, even when change requests RQ are frequently generated, the delivery content is not changed. Accordingly, the displeasure of other users or deterioration of the mood of the party or the like due to the change in the delivery content does not occur.

In other words, according to the fourth embodiment, by generating no frequent change in the content storing, other users can be provided with pleasant delivery. Moreover, when there is no conflict, the delivery can be changed in accordance with a user's wish.

In addition, since a change request RQ is not allowed to be transmitted from the client device 2 in the second period TM2, there is an advantage of preventing reoccurrence of an unnecessary authority conflict after that.

In addition, similarly to the third embodiment, since the client device 2 side makes a count of the period TM2 and releases the set transmission prohibition in accordance with the counting, the processing load of the contents server device 1 is lessened.

In addition, the setting of the periods TM1 and TM2 and the setting of the threshold value CCth may be considered to be similar to those of the first embodiment.

In addition, in the above-described example, when there is a tangle of change requests RQ, a transmission prohibiting signal enRQ is transmitted to all the client devices 2. However, the transmission prohibiting signal enRQ may be transmitted only to specific client devices 2. In other words, it may be configured such that the transmission prohibiting signal enRQ is transmitted only to client devices 2 causing a tangle of change requests RQ in the period TM1, and other client devices 2 are maintained to be in a state in which a change request RQ can be continuously transmitted.

In addition, in the example of the process represented in FIG. 25, although the number CC of change requests at the time point after the elapse of the period TM1 and the threshold value CCth are compared, the number CC of change requests and the threshold value CCth may be compared continually in the middle of making a count of the period TM1.

In such a case, it may be configured such that the period TM1 ends at a time point when the number CC of change requests is equal to or greater than the threshold value CCth, and the transmission prohibiting signal enRQ of Step F115A is transmitted.

In addition, in the fourth embodiment, an example in which, when there is a tangle of change requests RQ, similarly to the third embodiment, a transmission prohibiting signal enRQ is transmitted, and the client device 2 side makes a count of the period TM2 is represented. However, at that time, the same process as that of the first and second embodiments may be considered to be performed. In other words, while the contents server device 1 side makes a count of the period TM2, a change request RQ may be invalidated in the mean time. Alternatively, a transmission prohibiting releasing signal okRQ may be transmitted after the period TM2 elapses.

In addition, as the process of the client device 2, the content of the presentation based on the announcement signal AN of Step F231 may be considered in a broad range.

For example, only the generation of a change request may be notified by presenting a message such as “There has been a change request”.

In addition, the generation source of a change request may be notified together by presenting a message such as “There has been a change request from a client number 3”.

In addition, a message including operation time such as “There was a change request from a client number 3 at 15:35” may be presented.

When such a message content is used, the contents server device 1 may include information of the content in the announcement signal AN.

In addition, the possibility of changing that a change request RQ will be accepted may be presented to the client device 2 that has made the change request RQ. Anyway, since the delivery content is not changed until the period TM1 elapses, a message such as “Wait for the moment until the delivery content is changed” may be presented.

In addition, when the user operation is invalidated in Step F217, similarly to the second and third embodiments, it is preferable that a message or the like that indicates the prohibition of the transmission of a change request RQ may be displayed, for example, by using the display unit 29 or the like.

In such a case, since a change request RQ that has been transmitted in advance is regarded to be invalid, a message such as “The change request has been cancelled” or “Since there is a plurality of change requests, the change request has been canceled” may be considered to be presented to the client device 2 by which the change request RQ has been made.

### 6. Fifth Embodiment

### [6-1: Overview of Operation]

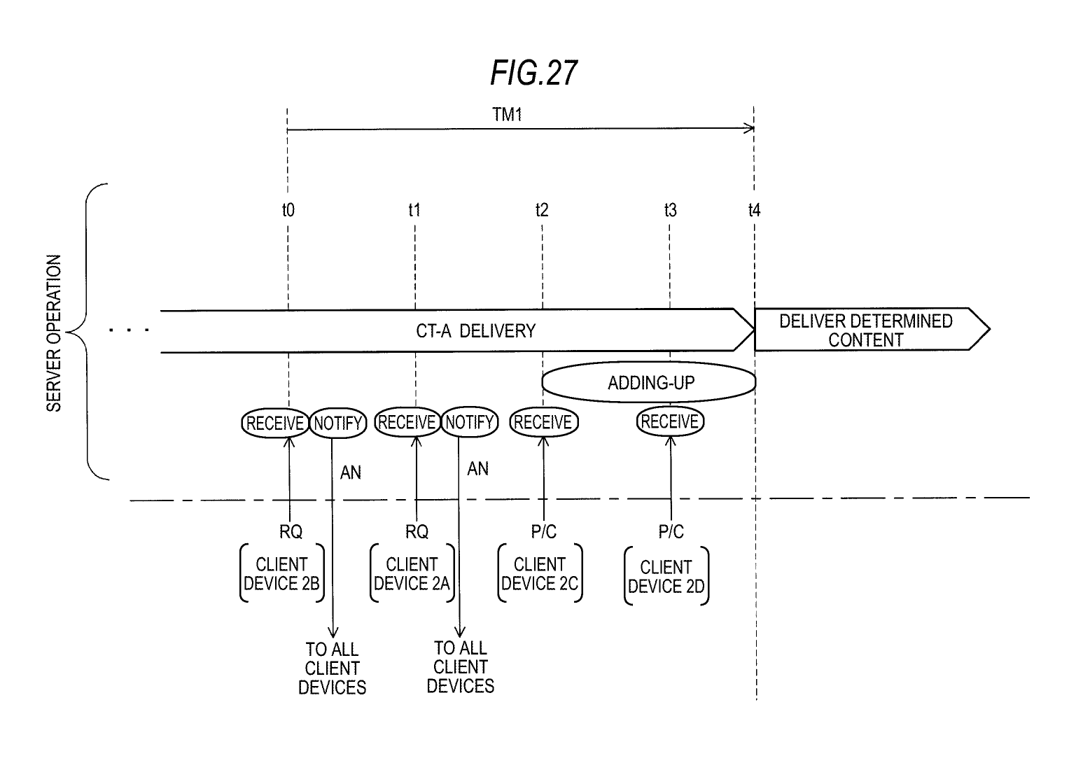

The overview of the operation according to a fifth embodiment will be described with reference to FIG. 27. FIG. 27 represents the content data CT that is delivered in the party mode along the time axis.

First, it is assumed that the contents server device 1 delivers the content data CT-A to all the client devices 2 until a time point t0. In addition, at the time point t0, it is assumed that there is a change request RQ from a client device 2B.

The contents server device 1 receives the change request RQ that is transmitted at the time point t0 as above. However, the contents server device 1 does not immediately change the delivery content to the content data in accordance with the change request RQ.

In addition, the contents server device 1 transmits an announcement signal AN that notifies of the presence of the change request RQ to all the client devices 2.

Each client device 2 notifies a user present at the room, at which each client device 2 is disposed, of the presence of a change request RQ through a message display, an output of a voice message, or the like in accordance with the reception of the announcement signal AN.

The contents server device 1 makes a count of the period TM1 from a time point t0 used as a starting point in accordance with the first reception of the change request RQ at the time point t0.

The above-described operations are the same as those of the fourth embodiment.

According to this fifth embodiment, until a time point t4 when the period TM1 elapses, checks the status of a reception of an additional change request RQ and checks an approval/disapproval information signal P/C transmitted from the client devices 2.

The approval/disapproval information signal P/C is a signal by which users other than competing users represent indication of intention to agree on a specific change request (or disagree on a specific change request) in a case where a plurality of change requests RQ compete against each other. This may be regarded as votes.

Accordingly, a user can perform an operation input for a plurality of presented changes in the delivery content as his or her vote by using the client device 2.

Each client device 2 transmits the approval/disapproval information signal P/C to the contents server device 1 in accordance with the operation.

In the example shown in FIG. 27, first, there is a change request RQ at a time point t0, and accordingly, the announcement signal AN is transmitted to each client device 2.

At this time point, each client device 2 presents the indication of generation of a change request for content data CT-B and displays a vote menu used for voting for “content data CT-B” relating to the change request or “no change in the delivery content” so as to enable the user to perform an operation input.

Here, it is assumed that there is a second change request RQ from a client device 2A at a time point t1. The contents server device 1 does not change the delivery content also at this time point but transmits the announcement signal AN to each client device 2 in accordance with the change request RQ.

When the change request RQ from the client device 2A is a change request for “content data CT-C” in this case, each client device 2 presents the indication of generation of a change request for the content data CT-C. Then, together with the above-described indication, each client device 2 displays a vote menu used for voting for “content data CT-B”, “content data CT-C” or “no change in the delivery content” so as to enable the user to perform an operation input.

On the other hand, when the change request RQ from the client device 2A at this time is a change request for “content data CT-A” that is currently delivered (in other words, a refusal of the change to the content data CT-B), each client device 2 may display a vote menu used for voting for “content data CT-B” or “no change in the delivery content”.

For example, for such a presentation, for example, users using other client devices 2C and 2D transmit the approval/disapproval information signals P/C by performing operation inputs.

FIG. 27 represents that approval/disapproval information signals P/C are received at time points t2 and t3 from the client devices 2C and 2D.

The contents server device 1 performs an adding-up process in accordance with the reception of the approval/disapproval information signals P/C.

Then, the contents server device 1 determines a delivery operation after a time point t4 when the period TM1 elapses based on the number of received change requests RQ and the result of adding-up of the approval/disapproval information signals P/C.

For example, in a case where the reception of the change request RQ does not frequently occur within the period TM1, in other words, in a case where the number of received change request RQ is one or two, particularly a conflict for changing the content is determined not to occur, and the delivery content is changed in accordance with the latest change request RQ.

On the other hand, in a case where the reception of the change request RQ occurs many times within the period TM1, the contents server device 1 determines that there is a tangle of the change requests RQ and determines to change the delivery content or not at the time point t4 based on the result of adding-up of the approval/disapproval information signals P/C.

Then, after the time point t4, content delivery according to the result of the adding-up is performed.

As above, according to the fifth embodiment, when a change request RQ requesting to change the delivery content is received from a client device in the middle of a delivery operation in the party mode, the delivery content is not changed at that time point. Then, an additional change request RQ or an approval/disapproval information signal P/C is checked within the first period TM1 counting of which is started based on the reception of the first change request RQ.

Then, the process after the elapse of the period TM1 is determined based on the status of the reception of a change request within the period TM1 or the result of adding-up of the approval/disapproval information signals P/C. In such a case, the delivery content is determined.

### [6-2: Functional Configuration of Server and Client]

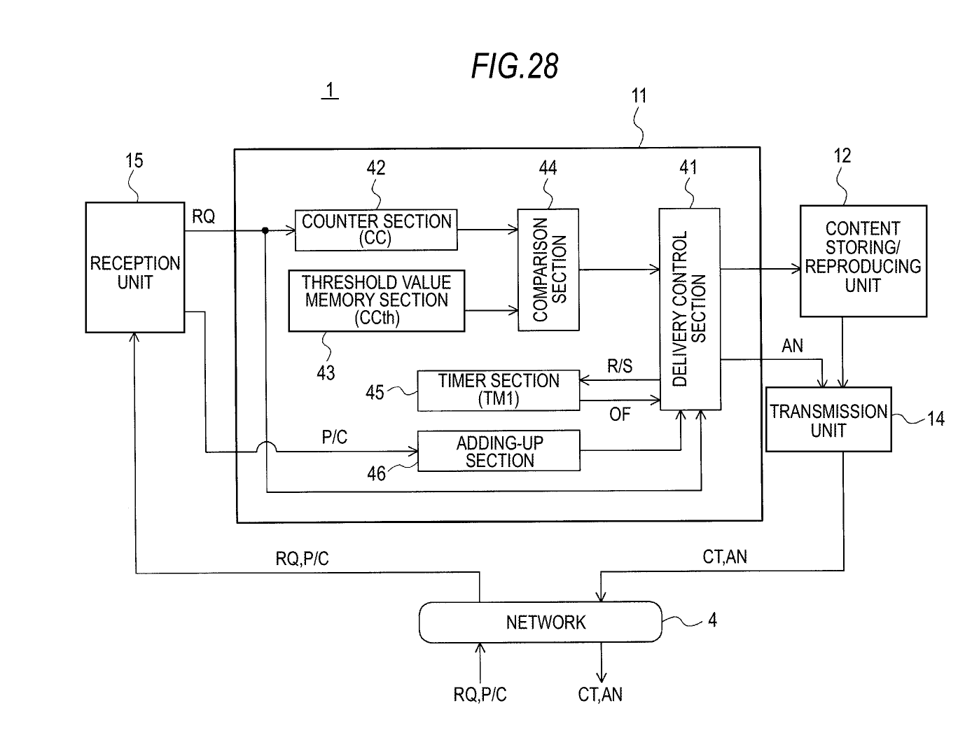

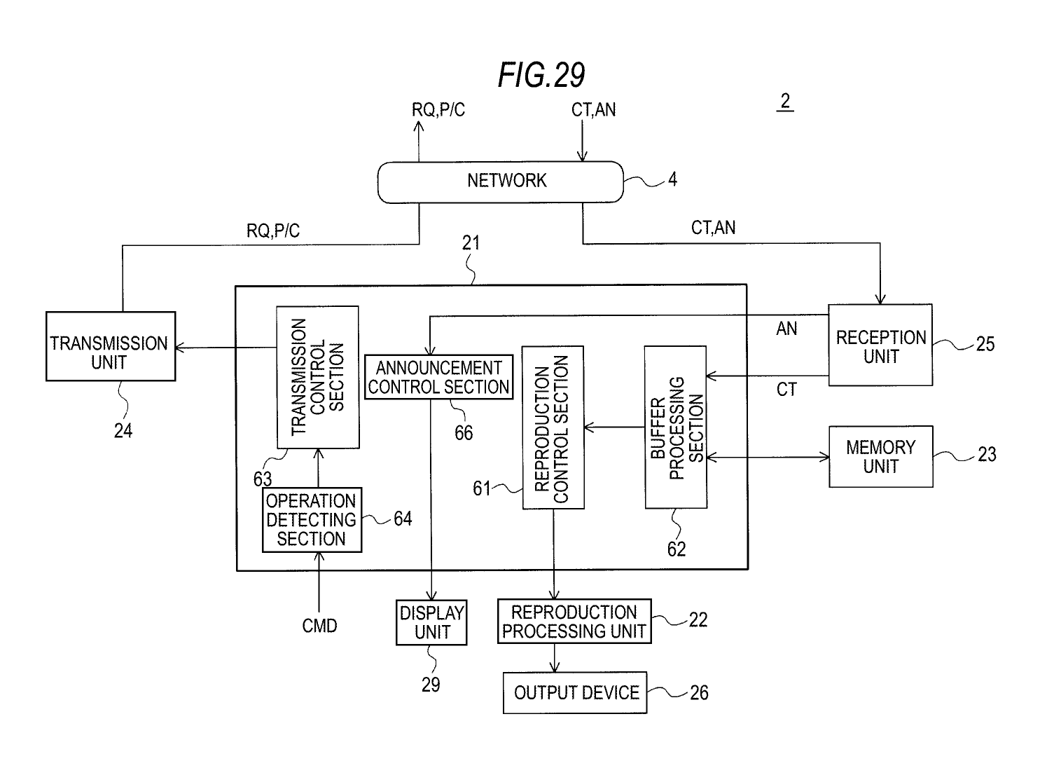

The functional configurations of the control units 11 and 21 of the contents server device 1 and the client device 2 for implementing such operations are shown in FIGS. 28 and 29.

As the functional configuration of the control unit 11 of the contents server device 1 shown in FIG. 28, a delivery control section 41, a counter section 42, a threshold value memory section 43, a comparison section 44, and a timer section 45 are included. Such functions are the same as those of the fourth embodiment. In addition to such a functional configuration, the contents server device includes an adding-up section 46.

Other than a change request RQ, an approval/disapproval information signal P/C may be received by the reception unit 15. The received approval/disapproval information signals P/C are supplied to the adding-up section 46 so as to be added up. The result of the adding-up is supplied to the delivery control section 41.

In the control unit 21 of the client device 2 shown in FIG. 29, a reproduction control section 61, a buffer processing section 62, a transmission control section 63, an operation detecting section 64, and an announcement control section 66 are included.

The functions of the reproduction control section 61, the buffer processing section 62, the transmission control section 63, and the operation detecting section 64 are the same as those of the first embodiment. In addition, the announcement control section 66 according to the fifth embodiment performs control of display of a vote menu and the like, in addition to the control of the presentation of a change request RQ that is the same as that of the fourth embodiment.

### [6-3: Example of Process of Server And Client]

An example of the process of the contents server device 1 and the client device 2 according to the fifth embodiment will now be described.

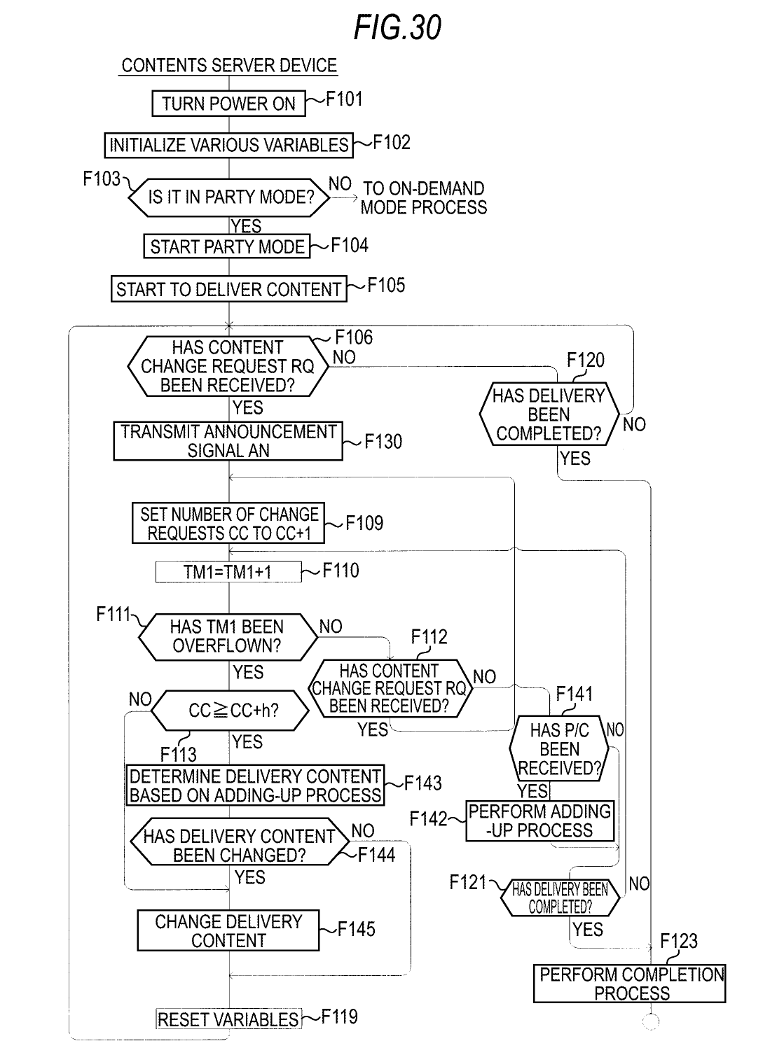

First, an example of the process of the control unit 11 (mainly the delivery control section 41) of the contents server device 1 will be described with reference to FIG. 30. The same step number is assigned to the same process as those shown in FIGS. 9, 14, 19 and 25. Here, the description of Steps F101 to F105 are omitted, and the process after the start of content delivery in the party mode in Step F105 will be described.

In the middle of the content delivery in the party mode, the control unit 11 monitors the reception of a change request RQ in Step F106 and monitors a delivery completion trigger in Step F120.

When such a delivery completion trigger is detected, the control unit 11 proceeds from Step F120 to Step F123 and performs a process of completing the delivery operation in the party mode.

When detecting the reception of the change request RQ in Step F106, the control unit 11 starts the process for performing the operations described with reference to FIG. 27. The change request RQ detected in Step F106 is a change request RQ that becomes the time point t0 shown in FIG. 27, that is, a starting point of a count of the period TM1.

First, in Step F130, the control unit 11 transmits an announcement signal AN to each client device 2. In other words, the control unit 21 generates an announcement signal AN including the content (the title or the like of the content data CT to which the content delivery is changed) of the received change request RQ and transmits the announcement signal AN from the transmission unit 14.

In addition, the control unit 11 increments the number CC of change requests as the function of the counter section 42 in Step F109.

Furthermore, the control unit 11 performs a process of making a count of the period TM1 as the function of the timer section 45 in Step F110. Here, the control unit 11 increments “TM1” as a counting value of the timer section 45.

Thereafter, until the counting value TM1 is overflown, in other words, until the period TM1 described with reference to FIG. 27 elapses, the control unit 11 performs the increment operation of Step F110 while performing monitoring of the reception of a change request RQ in Step F112, monitoring of the reception of an approval/disapproval information signal P/C in Step F141, and monitoring of a delivery completion trigger in Step F121. In other words, the control unit 11 advances time counting as the period TM1.

When a delivery completion trigger occurs before the elapse of the period TM1, the control unit 11 proceeds from Step F121 to Step F123 and performs a delivery completing process.

In addition, when receiving another change request RQ before the elapse of the period TM1, the control unit 11 returns the process from Step F112 to Step F109.

In this case, the control unit 11 increments the number CC of change requests as the function of the counter section 42 in Step F109.

As above, every time that a change request RQ is received until the elapse of the period TM1, the control unit 11 increments the number CC of change requests.

However, until the period TM1 elapses, controlling of the change in the delivery content is not performed.

In addition, when receiving an approval/disapproval information signal P/C before the elapse of the period TM1, the control unit 11 proceeds from Step F141 to F142 and performs an adding-up process based on the function of the adding-up section 46.

For example, the control unit 11 performs a process of adding up votes for the contents according to one or a plurality of change requests RQ at the time point and “no change in the delivery content”.

When the counting value “TM1” in the timer section 45 is overflown, in other words, when the period TM1 elapses, the control unit 11 proceeds from Step F111 to Step F113 and checks a comparison result at this time point based on the function of the comparison section 44. In other words, it is determined whether the number of received change requests RQ within the period TM1 is equal to or greater than a predetermined number as the threshold value CCth.

When CC<CCth, the control unit 11 determines that a tangle of change requests RQ (a conflict of the selection of delivery content) does not occur in the period TM1, proceeds to Step F145, and performs a process of changing the delivery content.

In other words, the control unit 11 controls to change the delivery content in response to the latest change request RQ until the period TM1 elapses. For example, in a case where the latest change request RQ before the elapse of the period TM1 requests for content data CT-B, the control unit 11 allows the content storing/reproducing unit 12 and the transmission unit 14 to reproduce and deliver the content data CT-B.

Then, the process proceeds to Step F119, the variables, that is, the counting values “TM1” and the number CC of change requests in this case are reset, and the process is retuned back to the monitoring loop of Steps F106 and F120.

On the other hand, when CC≧CCth, the control unit 11 determines that a tangle of change requests RQ occurs in the period TM1 and proceeds to Step F143.

The control unit 11 checks the result of adding-up of votes based on the approval/disapproval information signals P/C for the plurality of conflicting change requests RQ and determines delivery content based on the result of adding-up of the votes in Step F143.

Then, the control unit 11 proceeds to Step F145 and performs a process of changing the delivery content based on the determination according to the result of adding-up.

Then, the control unit 11 resets the variables, that is, the counting value “TM1” and the number CC of change requests in Step F119 and returns the process back to the monitoring loop of Steps F106 and F120.

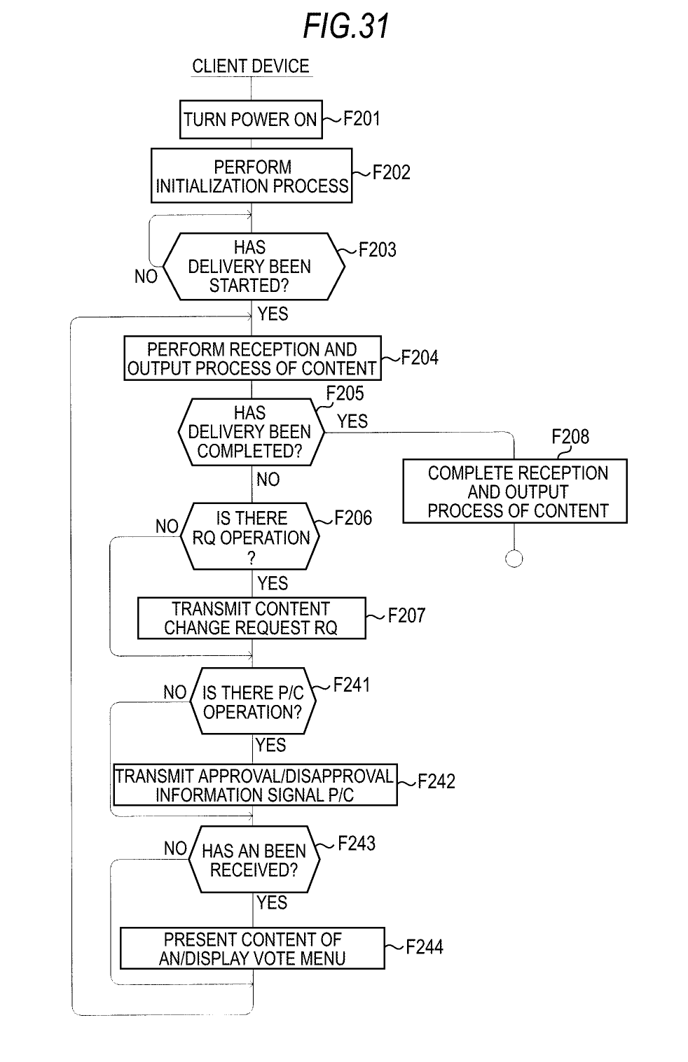

Next, the process of the client device 2 will be described with reference to FIG. 31. Here, the same step number is assigned to the same process as those shown in FIGS. 10, 15, 20 and 27. The description will be presented from Step F204 after the start of the content delivery.

After the start of the delivery operation, the control unit 21 performs a monitoring process of Steps F230, F210, F221, and F214 in addition to the process of monitoring the completion of delivery in Step F205 while performing the process of receiving and outputting the content data CT of Step F204.

In Step F206, a user's operation input for a change request is monitored.

When detecting the operation of a change request as the user operation, the control unit 21 proceeds from Step F206 to F207 and performs a process of transmitting the change request RQ from the transmission unit 24 to the contents server device 1.

In Step F241, a user's operation input of the approval/disapproval information for display of the vote menu is monitored.

When detecting the user's operation input of the approval/disapproval information as the user operation, the control unit 21 proceeds from Step F241 to Step F242 and performs a process of transmitting the approval/disapproval information signal P/C from the transmission unit 24 to the contents server device 1.

In Step F243, the reception of an announcement signal AN is monitored. When receiving an announcement signal AN from the contents server device 1, the control unit 21 controls presentation in accordance with the announcement signal AN in Step F244 based on the function of a presentation control section 66. For example, the control unit 21 displays a message in the display unit 29 or the like or outputs a voice message using the speaker of the output device 26.

Furthermore, the control unit 21 performs display of a vote menu by using the display unit 29 or a monitor display of the output device 26 together with controlling a message display. A user can input approval/disapproval information for the display of the vote menu.

As the contents server device 1 and the client device 2 perform the above-described processes represented in FIGS. 30 and 31, the operations described with reference to FIG. 27 are realized.

According to the fifth embodiment, the following advantages can be acquired.

In other words, in the middle of the delivery operation in the party mode, users using the client devices 2 disposed in each of the rooms R0 to R3 can freely request to change the delivery content.

On the other hand, even when change requests RQ are frequently generated, the delivery content is not changed until the period TM1 elapses. Accordingly, the displeasure of other users or deterioration of the mood of the party or the like due to the change in the delivery content does not occur.

In addition, the setting of the period TM1 and the setting of the threshold value CCth may be considered to be similar to those of the first embodiment.

In the process shown in FIG. 30, although the contents server device 1 determines the delivery content based on the result of adding-up in Step F143, various examples of a technique used for the adding-up and the determination or the transmission and reception of the approval/disapproval information signal P/C may be considered.

First, when a change request RQ is generated, a vote menu is displayed for the users using the client device 2. However, all the users using the client devices 2 do not necessarily perform a vote operation. Thus, there may be an interpretation of the client device 2 that has not transmitted the approval/disapproval information signal P/C as “allowing the change”, “no change”, “invalid vote”, and the like.

For example, in a case where the vote menu is configured by “support for change” to content data CT and “no support for change” to content data CT, a vote of the client device 2 that has not transmitted an approval/disapproval information signal P/C may be regarded as “support for change”.

On the other hand, in a case where the vote menu is configured by “change to content data CT-B”, “change to content data CT-C”, and “no change”, a vote of the client device 2 that has not transmitted an approval/disapproval information signal P/C may be regarded as “no change”.

On the other hand, in a case where the vote menu is configured by “change to content data CT-B” and “change to content data CT-C”, a vote of the client device 2 that has not transmitted an approval/disapproval information signal P/C may be considered to be regarded as an “invalid vote”.

Although these are examples, the intension of a user indifference to the delivery content can be appropriately handled through such a process.

In addition, the content of a vote may be variously considered based on the number of generated change requests RQ.

When an example that is appropriate for the example shown in FIG. 27 is described, one change request RQ is generated at time points t0 to t1. At this time, the client device 2 requests for user's vote operating by displaying a vote menu configured by “allowing change” and “no change”. Then, the client device 2 transmits an approval/disapproval information signal P/C in accordance with the vote operation.

At time point t1, a second change request RQ is generated. Thus, after the time point t1, the client device 2 requests for user's vote operation by changing the vote menu to “change to content data CT-B”, “change to content data CT-C”, and “no change”. Then, the client device 2 transmits an approval/disapproval information signal P/C in accordance with the vote operation.

Thereafter, approval/disapproval information signals P/C are received by the contents server device 1 at the time points t2 and t3. However, the received signals are added up for a vote menu after the time point t1.

In addition, between the time points t0 and t1, an approval/disapproval information signal P/C may be received from any client device 2. The contents server device 1 may regard the approval/disapproval information signal P/C before the time point t1 as invalid in accordance with the change in the vote menu at the time point t1 or may add up the approval/disapproval information signal PC as a vote, for example, for the same option.

For example, when an approval/disapproval information signal P/C of “allowing change” is received from a client device 2 before the time point t1, and if the approval/disapproval information signal is used for allowing to change to the content data CT-B, the approval/disapproval information signal is added up as a vote for “change to content data CT-B” in a vote menu after the time point t1.

For example, as above, the votes are added up at the time point of completion of the period TM1 while changing over the vote menu in accordance with the number of change requests RQ, and after the time point t4, delivery according to an option acquiring the highest number of votes is performed.

In addition, when an approval/disapproval information signal P/C is received again from a client device 2 that already has transmitted an approval/disapproval information signal once, the contents server device 1 may regard the new approval/disapproval information signal P/C as invalid or may regard the latest approval/disapproval information signal P/C as valid and the previous approval/disapproval information signal P/C as invalid.

In addition, the client device 2 side may request a user for an operation of transmitting an approval/disapproval information signal P/C by displaying a vote menu only when there are a predetermined number of change requests RQ or more, for example, two or more change requests RQ.

For example, as the process of Step F244 shown in FIG. 31, when the first announcement signal AN is received, only a message indicating the generation of a change request is displayed. Then, when a second or later announcement signal AN is received, a vote menu is displayed together with a message indicating the generation of a change request.

In such a case, a user performs a desired vote operation for options including the content of two or more change requests.

Particularly when there is a tangle of change requests RQ, in a case where delivery content is determined based on other user's votes, such a process can be appropriately performed.

In addition, a case may be considered in which a client device 2 that has transmitted a change request RQ is not allowed to display a vote menu and transmit an approval/disapproval information signal P/C. In such a case, a user is prevented from voting for his or her change request RQ.

In addition, in the example described with reference to FIG. 27, even after the period TM1 elapses, a change request RQ can be arbitrarily transmitted from each client device 2. In contrast to this, after the time point t4, a change request RQ in the period TM2 may be prohibited by using the technique used in the first, second, and third embodiments.

In addition, a case may be considered in which, after the period TM1 elapses, the contents server device 1 notifies each client device 2 of the result of adding-up, and each client device 2 presents the result of adding-up.

### 7. Sixth Embodiment

### [7-1: Overview of Operation]

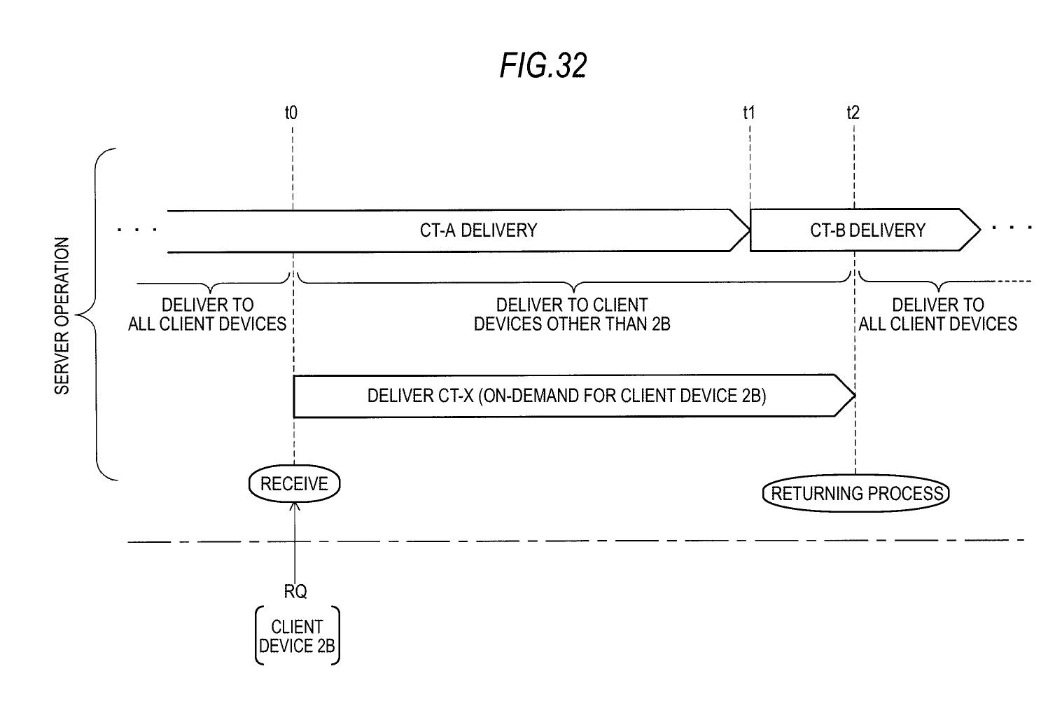

The overview of a sixth embodiment will be described with reference to FIG. 32.

In the above-described first to fifth embodiments, the operations are performed on the premise that the party mode is continued in all the rooms. However, according to the sixth embodiment, a client device 2 that transmits a change request RQ is disengaged from the party mode. In other words, only the client device 2 delivers content data CT requested only for the room in the on-demand mode.

FIG. 32 represents content data CT that is delivered along the time axis.

First, it is assumed that the contents server device 1 delivers content data CT-A to all the client devices 2 in the party mode until a time point t0. In addition, at the time point t0, it is assumed that there is a change request RQ from a client device 2B.

The contents server device 1 receives the change request RQ that is transmitted at the time point t0 as above. Then, the contents server device 1 disengages the client device 2B from the party mode and delivers requested content data CT-X only to the client device 2B as the on-demand mode.

The contents server device 1 allows the other client devices 2 to be continued in the party mode and continues to deliver, for example, the content data CT-A to the other client devices 2.

In addition, when the content data CT-A is completed (completion of the pieces), for example, at a time point t1, the contents server device 1 delivers the next piece (content data CT-B) that is determined in a predetermined order (or random selection) in the party mode.

Meanwhile, it is assumed that the content data CT-X delivered to the client device 2B in the on-demand mode is completed at a time point t2.

In such a case, the contents server device 1 returns the client device 2B to the party mode. Accordingly, after the time point t2, the content data CT-B is delivered to all the client devices 2 including the client device 2B.

As above, according to the sixth embodiment, when a change request RQ requesting to change delivery content is received from a client device 2B in the middle of a delivery operation in the party mode, the contents server device 1 continues to deliver the common content to the client devices 2 other than the client device 2B as the transmission source of the change request RQ. Then, the contents server device 1 delivers content data according to the change request RQ only to the client device 2B as the transmission source of the change request RQ.

In addition, after the transmission of the content data according to the change request RQ is completed, the contents server device 1 returns the client device 2B as the transmission source of the change request RQ to the delivery destination of the content data common to the other client devices 2.

### [7-2: Functional Configuration of Server and Client]

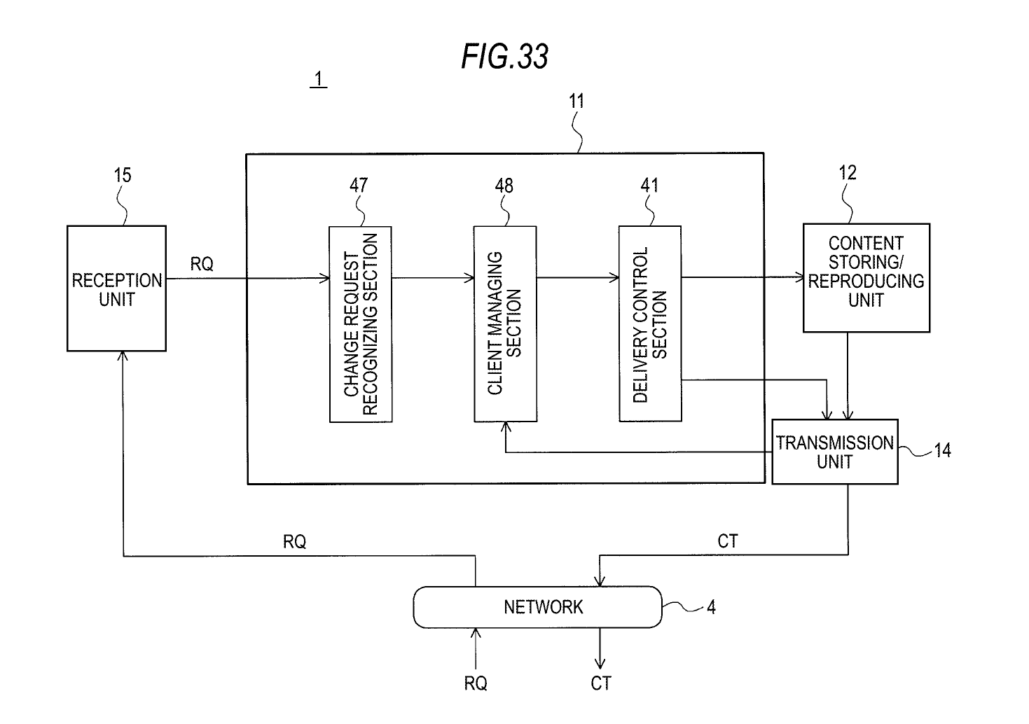

The functional configuration of the control unit 11 of the contents server device 1 for implementing such operations is shown in FIG. 33.

As the functional configuration of the control unit 11 of the contents server device 1 shown in FIG. 33, a delivery control section 41, a change request recognizing section 47, and a client managing section 48 are included.

The delivery control section 41 is a functional portion that controls the delivery operation in the party mode or the on-demand mode. The delivery control section 41 controls to designate content data CT to be delivered, allow the content storing/reproducing unit 12 to reproduce the designated content data CT to be delivered, and deliver the reproduced content data CT from the transmission unit 14 to each client device 2.

The change request recognizing section 47 recognizes a change request RQ, which is received by the reception unit 15 and is supplied to the control unit 11, transmitted from the client device 2 and transmits the information, that is, the information on the client device 2 as the transmission source and content data CT requested to be delivered to the client managing section 48.

The client managing section 48 manages delivery modes of each client device 2. In other words, the client managing section 48 sets whether each client device 2 belongs to a group in the party mode or is set to be in an individual on-demand mode. Then, the client managing section 48 transmits the mode of each client device 2 to the delivery control section 41. In particular, the client managing section 48 notifies of the IP addresses of each client device 2 as the delivery destination in the party mode and a client device 2 as the delivery destination in the on-demand mode and the like.

In addition, when a delivery operation for a client device 2 is completed in the on-demand mode, the client managing section 48 directs the delivery control section 41 to return the client device 2 to the party mode.

Here, the functional configuration of the control unit 21 of the client device 2 is the same as that of the first embodiment shown in FIG. 8, and thus the description thereof is omitted.

### [7-3: Example of Process of Server And Client]

An example of the process of the contents server device 1 according to the sixth embodiment will now be described.

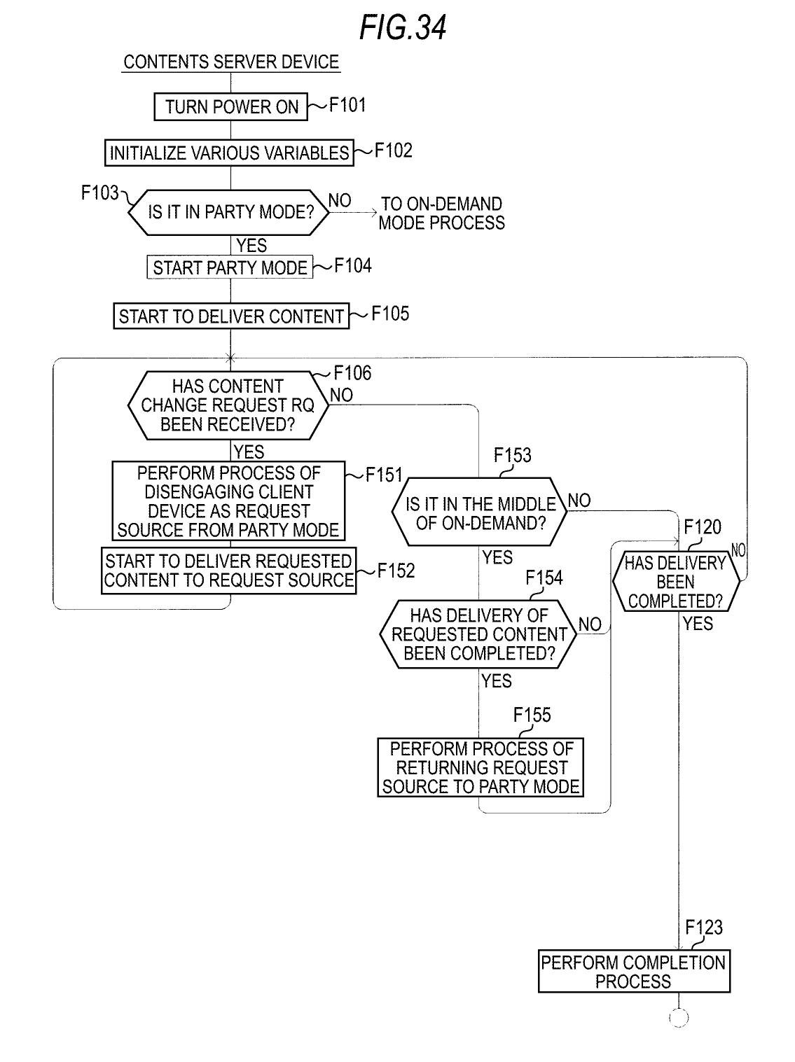

An example of the process of the control unit 11 (mainly the delivery control section 41) of the contents server device 1 will be described with reference to FIG. 34. The same step number is assigned to the same process as those shown in FIGS. 9, 14, 19 25, and 30. Here, the descriptions of Steps F101 to F105 are omitted, and the process after the start of content delivery in the party mode in Step F105 will be described.

In the middle of the content delivery in the party mode, the control unit 11 monitors the reception of a change request RQ in Step F106 and monitors a delivery completion trigger in Step F120.

In addition, particularly, when a delivery operation in the on-demand mode is performed for a client device 2, the monitoring loop proceeds from Step F153 to F154, and it is monitored whether or not the delivery of the requested content data CT is completed.

When detecting the reception of a change request RQ based on the function of the change request recognizing section 47 in Step F106, the control unit 11 proceeds to Step F151. Then, the control unit 11 performs a process of disengaging the client device 2 as the transmission source of the change request RQ from the party mode based on the function of the client managing section 48.

Then, the control unit 11 starts to deliver the requested content data CT to the disengaged client device 2 based on the function of the deliver control section 41 in Step F152.

In other words, while allowing the content storing/reproducing unit 12 and the transmission unit 14 to perform a reproduction operation and a transmission operation for content delivery in the party mode for the other client devices 2, the control unit 11 performs the reproduction and the transmission of the content data CT for content delivery in the on-demand mode for the client device 2 as the source of the request. Accordingly, a delivery operation after the time point t1 shown in FIG. 32 is performed.

Then, the control unit 11 returns to the monitoring loop starting from Step F106.

During the delivery operation in the on-demand mode, the control unit 11 monitors the completion of delivery of the content data CT requested in Step F154.

When the delivery of the requested content data CT is completed, the control unit 11 proceeds to Step F155 and returns the client device 2 as the delivery destination in the on-demand mode to the party mode. Accordingly, similarly to the time point t2 shown in FIG. 32 and after that, the delivery state in the party mode including the client device 2 is formed.

Then, the control unit 11 returns to the monitoring loop starting from Step F106.

When a delivery completion trigger is detected in the party mode in Step F120, the control unit 11 proceeds to Step F123 and performs a process of completing the delivery operation in the party mode.

In addition, the process of the client device 2 according to the sixth embodiment is the same as that of the first embodiment shown in FIG. 10, and thus, the description thereof is omitted.

As the contents server device 1 performs the process represented in FIG. 34 and the client device 2 performs the process represented in FIG. 10, the operations described with reference to FIG. 32 are realized.

According to the sixth embodiment, the following advantages can be acquired.

According to the sixth embodiment, a request from a room (client device 2) in which a content change request RQ is made can be responded without interrupting the content delivery to each room in the party mode. Accordingly, while a delivery operation is performed in the party mode, individual user's request can be accurately responded without bothering other persons at all.

For example, when content including an artist participating to a party becomes the subject of conversation, and the content is desired to be viewed in a room, a conversation can be enjoyed while viewing the content only in the room without interrupting the content that is reproduced in other rooms.

Furthermore, a useless conflict such as a tangle of change requests RQ from a plurality of client devices 2 does not occur.

In addition, after the delivery of the content CT according to the request from the client device 2 disengaged from the party mode is completed, a process of automatically returning the client device 2 to the party mode is performed. Accordingly, there is no operation load of a user, and a delivery operation in the party mode can be appropriately continued.

In this embodiment, the client device 2 is disengaged from the party mode in accordance with a change request RQ from the client device 2. However, it may be configure that the client device 2 side can select the party mode or the on-demand mode.

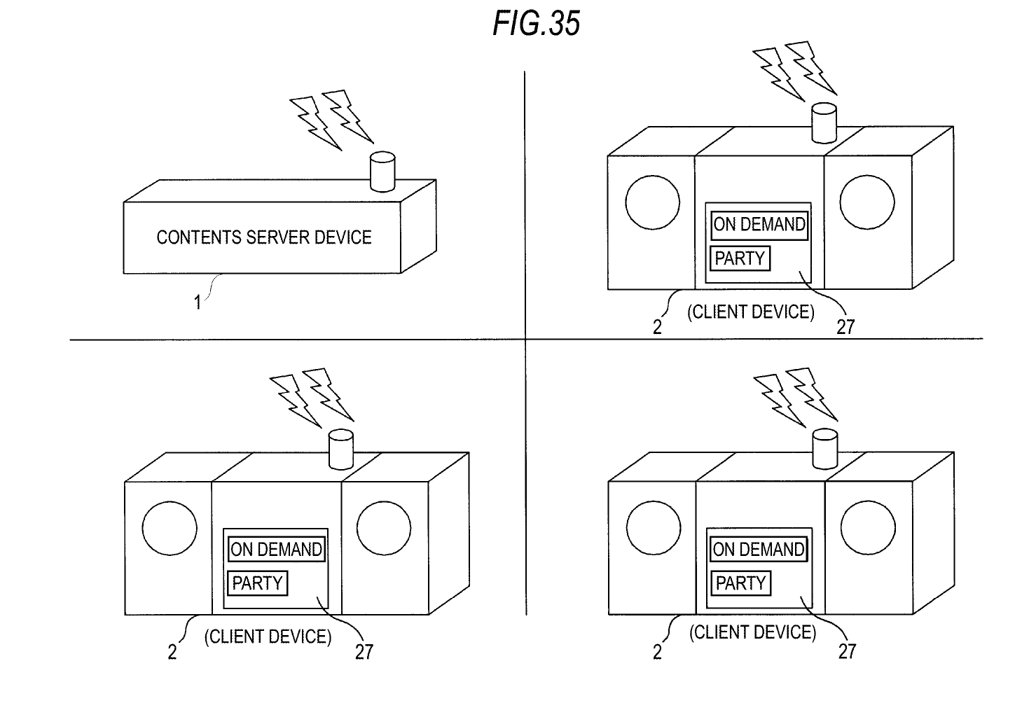

For example, as shown in FIG. 35, on the panel operation unit 27 of each client device 2, operation keys of “On-demand” and “Party” may be arranged so as to enable a user to perform a selection operation.

It is apparent that shifting between the party mode and the on-demand mode may be performed in accordance with a toggle operation of one key. In addition, operation icons of “On-demand” and “Party” may be displayed on the display unit 27 or the like so as to enable a user to perform a selection operation through an operation of a touch panel. Furthermore, the shifting between the modes may be configured to be performed through an operation of a remote commander 3.

In such a case, the contents server device 1 delivers content data CT to each room as an operation in the party mode.

A user, who desired to disengage from the party mode, present in a room (client device 2) selects the on-demand mode through an operation. The client device 2 stops reception/reproduction in the party mode in accordance with the operation and is disengaged from the party mode at once. Thereafter, desired content may be requested to be delivered in the on-demand mode.

In addition, when desiring to return to the party mode in the middle of the delivery operation for the desired content in the on-demand mode, the user may be returned to the party mode by designating the party mode through an operation.

### 8. Program

A program according to an embodiment of the invention is a program that allows the control unit 11 (microcomputer) of the contents server device 1 to perform the process represented in FIG. 9, 14, 19, 25, 30, or 34.

In addition, a program according to an embodiment of the invention is a program that allows the control unit 21 (microcomputer) of the client device 2 to perform the process represented in FIG. 10, 15, 20, 26, or 31.

By using the program, the contents server device 1 and the client device 2 from which the above-described advantages can be acquired can be realized without using any special dedicated device. For example, the contents server device 1 and the client device 2 can be realized by using a personal computer or the like.

In addition, according to a program recording medium on which the program is recorded, it is easy to realize the contents server device 1 and the client device 2 according to the embodiment of the invention in a content reproducing device or the like.

A program according to this embodiment can be recorded in advance in an HDD as a recording medium that is built in a personal computer, an imaging apparatus, or the like, a ROM arranged inside a microcomputer having a CPU, or the like.

Alternatively, the program can be stored (recorded) temporarily or perpetually on a removable recording medium such as a flexible disc, a CD-ROM (Compact Disc Read Only Memory), an MO (Magnet optical) Disk, a DVD (Digital Versatile Disc), a Blu-ray Disc (registered trademark), a magnetic disk, a semiconductor memory, or a memory card. Such a removable recording medium can be provided as so-called package software.

A program according to an embodiment of the invention may be installed to a personal computer or the like from a removable recording medium or may be downloaded from a download site through a network such as a LAN (Local Area Network) or the Internet.

The present application contains subject matter related to that disclosed in Japanese Priority Patent Application JP 2010-051738 filed in the Japan Patent Office on Mar. 9, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A server device comprising:
a communication unit that communicates with a plurality of client devices capable of performing network communication;
a reproduction unit that reproduces content data; and
a control unit that delivers common content data reproduced by the reproduction unit from the communication unit to each of the client devices and, in a case where a change request requesting to change delivery content is received from one client device through the communication unit during the common content delivery operation, checks a status of a reception of an additional change request from other client within a first period counting of which is started based on the reception from the one client and determines a process after an elapse of the first period based on the status of the reception of the change request within the first period.

2. The server device according to claim 1, wherein the control unit performs a process of invalidating the received change request during a second period counting of which is started after the elapse of the first period when the number of the change requests detected within the first period is equal to or greater than a predetermined number.

3. The server device according to claim 1, wherein the control unit transmits a prohibit signal for prohibiting transmission of new change request to all or some of the client devices through the communication unit when the number of the change requests detected within the first period is equal to or greater than a predetermined number.

4. The server device according to claim 1, wherein, when the number of the detected change requests within the first period is equal to or greater than a predetermined number, the control unit transmits a prohibit signal for prohibiting transmission of new change request to all or some of the client devices through the communication unit and transmits a release signal for releasing the prohibition of transmission of the new change request to all or some of the client devices through the communication unit after a second period counting of which is started after the elapse of the first period counting.

5. The server device according to claim 1, wherein the control unit determines a valid change request which is a change request received at a time when the first period elapses, and controls the reproduction unit so as to reproduce the content data according to the valid change request and the communication unit so as to transmit the reproduced content data to each of the client devices.

6. The server device according to claim 5, wherein the control unit controls the reproduction unit so as to maintain the content data delivered before the start of counting of the first period in a case where the number of the change requests detected within the first period is equal to or greater than a predetermined number and controls the communication unit so as to transmit the reproduced data from the communication unit to each of the client devices.

7. The server device according to claim 1, wherein the control unit does not control to change the delivery content in accordance with the change request received until the first period elapses.

8. The server device according to claim 7, wherein the control unit does not control to change the delivery content in accordance with the change request detected within the first period also after the elapse of the first period in a case where the number of the change requests detected within the first period is equal to or greater than a predetermined number.

9. The server device according to claim 7, wherein the control unit controls the reproduction unit so as to reproduce the content data according to the latest change request detected within the first period after the elapse of the first period and controls the communication unit so as to transmit the reproduced content data from the communication unit to each of the client devices in a case where the number of the change requests detected within the first period is less than a predetermined number.

10. The server device according to claim 7, wherein the control unit, in accordance with a reception of the change request until a time point when the first period elapses, transmits an announcement signal used for notifying of the received change request from the communication unit to all or some of the client devices.

11. The server device according to claim 10, wherein the control unit performs an adding-up process of approval/disapproval information in accordance with a reception of an approval/disapproval information signal that is received by the communication unit from the client device after the transmission of the announcement signal within the first period and determines the delivery content after the elapse of the first period based on a result of the adding-up process.

12. A server device comprising:
a communication unit that communicates with a plurality of client devices capable of performing network communication;
a reproduction unit that reproduces content data; and
a control unit that delivers a common content data reproduced by the reproduction unit from the communication unit to each of the client devices and, in a case where a change request requesting to change delivery content is received from one client device through the communication unit during the common content delivery operation, said control unit controlling the reproduction unit so as to reproduce both of the common content data and a content data corresponding to the change request from the one client, and controlling the reproduction unit so as to transmit the content data corresponding to the change request only to the one client device and the common content data to other client devices except for the one client device.

13. The server device according to claim 12, wherein, when the transmission of the content data to the one client device is completed, the control unit controls the reproduction unit so as to recover delivery of the common content data to all client devices including the one client device.

14. A client device comprising:
a communication unit that communicates with a server device capable of performing network communication;
a reproduction processing unit that performs a reproduction process of content data that is delivered from the server device and is received by the communication unit; and
a control unit that transmits a change request used for requesting to change delivery content from the communication unit to the server device in accordance with a user operation and, in a case where a transmission prohibiting signal is received from the server device, does not transmit the change request according to the user operation in a predetermined period counting of which is started after the reception.

15. A client device comprising:
a communication unit that communicates with a server device capable of performing network communication;
a reproduction processing unit that performs a reproduction process of content data that is delivered from the server device and is received by the communication unit; and
a control unit that performs a process of transmitting a change request used for requesting to change delivery content from the communication unit to the server device in accordance with a user operation, a process of presenting a contents of an announcement signal when the announcement signal used for notifying of the change request from another client device is received from the server device, and a process of transmitting an approval/disapproval information signal representing approval/disapproval information on a contents of the announcement signal in accordance with a user operation from the communication unit to the server device.

16. A delivery method of a server device in a delivery system in which the server device and a plurality of client devices can communicate with each other through network communication, the delivery method comprising the steps of:
commonly delivering reproduced content data to each of the client devices;
checking a status of a reception of an additional change request in accordance with a reception of a change request used for requesting to change delivery content from one client device during the common content delivery operation within a predetermined period counting of which is started based on the reception from the one client; and
determining a process after an elapse of the predetermined period based on the status of the reception of the change request within the predetermined period.

17. A delivery method of a server device in a delivery system in which the server device and a plurality of client devices can communicate with each other through network communication, the delivery method comprising the steps of:
commonly delivering reproduced content data to each of the client devices; and
when a change request used for requesting to change a delivered content data is received from one of the client devices during the commonly delivering step,
(i) reproducing content data corresponding to the change request, while maintaining reproduction of the commonly delivering reproduced content data, and
(ii) transmitting the content data corresponding to the change request to the one of the client devices and the commonly delivering reproduced content data to the other of the client devices simultaneously.

18. A program that allows a calculation processing apparatus to perform the steps of:
commonly delivering reproduced content data to each of client devices capable of performing network communication;
checking a status of a reception of an additional change request in accordance with a reception of a change request used for requesting to change delivery content from one client device during the common content delivery operation within a predetermined period counting of which is started based on the reception from the one client; and
determining a process after an elapse of the predetermined period based on the status of the reception of the change request within the predetermined period.

19. A program that allows a calculation processing apparatus to perform the steps of:
commonly delivering reproduced content data to each of client devices capable of performing network communication; and
when a change request used for requesting to change a delivered content data is received from one of the client devices during the commonly delivering step,
(i) reproducing content data corresponding to the change request, while maintaining reproduction of the commonly delivering reproduced content data, and
(ii) transmitting the content data corresponding to the change request to the one of the client devices and the commonly delivering reproduced content data to the other of the client devices simultaneously.
